(19) United States
(12) Patent Application Publication
(10) Pub. No.: US 2012/0330769 A1
(43) Pub. Date: Dec. 27, 2012

(54) ELECTRONIC TRANSACTION TECHNIQUES IMPLEMENTED OVER A COMPUTER NETWORK

(75) Inventor: Alejandro Diaz Arceo, San Francisco, CA (US)

(73) Assignee: KODEID, INC., San Francisco, CA (US)

(21) Appl. No.: 13/607,727

(22) Filed: Sep. 9, 2012

Related U.S. Application Data
(63) Continuation of application No. PCT/US11/27793, filed on Mar. 9, 2011.
(60) Provisional application No. 61/447,696, filed on Feb. 28, 2011.
(60) Provisional application No. 61/443,253, filed on Feb. 16, 2011.
(60) Provisional application No. 61/312,179, filed on Mar. 9, 2010.

(51) Int. Cl. G06Q 20/40; G06Q 20/32; H04W 12/06

(52) U.S. Cl. 705/21; 455/411; 705/44

(57) ABSTRACT

Various techniques are disclosed herein for enabling and facilitating identification management and identity verification transactions conducted over computer networks. Some aspects disclosed herein are directed to secure techniques for enabling and facilitating electronic commerce and financial transactions conducted via one or more mobile devices. Other aspects disclosed herein are directed to secure techniques for enabling and facilitating identity verification and authentication transactions to be successfully and reliably performed via communications with a user's mobile device.

### RELATED APPLICATION DATA

The present application is a continuation of pending International Patent Application PCT/US11/27793, titled “ELECTRONIC TRANSACTION TECHNIQUES IMPLEMENTED OVER A COMPUTER NETWORK”, naming Alejandro Diaz Arceo as inventor, and filed on Mar. 9, 2011, which designates the United States; and which claims benefit from U.S. Provisional Application Ser. No. 61/443,253, titled “A Universal Unique Identifier Data Represented by a Barcode Insignia”, naming Alejandro Diaz Arceo as inventor, and filed 16 Feb. 2011; and which claims benefit from U.S. Provisional Application Ser. No. 61/312,179, titled “A System, Method, and Program Product for Consumer Transactions”, naming Alejandro Diaz Arceo as inventor, and filed Mar. 9, 2010; and which claims benefit from U.S. Provisional Application Ser. No. 61/447,696, titled “ELECTRONIC TRANSACTION TECHNIQUES IMPLEMENTED OVER A COMPUTER NETWORK”, naming Alejandro Diaz Arceo as inventor, and filed 28 Feb. 2011., the entirety of which is incorporated herein by reference for all purposes. The disclosures of International Patent Application PCT/US11/27793, U.S. Provisional Application Ser. No. 61/443,253, U.S. Provisional Application Ser. No. 61/312,179, and U.S. Provisional Application Ser. No. 61/447,696, are each incorporated herein by reference in their entirety for all purposes.

### BACKGROUND

Recent advancements in mobile communication technology have enabled not only real-time, remote communication, but also an ability to accomplish such communication without utilizing a stationary telephonic device. Specifically, cellular technology, Bluetooth technology, and the like, have enabled individuals to travel and conduct remote, real-time communicate simultaneously. In addition to voice communication, remote digital information exchange in general has also been accomplished by way of such devices. As a result, the recent generation has aptly been characterized as an age of “information on the move.”

As mobile communication devices, e.g., cell phones, smartphones, multi-mode phones, personal digital assistants (PDAs), etc., become more portable and more personal, such devices have become central to the new mobile communication age. For instance, mobile devices can be utilized to browse the Internet, shop online, and download songs, video, and the like. In addition, consumers can access electronic mail, instant messaging (IM), personal planning applications, such as calendars and task lists, entertainment applications, and so on; essentially, the mobile communication device has come to replace stationary personal computers in many aspects. As mobile device popularity increases, service providers also adapt to make their products and services accessible by way of such devices. However, the rate at which mobile computing and communication technology progresses is typically faster than the rate at which service providers can incorporate new applications for mobile technology; consequently, data services may not be fully leveraged at a given point in time for such devices.

More often, personal electronic devices contain or record personal and business related identification information. For instance, security key cards can be used to provide a form of individual identity at a security station (e.g., at an entrance to an office building), providing admittance through the security station upon scanning a valid key card. Credit cards and bank cards contain magnetic strips identifying a financial account associated with the card. Typically, a holder of the card must also present a username, password, and/or personal identification number (PIN) in order to verify user identity in conjunction with an account identity established by the card. As applications leveraging mobile technology become more diverse, however, such forms of identification can also become more integrated.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates a simplified block diagram of a specific example embodiment of a Transaction Identification System 101

FIG. 1B illustrates a block diagram depicting a conventional client/server communication system.

FIG. 2 presents a diagram illustrating an example identifier for communications applications, in accordance with a specific embodiment.

FIG. 3 presents a block diagram illustrating an example identification system for communications applications, in accordance with a specific embodiment.

FIG. 4 presents a diagram illustrating an example protocol for communications exchange, in accordance with a specific embodiment.

FIG. 5 is a simplified block diagram of an exemplary mobile client system 500 in accordance with a specific embodiment.

FIGS. 6A-C present a flow chart illustrating an exemplary method for interaction with the elements of identification system described with reference to FIG. 3 using identifier described with reference to FIG. 2 via communication system described with reference to FIG. 1, system protocol described with reference to FIG. 4 and computer system described with reference to FIG. 5, in accordance with a specific embodiment.

FIGS. 7A-7B illustrate an example transaction performed between an agent and a client via an associated mobile device, in accordance with a specific embodiment.

FIGS. 8A-D illustrate an example embodiments of identification transactions, in accordance specific embodiments.

FIGS. 9A-B presents a diagram illustrating an example Point-of-Sale (POS) transaction, in accordance with a specific embodiment.

FIGS. 10A-F presents diagrams illustrating example application GUIs for a mobile device, in accordance with a specific embodiment

FIGS. 11A-B presents diagrams illustrating an example transaction identifier and operation of associated transaction identifier poll indicator, in accordance with a specific embodiment.

FIGS. 12A-12D illustrate example screenshots of a TIS-related transaction user registration/account creation sequence in accordance with a specific embodiment.

FIG. 13A-D present diagrams illustrating an example operation for a website authentication, in accordance with a specific embodiment.

FIGS. 14A-E present diagrams illustrating an example operation for a commerce transaction associated with a website, in accordance with a specific embodiment.

FIG. 15 presents a diagram illustrating an example associating a transaction identification and identification system database as described with reference to FIG. 3, in accordance with a specific embodiment.

FIGS. 16A-I present diagrams illustrating example transaction identification data types, in accordance with a specific embodiment.

FIG. 17 presents a flow chart illustrating an exemplary method for account creation, in accordance with a specific embodiment.

FIG. 18 presents a flow chart illustrating an exemplary method for performing authentication, in accordance with a specific embodiment.

FIG. 19 presents a flow chart illustrating an exemplary method for performing payment transactions, in accordance with a specific embodiment; and

FIG. 20 presents a flow chart illustrating an exemplary method for performing identification processing, in accordance with a specific embodiment.

FIG. 21 shows an exemplary environment 2100 for implementing various aspects disclosed herein.

FIG. 22 illustrates a schematic block diagram of an exemplary remote communication environment operable to execute aspects of the disclosed subject matter FIG. 23

FIG. 23 illustrates components of an example Transaction Identification Server System database architecture in accordance with a specific embodiment.

FIG. 24 is a diagram illustrating the architectural layout and interaction between the components of an exemplary centralized debit or credit accounting system during a credit or debit transaction, in accordance with one embodiment.

FIG. 25 is a flow diagram illustrating exemplary steps involved in processing a credit or debit transaction using a centralized debit or credit accounting system, in accordance with one embodiment; and

FIGS. 26A-D are diagrams illustrating exemplary display content of a mobile device at multiple steps of a transaction performed using a centralized debit or credit accounting system, in accordance with one embodiment.

FIG. 27 shows the steps and the functions involved to authenticate the mobile device insignia in accordance to one embodiment.

FIG. 28 illustrates an example embodiment of a Transaction Identification Server System 2880 which may be used for implementing various aspects/features described herein.

FIG. 29A illustrates an example of a functional block diagram of a Transaction Identification Server System in accordance with a specific embodiment.

FIG. 29B illustrates an example of a functional block diagram of a Transaction Identification Appliance in accordance with a specific embodiment.

FIGS. 30-45 illustrate various interaction diagrams which exemplify different aspects, interactions, GUIs, and components of the Transaction Identification System features disclosed herein.

### DETAILED DESCRIPTION OF EXAMPLE EMBODIMENTS

### Overview

Various aspects disclosed herein are directed to different methods, systems, and computer program products for facilitating a mobile transaction between a client and an agent comprising: displaying, on a first display of a first mobile device, a first insignia comprising a first portion of machine readable data; scanning the first insignia using a second device, wherein the scanning includes reading the first portion of machine readable data; transmitting the first portion of machine readable data from the second device to a first server system; and displaying, at the first mobile device, a first authentication verification request to receive authentication information input at the first mobile device; wherein the first authentication verification request is caused to be displayed at the first mobile device in response to the transmitting of the first portion of machine readable data from the second device to the first server system.

Other aspects disclosed herein are directed to different methods, systems, and computer program products for receiving authentication information from a first user of the first mobile device; authenticating an identity of the first user; and facilitating successful completion of the mobile transaction using the first portion of machine readable data.

Other aspects disclosed herein are directed to different methods, systems, and computer program products for receiving authentication information from a first user of the first mobile device; authenticating an identity of the first user; and facilitating, in response to successful authentication of the identity of the first user, successful completion of the mobile transaction using the first portion of machine readable data.

Other aspects disclosed herein are directed to different methods, systems, and computer program products for receiving authentication information from a first user of the first mobile device; confirming, at the first server system, a validity of the first portion of machine readable data; and facilitating, in response to confirming the validity of the first portion of machine readable data, successful completion of the mobile transaction using the first portion of machine readable data.

Other aspects disclosed herein are directed to different methods, systems, and computer program products for receiving authentication information from a first user of the first mobile device; authenticating an identity of the first user; confirming, at the first server system, a validity of the first portion of machine readable data; and facilitating successful completion of the mobile transaction in response to successful authentication of the identity of the first user, and further in response to confirming the validity of the first portion of machine readable data.

Other aspects disclosed herein are directed to different methods, systems, and computer program products for configuring a validity of the first portion of machine readable data to expire upon an occurrence of a first condition or event; detecting an occurrence of the first condition or event; and preventing successful completion of the mobile transaction in response to detecting that the first portion of machine readable data is inactive or invalid.

Other aspects disclosed herein are directed to different methods, systems, and computer program products for configuring the first portion of machine readable data to be valid only during a first specified time interval; detecting that the validity of the first portion of machine readable data has expired; and preventing successful completion of the mobile transaction in response to detecting that the first portion of machine readable data is inactive or invalid.

Other aspects disclosed herein are directed to different methods, systems, and computer program products for storing a plurality of transaction identifiers at a mobile device, wherein the first plurality of transaction identifiers includes a first transaction identifier configured to be valid only during a first predefined time interval, wherein the first plurality of transaction identifiers includes a second transaction identifier configured to be valid only during a second predefined time interval; and using the first transaction identifier to successfully complete a first mobile transaction during the first predefined time interval; and using the second transaction identifier to successfully complete a second mobile transaction during the second predefined time interval.

The method of claim 8 further comprising: preventing successful completion of the first mobile transaction in response to detecting an attempt to use the first transaction identifier to complete the first mobile transaction during a time which falls outside of the first predefined time interval.

Other aspects disclosed herein are directed to different methods, systems, and computer program products for storing a plurality of transaction identifiers at a mobile device, wherein the first plurality of transaction identifiers includes a first transaction identifier configured to be valid only during a first predefined time interval, and wherein the first plurality of transaction identifiers includes a second transaction identifier configured to be valid only during a second predefined time interval; using the first transaction identifier to successfully complete a first mobile transaction during the first predefined time interval; and using the second transaction identifier to successfully complete a second mobile transaction during the second predefined time interval; displaying, on a first display of a first mobile device, a first insignia comprising a first portion of machine readable data; scanning the first insignia using a second device, wherein the scanning includes reading the first portion of machine readable data; transmitting the first portion of machine readable data from the second device to a first server system; and displaying, at the first mobile device, a first authentication verification request to receive authentication information input at the first mobile device; wherein the first authentication verification request is caused to be displayed at the first mobile device in response to the transmitting of the first portion of machine readable data from the second device to the first server system.

Other aspects disclosed herein are directed to different methods, systems, and computer program products for displaying, on a first display of a first mobile device, a first transaction identifier comprising a first portion of machine readable data; scanning the first transaction identifier using a second device, wherein the scanning includes reading the first portion of machine readable data; transmitting the first portion of machine readable data from the second device to a first server system; displaying, at the first mobile device, a first authentication verification request to receive authentication information input at the first mobile device; authenticating an identity of the first user; and facilitating, in response to successful authentication of the identity of the first user, successful completion of the mobile transaction using the first portion of machine readable data.

Other aspects disclosed herein are directed to different methods, systems, and computer program products for using the first transaction identifier to successfully complete a mobile payment transaction between the client and the agent.

Other aspects disclosed herein are directed to different methods, systems, and computer program products for using the first transaction identifier to successfully complete a mobile point-of-sale (POS) transaction between the client and a POS system.

Other aspects disclosed herein are directed to different methods, systems, and computer program products for using the first transaction identifier to successfully complete a user identity verification transaction between the client and the agent.

Other aspects disclosed herein are directed to different methods, systems, and computer program products for using the first transaction identifier to successfully complete a user age verification transaction between the client and the agent.

Other aspects disclosed herein are directed to different methods, systems, and computer program products for using the first transaction identifier to successfully complete a universal shopping cart transaction between the client and the agent.

Other aspects disclosed herein are directed to different methods, systems, and computer program products for using the first transaction identifier to successfully complete a URL access/login transaction between the client and the agent.

Other aspects disclosed herein are directed to different methods, systems, and computer program products for using the first transaction identifier to successfully complete a mobile payment transaction between the client and the agent.

Other aspects disclosed herein are directed to different methods, systems, and computer program products for using the first transaction identifier to successfully complete a mobile payment transaction between the client and the agent.

Other aspects disclosed herein are directed to different methods, systems, and computer program products for displaying, on a first display of a first mobile device, a first transaction identifier comprising a first portion of machine readable data; scanning the first transaction identifier using a scanning device operatively coupled to the electro-mechanical locking mechanism, wherein the scanning includes reading the first portion of machine readable data; confirming a validity of the first portion of machine readable data; and enabling operational control of the electro-mechanical locking mechanism in response to confirming the validity of the first portion of machine readable data.

Other aspects disclosed herein are directed to different methods, systems, and computer program products for transmitting the first portion of machine readable data from the second device to a first server system; displaying, at the first mobile device, a first authentication verification request to receive authentication information input at the first mobile device; authenticating an identity of the first user; and enabling operational control of the electro-mechanical locking mechanism in response to successful authentication of the identity of the first user.

Other aspects disclosed herein are directed to different methods, systems, and computer program products for displaying, on the first display, a first transaction identifier comprising a first portion of machine readable data; scanning, using a first mobile device, the first transaction identifier, wherein the scanning includes reading the first portion of machine readable data; transmitting the first portion of machine readable data from the second device to a first server system; displaying, at the first mobile device, a first authentication verification request to receive authentication information input at the first mobile device; authenticating an identity of the first user; and enabling operational control of the electro-mechanical locking mechanism in response to successful authentication of the identity of the first user.

Additional objects, features and advantages of the various aspects described or referenced herein will become apparent from the following description of its preferred embodiments, which description should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

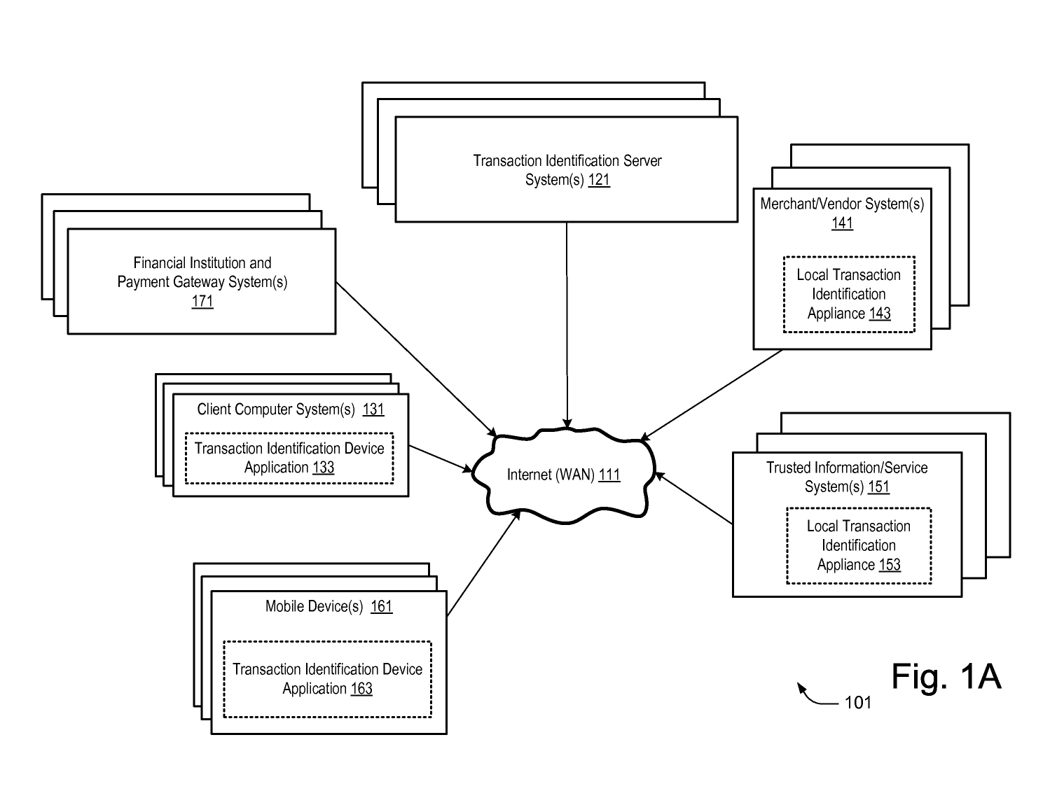

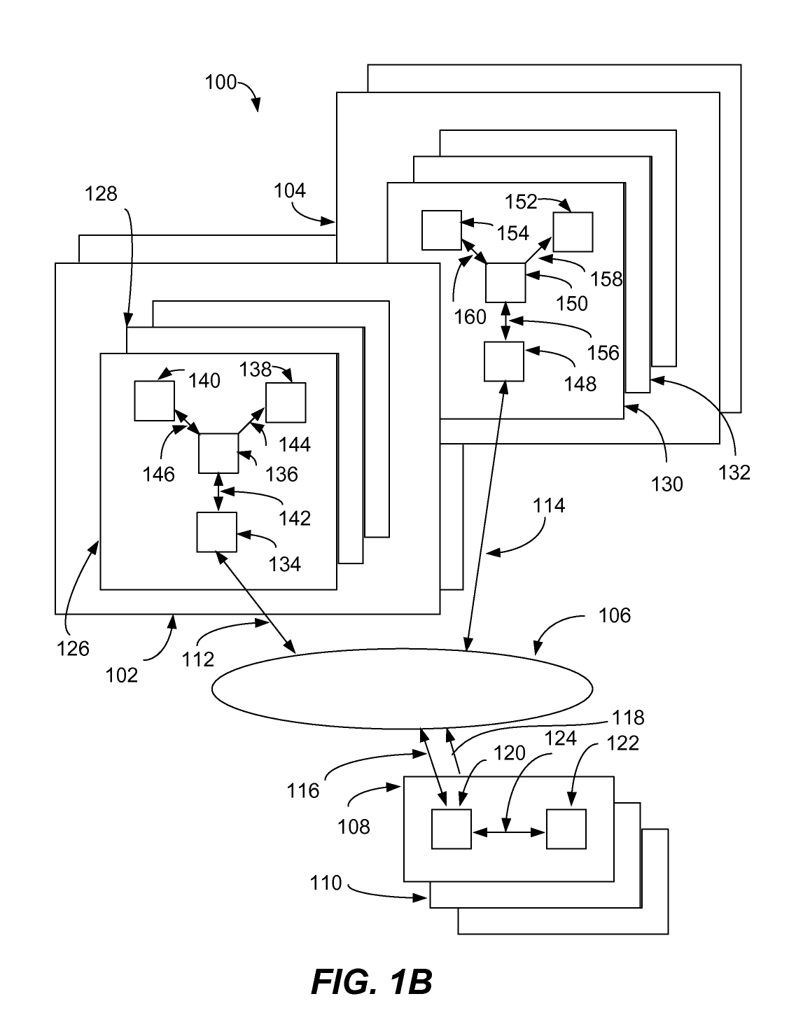

FIG. 1A illustrates a simplified block diagram of a specific example embodiment of a Transaction Identification System 101 which may be implemented in network portion 101. As described in greater detail herein, different embodiments of Transaction Identification Systems may be configured, designed, and/or operable to provide various different types of operations, functionalities, and/or features generally relating to Transaction Identification System technology. Further, as described in greater detail herein, many of the various operations, functionalities, and/or features of the Transaction Identification System(s) disclosed herein may provide may enable or provide different types of advantages and/or benefits to different entities interacting with the Transaction Identification System(s).

For example, according to different embodiments, at least some Transaction Identification System(s) may be configured, designed, and/or operable to provide, initiate, and/or enable various different types of operations, functionalities, and/or features, such as, for example, one or more of the following (or combinations thereof):
Mobile-Mobile Payment Transactions
Mobile-Computer Payment Transactions
Mobile-Retail Store Payment Transactions
Web site authentication
User ID authentication
ID Verification
Mobile device authentication
Age/Gender verification (social media sites, dating sites)
Airport Check-in
Group on/coup on/promotion transactions
Prepaid credit/debit accounts
Prepaid phone cards
Wager-based and non wager-based gaming
Social media relating to user transaction activities
ATM deposits/withdrawals
Concert tickets. Fraud in ticket concert is common TID could be used to identify or present the ticket for admission
Ski resort tickets. TID could be used instead of the lift ticket.
Public Transit systems. TID should be able to replace the ticket or monthly pass by performing the a transaction on a TID.
Toll Booth payment. A scanner could scan the users TID and charge them.
Telephone card. People should be able to use TID to call someone after scanning or having scanned a TID
Transactions between 2 computer systems (e.g., via video conference call)
Universal Shopping Cart
Hardware to unlock doors, rental cars, hotel doors, safes, security deposit boxes etc. The steps to unlock a Zip car:
   User logs into zipcar.com to create a reservation for a car (could use TID for website authentication)
   User walks up to the zip car, and launches the Transaction Identification Device Application on their phone and either scans a TID on the car (could be a static TID on the windshield, or an LCD display under the windshield that is able to serve temporary TID. Alternatively, a bar code reader device could be installed under the windshield, and the user places their phone with their TID from the Transaction Identification Device Application on the scanner.
   The transaction is sent to the Transaction Identification Server System and then the user's cell phone is prompted for their password. They enter the password and the information is sent to the Transaction Identification Server System.
   The cell phone polls for transaction confirmation, once confirmed the Zip car mechanism opens the car door (same existing mechanism). Voting systems
Device/user location verification (e.g., parole officer checking in with their parolees to make sure they are in the county/state)
   Parolee is required to check in daily at a certain time online.
   Parolee launches a government website where they can log in and a static or dynamic TID is displayed on the screen.
   Parolee launches TID on their phone and scans the TID displayed on the screen.
   The parolee is prompted for a password (In this case biometrics could be required . . . fingerprint, retinal scan etc).
   The transaction is sent to the Transaction Identification Server Systems for verification (GPS, Time, password/biometrics, ID)
   Optional steps could be added where the parolee receives a confirmation transaction screen indicating if he wants to send location to Parole officer (Accept or Decline)
   Once verified status is sent to the government website and to the parolee.
Instant Messaging security (e.g., for verifying/authenticating identities of instant messaging participants)
   User logs into an Instant Messaging system.
   User wants to start a secure IM chat with another user, and clicks “start secure chat with TID” button
   Transaction Identification Server System displays the same static unique TID on each users screens.
   Both users launch TID on their phones and scan the TID on the screen.
   The transactions are sent to the Transaction Identification Server System and matched based on the unique TID that was scanned.
   Both users are prompted for their passwords, they enter and click ok.
   They are then prompted for the type of ID to send (Drivers License, partial ID e.g. Name, Age, Sex) and confirmation that you will send information to user ABC.
   Once accepted the specified ID is sent to the other user.
Discount or membership cards. TID could replace Costco or Safeway cards for access to the store and discounts.
   During checkout at a store the POS agent will scan the individual physical items that are being purchased using a bar code reader device.
   The client launches the Transaction Identification Device Application (client software) on their cell phone (client device) and displays their transaction oriented identifier to the agent.
   The POS agent scans the clients transaction oriented identifier from their cell phone (client device).
   The client device receives a prompt for a password; the client enters it and clicks ok.
   The client device then receives the list of items to be purchased, and a list of available payment options and savings cards. The client can accept or decline the transaction.
   Both the client device and the agent device receive the transaction status (accepted or denied).
In at least some embodiments, scanning or reading of Transaction IDs may be performed over a video conference, for example, by displaying a user's mobile device display (which, for example, is displaying a Transaction ID) via the video conference display so that the Transaction ID can be viewed by a user (and/or scanned by a reading device) located at the other end of the video conference.
Etc.

According to different embodiments, at least a portion of the various types of functions, operations, actions, and/or other features provided by the Transaction Identification System may be implemented at one or more client systems(s), at one or more server systems (s), and/or combinations thereof.

Additionally, various embodiments of the Transaction Identification System(s) described here may include or provide a number of different advantages and/or benefits over currently existing Transaction Identification System technology such as, for example, one or more of the following (or combinations thereof):
Provides environmentally-friendly, green technology.
Significantly reduces or eliminates the need to use and/or manufacture credit cards, gift cards, identification cards, paper receipts, and/or other types of paper/plastic documentation which is typically needed for (or generated as a result of) conducting many of today's conventional financial transactions.
Significantly reduces or eliminates the need to use and/or manufacture debit/credit card reading/transaction devices and/or other types of magnetic card reading devices.
Significantly eliminates or reduces the need of credit card or debit card terminals. In at least one embodiment, such terminals may be replaced by TIS software and mobile devices.
Significantly simplifies credit card account application. For example, a typical credit card application consists of a client filling in an on line or paper form and receiving a plastic card via mail. TIS technology allows one to do everything on line. The client fills in the form and upon credit approval the user can have the option to add the account to the Transaction Identification Server System account list. In this case the credit company eliminates the need to manufacture the plastic card, eliminates paper communication and delivery costs.
Promotional Credit Card advertising can be done through the TIS website where the client can apply and add the credit card to the Transaction Identification System.
Facilitates transaction tracking, account centralization and accounting. For example, a customer who purchases a TV set with Master Card and pays groceries with a VISA card; he or she doesn't need retrieve transaction history from each credit card company web portal. If the accounts are configured in the system all transaction are available in the Transaction Identification System. Third party accounting software could also be easily integrated because all the data is in one location.
Increased security by using a temporary TIDs and by requiring a passcode. Traditional credit card method uses a plastic card with a fixed number. Creating temporary TIDs for a transaction limits the risk time where a transaction can be executed illegally. Existing methods do not require a passcode and use a signature that it has become more a symbolic action than a real authentication method. I consider a signature one of the reminiscent of pen and paper transaction and do not provide any security as human can't reproduce the same signature every time. Passcodes on the other hand can be reproduced and verified systematically. Ability to select from multiple accounts: User can select from multiple credit card or configured accounts.
Increased security—if you lose your phone, you do not need to replace any credit cards or pieces of identification (as you would if you lost your wallet). You would simply need to suspend your TIS account and re-register a new device. All of your information is secure and does not need to be reissued.
Transaction simplification and practical use. TID(s) have been designed to replace any card that can perform a transaction. The user doesn't need to carry multiple card or identifications.
Information masking and privacy: Using TIDs the real account and credit card numbers are never revealed to the processing agent. Losing your wallet means canceling and renewing credit card and identification. Losing the TIS-enabled cellphone requires only deactivating the service and creating another system TID for the new mobile device. Because credit card and drivers license information is never revealed or kept in the cellphone there is no need to cancel the accounts with the provider.
etc.

According to different embodiments, the Transaction Identification System 101 may include a plurality of different types of components, devices, modules, processes, systems, etc., which, for example, may be implemented and/or instantiated via the use of hardware and/or combinations of hardware and software. For example, as illustrated in the example embodiment of FIG. 1A, the Transaction Identification System may include one or more of the following types of systems, components, devices, processes, etc. (or combinations thereof):
Mobile Client Device(s) 161
Client Computer System(s) 131
Financial Institution and Payment Gateway System(s) 171
Transaction Identification Server System(s) 121
Merchant/Vendor System(s) 141
Trusted Information/Service System(s) 151
WAN component(s) 110
Etc.

In at least one embodiment, the Transaction Identification System may be operable to utilize and/or generate various different types of data and/or other types of information when performing specific tasks and/or operations. This may include, for example, input data/information and/or output data/information. For example, in at least one embodiment, the Transaction Identification System may be operable to access, process, and/or otherwise utilize information from one or more different types of sources, such as, for example, one or more local and/or remote memories, devices and/or systems. Additionally, in at least one embodiment, the Transaction Identification System may be operable to generate one or more different types of output data/information, which, for example, may be stored in memory of one or more local and/or remote devices and/or systems.

Examples of different types of input data/information which may be accessed and/or utilized by the Transaction Identification System may include, but are not limited to, one or more of the different types of input data/information described or referenced herein.

Examples of different types of output data/information which may be generated by the Transaction Identification System may include, but are not limited to, one or more of the different types of output data/information described or referenced herein.

For purposes of illustration, at least a portion of the different types of components of a specific example embodiment of a Transaction Identification System will now be described in greater detail with reference to the example Transaction Identification System embodiment of FIG. 1A.
Transaction Identification Server System(s) (e.g., 121)—In at least one embodiment, the Transaction Identification Server System(s) may be operable to perform and/or implement various types of functions, operations, actions, and/or other features such as, for example, one or more of the following (or combinations thereof):
   Transaction Context Interpreter which, for example, may include functionality for automatically and/or dynamically analyzing contextual criteria (what type of transaction)
      Based on location:
      Transaction Identification Device Application and/or Transaction Identification Server System may be able to determine based on a given geographical location (Via GPS or GSM triangulation.) the transaction type. For instance, the Transaction Identification Server System could determine that a if a customer is using a mobile Transaction Identification client device at the airport (Location obtained via GPS), the customer is planning to check in or identify himself with an airport agent.
   Time Synchronization Engine
   Universal time synchronization (NTP or GPS)
   Search Engine: Search for transactions, logs, items, accounts, options in the TIS databases
   Configuration Engine: Configures TIDs activation and expiration settings, Adds or removes credit cards, identifications, user or gateway information.
   Transaction Time Interpreter: Changes TID activation and expiration time based on time or location
   TID Management Engine: TIDs generation, delivery and management: Creates random TIDs. Associates TIDs with information databases. Delivers TIDs to clients. Replaces, invalidates, revokes and blacklists TIDs. Maintains TIDs databases
   Authentication/Verification Engine (password, software/hardware info, TID, SSL certificates): Checks hardware device validity, Verifies passwords, SSL certificate validity, TIDs activation and expiration times
   Transaction Processing Engine: Selects type of transaction, decides which gateway to use, associates databases information to TIDs.
   Database Manager: Perform operation on user databases: Inserts, Updates, Delete, Add database information
   Transaction Log Component(s): Logs transactions history, Errors, connection from all API
   Transaction Status Tracking Component(s): Assign status based on the state of the transaction: Completed, Incomplete, Pending, Invalid, Error, Declined, Accepted . . . etc.
   Payment Gateway Component(s): Communicate with Payment gateways
   Identification Gateway Component(s): Communicates with Identification gateway
   POS Component(s): Communicate with POS
   Web Interface Component(s): Communicates with the TIS web portal
   Etc.
      According to specific embodiments, multiple instances or threads of the Transaction Identification Server System component(s) may be concurrently implemented and/or initiated via the use of one or more processors and/or other combinations of hardware and/or hardware and software. For example, in at least some embodiments, various aspects, features, and/or functionalities of the Transaction Identification Server System component(s) may be performed, implemented and/or initiated by one or more of the different types of systems, components, systems, devices, procedures, processes described or referenced herein.
      According to different embodiments, one or more different threads or instances of the Transaction Identification Server System component(s) may be initiated in response to detection of one or more conditions or events satisfying one or more different types of minimum threshold criteria for triggering initiation of at least one instance of the Transaction Identification Server System component(s). Various examples of conditions or events which may trigger initiation and/or implementation of one or more different threads or instances of the Transaction Identification Server System component(s) are described herein, which, for example, may include, but are not limited to, one or more of the following (or combinations thereof):
         Users TIS profile could default to a certain transaction type
         Based on the information in the users account a drop down list of available transaction types will be presented to the user (identification, authentication, payment, etc)
         Users profile could be set to use certain transaction types at certain times of the day
         Users location could determine transaction type
         Etc.
         In at least one embodiment, a given instance of the Transaction Identification Server System component(s) may access and/or utilize information from one or more associated databases. In at least one embodiment, at least a portion of the database information may be accessed via communication with one or more local and/or remote memory devices. Examples of different types of data which may be accessed by the Transaction Identification Server System component(s) are described herein.
         Mobile Client Device(s) (e.g., 161)—In at least one embodiment, the Mobile Client Device(s) may be operable to perform and/or implement various types of functions, operations, actions, and/or other features such as, for example, one or more of the various types of mobile device functions, operations, actions, and/or features described herein. According to specific embodiments, multiple instances or threads of the Mobile Client Device component(s) may be concurrently implemented and/or initiated via the use of one or more processors and/or other combinations of hardware and/or hardware and software. For example, in at least some embodiments, various aspects, features, and/or functionalities of the Mobile Client Device component(s) may be performed, implemented and/or initiated by one or more of the different types of systems, components, systems, devices, procedures, processes described or referenced herein.
         According to different embodiments, one or more different threads or instances of the Mobile Client Device component(s) may be initiated in response to detection of one or more conditions or events satisfying one or more different types of minimum threshold criteria for triggering initiation of at least one instance of the Mobile Client Device component(s). Various examples of conditions or events which may trigger initiation and/or implementation of one or more different threads or instances of the Mobile Client Device component(s) are described herein.
         In at least one embodiment, a given instance of the Mobile Client Device component(s) may access and/or utilize information from one or more associated databases. In at least one embodiment, at least a portion of the database information may be accessed via communication with one or more local and/or remote memory devices. Examples of different types of data which may be accessed by the Mobile Client Device component(s) may are described herein.
Financial Institution and Payment Gateway System(s) (e.g., 171)—In at least one embodiment, the Financial Institution and Payment Gateway System(s) may be operable to perform and/or implement various types of functions, operations, actions, and/or other features described and/or referenced herein.
   In at least one embodiment, the Financial Institution and Payment Gateway System(s) may include one or more systems which are managed by or associated with different types of information and/or services provided by Financial Institutions and/or Payment Gateway System such as for example, one or more of the following (or combinations thereof):
   Financial Institutions such as, for example, Wells Fargo, Bank of America, Citibank, JP Morgan Chase, Visa, Mastercard, etc.
   Third party Payment Gateway Service Providers such as, for example, Paypal, Google Checkout, etc.
   House the payment gateway on the Transaction Identification Server Systems
   Payment Gateway APIs
   Etc.
Client Computer System component(s) (e.g., 131)—In at least one embodiment, Client Computer System(s) may include end user and/or customer personal computer system(s). In at least one embodiment, one or more Client Computer System(s) may be operable to perform and/or implement various types of functions, operations, actions, and/or other features such as, for example, one or more of the following (or combinations thereof):
   TID processing and display capabilities: Display current valid TIDs. Visually replaces expired TID
   Transaction history: Maintains a transaction history database
   Transaction Searching engine: Search for transactions bases on criteria
   System configuration: TIDs expiration and activation time. Scanning options, other client settings
   Transaction poll engine: Checks active transaction in the Transaction Identification Server System.
   Provides User interface. Password input, Transaction activity, History activity, Confirmation activity, Error Log,
   API interface to Transaction Identification Server Systems
   NTP time synchronization: Use to check for validity of TIDs
   etc.
Merchant/Vendor System(s) (e.g., 141)—In at least one embodiment, Merchant/Vendor System(s) may include one or more systems which are managed by or associated with different types of vendors and/or merchants such as for example, one or more of the following (or combinations thereof):
   Online Merchant/Vendor websites such as, for example, Amazon.com, Newegg.com, Apple.com, Ebay.com, etc.
   Brick-and-mortar merchant/vendor systems such as, for example, Safeway, Barnes & Nobel, Best Buy, Costco, etc.
   Vending machines
   Mobile vendors (food trucks)
   Etc.
Trusted Information/Service System(s) (e.g., 151)—In at least one embodiment, Trusted Information/Service System(s) may include one or more systems which are managed by or associated with different types of information and/or services provided by trusted entities/sources such as for example, one or more of the following (or combinations thereof):
   Governmental entities/sources such as, for example, one or more of the following (or combinations thereof):
      State Department of Motor Vehicles (DMV)
      Internal Revenue Service (IRS)
      Transportation Security Association (TSA)
      Municipal Airport Operators
      Department of Defense
      Department of Homeland Security
      Library of Congress
      U.S. Patent and Trademark Office
      US Postal Service
      US Department of State (Passports)
      FAA Federal Aviation Administration
      All (or selected) Government Departments and Agencies
      Trusted information sources such as, for example:
      Lexis-Nexis
      Credit bureaus such as, for example, Equifax, Experian, TransUnion, etc.,
      Financial Institutions
      Airline operators
      Educational Institutions (e.g., Universities, Colleges, etc.)
   etc.
      In at least one embodiment, one or more of the Trusted Information/Service System(s) may include one or more Local Transaction Identification Appliance(s) (e.g., 153). In at least one embodiment, a Local Transaction Identification Appliance may be operable to perform and/or implement various types of functions, operations, actions, and/or other features described and/or referenced herein.
WAN (e.g., 110)—In at least one embodiment, WAN 110 may include one or more types of networks such as, for example, wide area network(s), the Internet, public networks, private networks, and/or combinations thereof.

As used herein, the following terms may have at least the following meanings:

TIS: a Transaction Identification System or portion(s) thereof.

Agent: user/device/software that initiates a transaction in the Transaction Identification System (TIS). For example, in a payment transaction, the Agent may typically represent the user/device/software associated with the merchant/vendor/business operator/service provider. In an identification transaction, the Agent may typically represent the user/device/software associated with the authority or entity who desires/requests to verify another person's identity (and/or associated security credentials).

Agent Device: A device (such as, for example, a mobile device, a computer system, a system or component of a computer network, etc.) associated with the Agent side of a TIS transaction.

Agent user: A person or user operating an Agent Device.

Client: user/device/software that participates in a TIS transaction with an Agent. For example, in a payment transaction, the Client may typically represent the user/device/software associated with the purchaser/customer/consumer. In an identification transaction, the Client may typically represent the user/device/software associated with the person whose identity is to be verified.

Client Device: A device (such as, for example, a mobile device, a computer system, a system or component of a computer network, etc.) associated with the Client side of a TIS transaction.

Client user: A person or user operating a Client Device.

User: a person acting as an Agent or Client

Transaction Identification Device Application: TIS-enabled software running on a device or system such as, for example, a mobile device, a computer system, etc.

Transaction Gateway: a system that is operable to process transaction on behalf of a Transaction Identification Server System. Examples of different types of transaction gateways may include, but are not limited to, one or more of the following (or combinations thereof): Payment Gateway(s) (e.g., PayPal, Bank of America etc.); Identification Gateway(s) (e.g., DMV, Government organizations etc.); Authentication Gateway(s) (e.g., VeriSign, certificate authority etc.); etc.

FIG. 1B illustrates a block diagram depicting a conventional client/server communication system.

A communication system 100 includes a multiplicity of networked regions with a sampling of regions denoted as a network region 102 and a network region 104, a global network 106 and a multiplicity of servers with a sampling of servers denoted as a server device 108 and a server device 110.

Network region 102 and network region 104 may operate to represent a network contained within a geographical area or region. Non-limiting examples of representations for the geographical areas for the networked regions may include postal zip codes, telephone area codes, states, counties, cities and countries. Elements within network region 102 and 104 may operate to communicate with external elements within other networked regions or within elements contained within the same network region.

In some implementations, global network 106 may operate as the Internet. It may be understood by those skilled in the art that communication system 100 may take many different forms. Non-limiting examples of forms for communication system 100 include local area networks (LANs), wide area networks (WANs), wired telephone networks, cellular telephone networks or any other network supporting data communication between respective entities via hardwired or wireless communication networks. Global network 106 may operate to transfer information between the various networked elements.

Server device 108 and server device 110 may operate to execute software instructions, store information, support database operations and communicate with other networked elements. Non-limiting examples of software and scripting languages which may be executed on server device 108 and server device 110 include C, C++, C# and Java.

Network region 102 may operate to communicate bi-directionally with global network 106 via a communication channel 112. Network region 104 may operate to communicate bi-directionally with global network 106 via a communication channel 114. Server device 108 may operate to communicate bi-directionally with global network 106 via a communication channel 116. Server device 110 may operate to communicate bi-directionally with global network 106 via a communication channel 118. Network region 102 and 104, global network 106 and server devices 108 and 110 may operate to communicate with at least one other and with one or more other networked device located within communication system 100.

Server device 108 includes a networking device 120 and a server 122. Networking device 120 may operate to communicate bi-directionally with global network 106 via communication channel 116 and with server 122 via a communication channel 124. Server 122 may operate to execute software instructions and store information.

Network region 102 includes a multiplicity of clients with a sampling denoted as a client 126 and a client 128. Client 126 includes a networking device 134, a processor 136, a GUI 138 and an interface device 140. Non-limiting examples of devices for GUI 138 include monitors, televisions, cellular telephones, smartphones and PDAs (Personal Digital Assistants). Non-limiting examples of interface device 140 include scanning device, barcode scanner, fingerprint reader, pointing device, mouse, trackball, scanner and printer. Networking device 134 may communicate bi-directionally with global network 106 via communication channel 112 and with processor 136 via a communication channel 142. GUI 138 may receive information from processor 136 via a communication channel 144 for presentation to a user for viewing. Interface device 140 may operate to send control information to processor 136 and to receive information from processor 136 via a communication channel 146. Network region 104 includes a multiplicity of clients with a sampling denoted as a client 130 and a client 132. Client 130 includes a networking device 148, a processor 150, a GUI 152 and an interface device 154. Non-limiting examples of devices for GUI 138 include monitors, televisions, cellular telephones, smartphones and PDAs (Personal Digital Assistants). Non-limiting examples of interface device 140 include pointing devices, mousse, trackballs, scanners and printers. Networking device 148 may communicate bi-directionally with global network 106 via communication channel 114 and with processor 150 via a communication channel 156. GUI 152 may receive information from processor 150 via a communication channel 158 for presentation to a user for viewing. Interface device 154 may operate to send control information to processor 150 and to receive information from processor 150 via a communication channel 160.

For example, consider the case where a user interfacing with client 126 may want to execute a networked application. A user may enter the IP (Internet Protocol) address for the networked application using interface device 140. The IP address information may be communicated to processor 136 via communication channel 146. Processor 136 may then communicate the IP address information to networking device 134 via communication channel 142. Networking device 134 may then communicate the IP address information to global network 106 via communication channel 112. Global network 106 may then communicate the IP address information to networking device 120 of server device 108 via communication channel 116. Networking device 120 may then communicate the IP address information to server 122 via communication channel 124. Server 122 may receive the IP address information and after processing the IP address information may communicate return information to networking device 120 via communication channel 124. Networking device 120 may communicate the return information to global network 106 via communication channel 116. Global network 106 may communicate the return information to networking device 134 via communication channel 112. Networking device 134 may communicate the return information to processor 136 via communication channel 142. Processor 136 may communicate the return information to GUI 138 via communication channel 144. User may then view the return information on GUI 138.

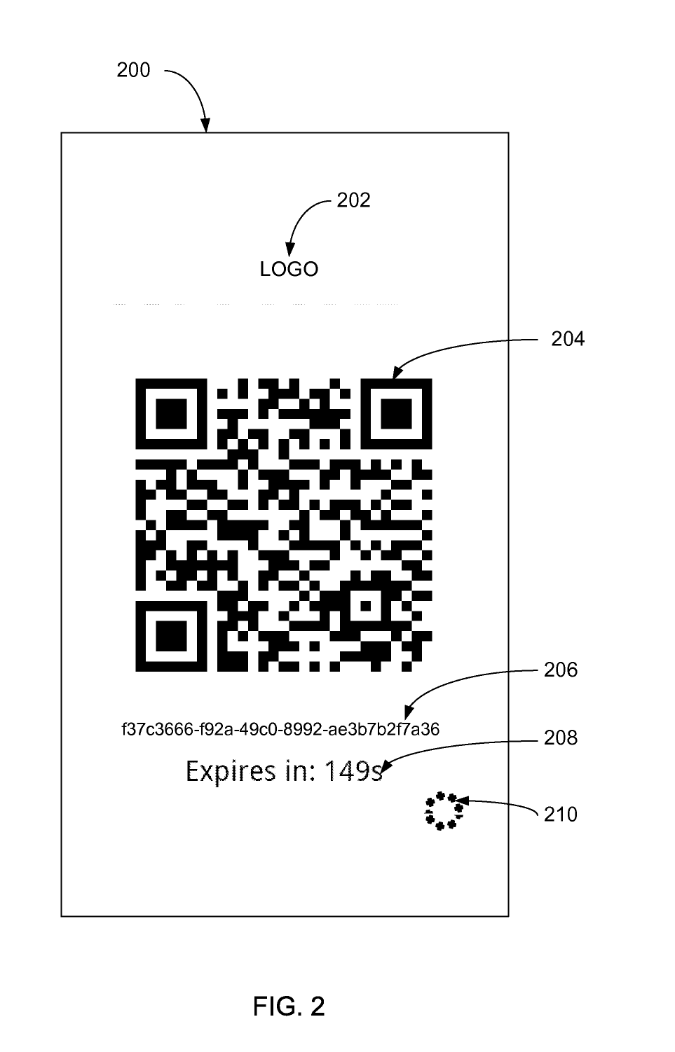

FIG. 2 presents a diagram illustrating an example transaction identifier (TID), in accordance with a specific embodiment.

As illustrated in the example embodiment of FIG. 2, a transaction identifier (TID) 200 may include, but is not limited to, one or more of the following features and/or content (or combinations thereof): a logo 202, a barcode insignia 204, a character string 206, a time identifier 208 and a poll indicator 210.

According to different embodiments, logo 202 may operate as a graphic mark or emblem for promoting brand recognition.

Barcode insignia 204 may operate to represent alphanumeric information and/or other machine readable information which may be presented to a scanning or reading device for converting the barcode insignia to its alphanumeric character representation. A non-limiting example of a reading device for interpreting barcode insignias includes an optical reading device such as a scanner or camera.

As illustrated in the example embodiment of FIG. 2, TID 200 may optionally include a character string 206 which, for example, may operate to present identifier information as well as other information associated with character string 206. For example, in one embodiment, character string 206 may represent an alphanumeric character string associated with barcode insignia 204. Non-limiting examples of other information associated with character string 206 may include, for example: a lifetime value, an activation time, an expiration time, a name, a company name, etc.

According to specific embodiments, time identifier 208 may operate to present information associated with the expiration of transaction identifier 200. For example, as illustrated in the example embodiment of FIG. 2, the displayed value indicated by time identifier 208 indicates that the displayed transaction ID 200 will expire in 149 seconds. In at least one embodiment, when the displayed Transaction ID expires, the system or device displaying the Transaction ID (such as, for example, the mobile client device), may automatically display a new and different Transaction ID having its own associated expiration time value.

According to specific embodiments, in order to increase security of the Transaction

Identification System (and thereby reduced fraud/theft), each different Transaction ID may have associated therewith a respective expiration/validation criteria which, for example, may be used to determine or govern the valid use and/or expiration of its associated Transaction ID. Examples of different types of expiration/validation criteria which may be used may include, but are not limited to, one or more of the following (or combinations thereof):
Time-based expiration criteria such as, for example:
   Transaction ID to expire in X seconds. According to different embodiments, the value X may be a value within a range, for example, from 1-86,400, such as, for example, X=30, X=60, X=300, X=3600, etc.
   Transaction ID to expire after specified time/date (e.g., Transaction ID to expire after 11:04 am-22-2011)
   Transaction ID only valid between time/date values of X and Y (e.g., Transaction ID only valid between 10:00 am-10:06 am-22-2011)
   Transaction ID to expire at the transaction is not completed within X seconds.
   Transaction ID to remain valid during the processing of the transaction.
Location-based expiration criteria such as, for example:
   Transaction ID only valid while associated mobile client device is detected as being within a range (R) of a designated geographic location. (e.g., airport check-in TID only valid while location of associated mobile client device is detected as being at designated airport location; ATM-withdrawal TID only valid while location of associated mobile client device is detected as being within 50 meters of an ATM device)
Security-based expiration criteria such as, for example:
   Transaction ID to expire sooner if it is detected that current security conditions meet or exceed a specified threshold value. According to different embodiments, different types of events and/or conditions may be used to determine current security conditions such as, for example, one or more of the following (or combinations thereof):
      security criteria associated with the type of transaction to be performed
      security criteria associated with the location of the mobile client device
      security criteria associated with the user or vendor/merchant
      security criteria associated with the types of communication channels can use to conduct the transaction
      security criteria associated with one or more devices/systems participating in the transaction
      etc.
Motion/Movement based expiration criteria such as, for example:
   Transaction ID valid only while associated mobile client device is detected as being stationary (or at a fixed geographic location) for at least N seconds (e.g., where N is a value within the range 1-86,400, such as, for example, N=5, N=60, N=300, etc.)
   Transaction ID valid only while associated mobile client device is detected as moving.
   Transaction ID valid only while associated mobile client device is detected as moving in a particular direction.
   Transaction ID valid only while associated mobile client device is detected as moving towards (or away from) a specific geographic location.
   etc.
Use-based expiration criteria such as, for example:
   Transaction ID to immediately expire upon detecting that TID is attempting to be used for a different type of transaction other than the type of transaction it was intended to be used for.
   Transaction ID to immediately expire upon any detected attempt to use Transaction ID to conduct one or more specific type(s) of transactions.
   Transaction ID remained valid only for conducting one or more specific type(s) of transactions.
Fraud-based expiration criteria such as, for example:
   Transaction ID to immediately expire upon detection of any fraud-based activities.
   etc.
User-based expiration criteria such as, for example:
   Transaction ID valid to expire . . .
   etc.
Other Types of expiration criteria such as, for example:
   If an attempted transaction was unsuccessfully processed due to an expired Transaction ID, increase expiration time value of next displayed Transaction ID (e.g., so that it remains valid/active for a longer period of time)

According to specific embodiments, TID activation/validation/expiration could be also be implemented using one or more of the following techniques (or combinations thereof):
Complete Pattern sequence:
e.g., All TIDs from 1, 2, 3 . . . n need to be valid for them to be valid.
Partial pattern sequence
e.g., Only m TIDS form sequence 1, 2, 3 n need to be valid
Predefined pattern sequence
e.g., TIDs m, p and q . . . n from sequence 1, 2, 3 . . . n need to be valid.
Replacement sequence:
   Multiple time based valid TIDs
      e.g., Only one TIDs from sequence 1, 2, 3 . . . n need to be valid in a x second interval. In this case all TIDs have the same activation and expiration time but their replacement is fast with relation of the number of valid TIDs. For example: Display and replace TIDs over a 5 second interval. This could require a more advanced scanning and optical hardware.
   Replacement of TIDs based on location and time.
      TIDs activation and expiration time could be replaced based on geographical location or time of the day for security purposes.
etc.

In at least one embodiment, the set(s) of Transaction IDs which are provided to the client/agent device(s) may include one or more of the following (or combinations thereof):
one or more online type TID(s)
one or more offline type TID(s)

In at least one embodiment, an online type Transaction ID may be configured or designed as a temporary Transaction ID which has a relatively short time window of activation (e.g., 30 secs, 60 secs, 5 minutes, 30 minutes, etc.). As explained in greater detail herein, in at least one embodiment, it may be preferable for a mobile device to use online type Transaction IDs when performing transactions during times when the mobile device is able to establish connectivity to the Transaction Identification Server System.

In at least one embodiment, an offline type Transaction ID may be configured or designed as a Transaction ID which does not expire, and/or which has a relatively large time window of activation (e.g., 12 hours, 24 hours, 7 days, 30 days, etc.). In at least one embodiment, it may be preferable for a mobile device to use offline type Transaction IDs when performing transactions during times when the mobile device is not able to establish connectivity to the Transaction Identification Server System.

In at least one embodiment, when a mobile device is online, new TIDs (e.g., that have not yet expired) may be periodically provided by the TISS to the mobile device. In at least some embodiments, during that process, the TISS may verify that the mobile device currently has available to it at least one valid offline TID. In at least one embodiment, the expiration of one or more offline TIDs may be specified or managed by a user or other entity.

In at least one embodiment, when a given TID has been used to perform a transaction, and may automatically expire so that it can no longer be used.

In at least one embodiment, to generate unique UUIDs or TIDs the Transaction Identification Server System may be operable to use timestamp information and secret/proprietary values as the seeds for UUID generation. The UUIDs may then be hashed using one or more different types of encryption algorithms such as, for example, MD5 or SHA.

According to different embodiments, examples of various different transaction types may include, but are not limited to, one or more of the following (or combinations thereof):
payment transactions;
user identity verification transactions;
user age verification transactions;
universal shopping cart transactions;
contact information exchange transactions
user check-in/out transactions
URL access/login transactions
etc.

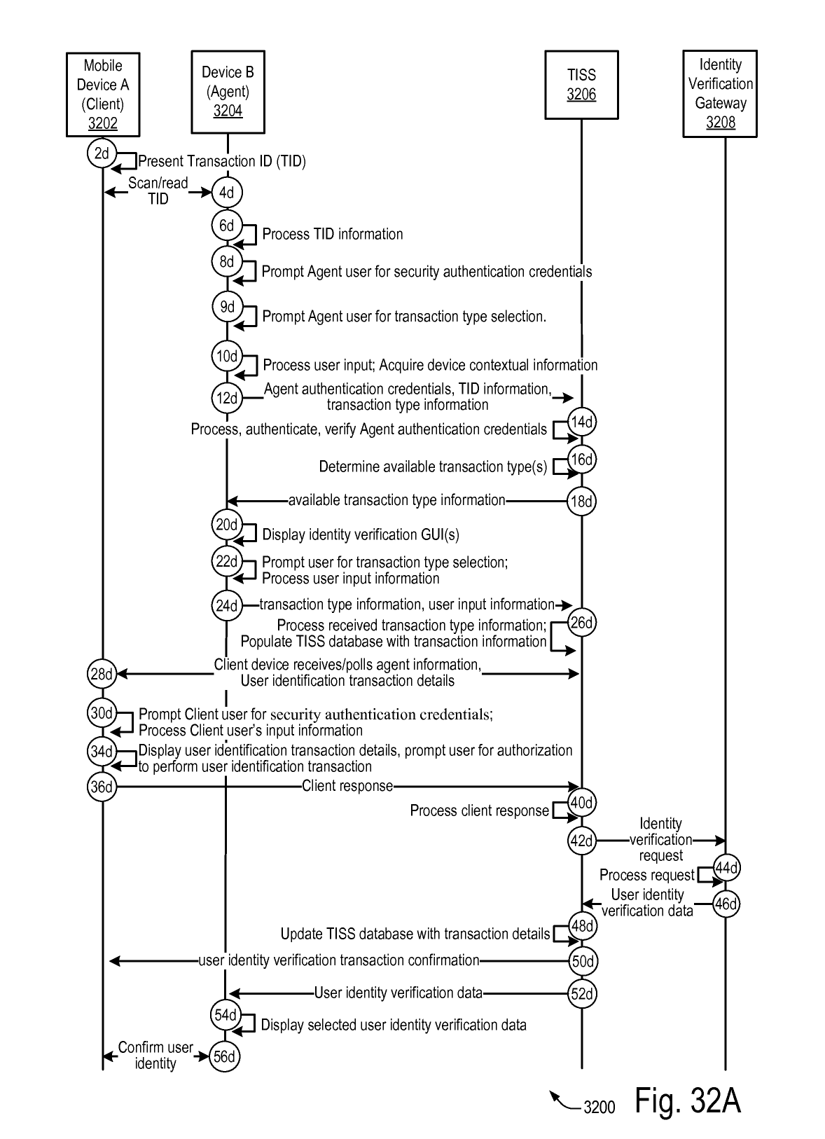

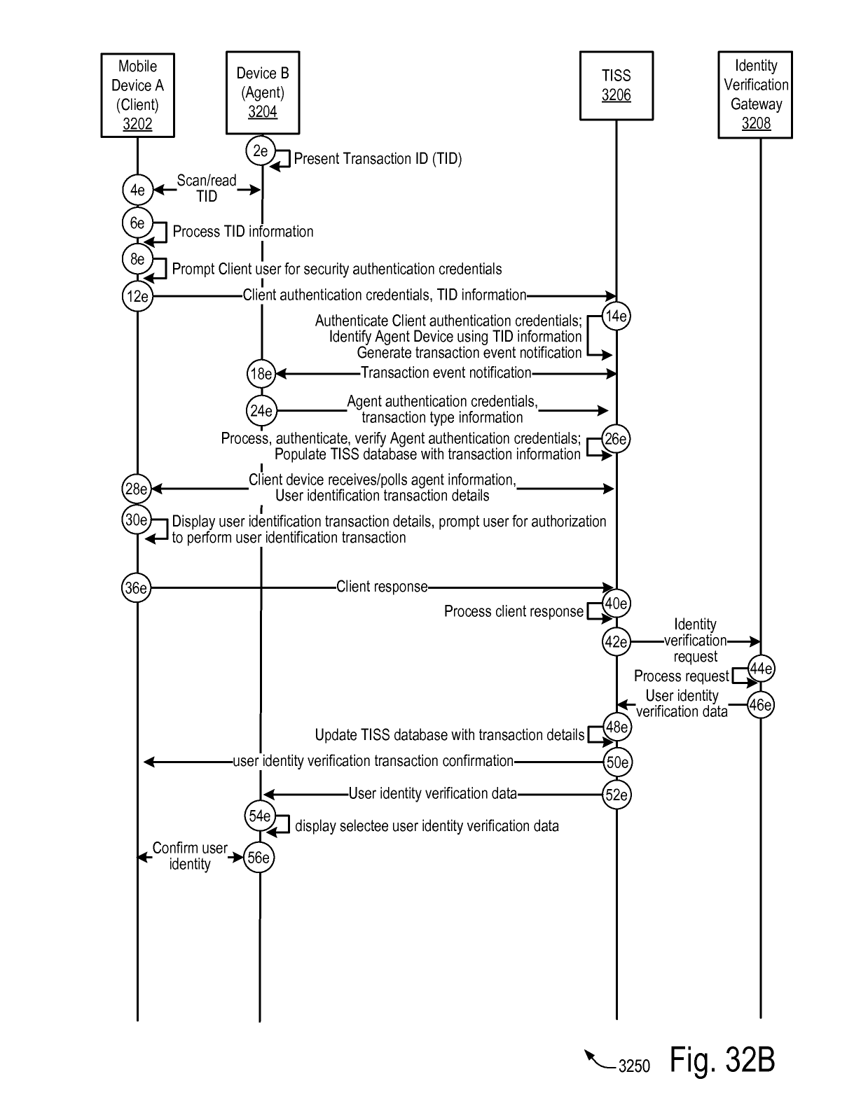

According to different embodiments, each of the different transaction types listed above may have associated therewith one or more subordinate transaction types. For example, in the specific example embodiment of FIG. 32A, different types of subordinate transactions (or sub-transactions) relating to the user identity verification transaction may include, but are not limited to, one or more of the following (or combinations thereof):
driver's license verification
Social Security number verification
passport verification
military ID verification
student ID verification
government ID verification
hospital ID verification
company ID version
security credential verification
Identification
Payment
Authentication
Electromechanical
Voting—“American Idol” displays a voting TID on screen for each singer, user scans the voting TID and casts their vote
Ticket/Passes—Buses are installed with scanners that scan your Ticket TID upon boarding the bus (proves you bought your monthly bus pass)
Rewards—Virgin America displays a reward TID, user scans it and the system redeems your Virgin Elevate points.—Visa Rewards Credit Card, rewards website and paper catalog displays reward TIDs, user scans the one for the item they want and it redeems their points.
Discount/Coupon—Safeway cards, coupons, senior citizen discount
Charity—During Hope for Haiti telethon the Red Cross Charity TID is displayed on screen, users scan to donate money—and this could be used to track your personal charitable donations for tax purposes for the year
Subscription—Scan a subscription TID—from TV, email, magazine, and subscribes you to mailing lists, promotions, text messages etc.

According to different embodiments, the Transaction Identification Server System may provide a given mobile client device with one or more set(s) or batch(es) of N pre-approved Transaction IDs (e.g., N=value selected from 1-1000), with each pre-approved Transaction ID having its own respective window of valid/active use. For example, in at least one embodiment, a mobile client device may be provided with a batch of 6 pre-approved Transaction IDs, wherein each of the pre-approved Transaction ID has an associated expiration time value of 180 seconds (e.g., meaning that a given Transaction ID will expire 180 seconds after it is first displayed at the mobile client device). Additionally, in at least one embodiment, the mobile client device may also receive Transaction ID order information relating to a particular order in which the transaction IDs are to be displayed in sequence. Thus, for example, in one embodiment, the Transaction ID order information may specify that a first particular Transaction ID (from the group of 6 pre-approved Transaction IDs) is to be the first Transaction ID to be displayed at the mobile client, and that a second particular Transaction ID (from the group of 6 pre-approved Transaction IDs) is to be the second Transaction ID to be displayed at the mobile client. Thus, in this particular example, once the first displayed Transaction ID has expired, the mobile client device may automatically and dynamically display the second Transaction ID until it expires. This process may be repeated until each of the 6 pre-approved Transaction IDs has been displayed according to their specific display order and expiration time values.

In at least one embodiment, only one particular Transaction ID may be valid for any given time interval at a given mobile client device. In other embodiments, more than one Transaction ID may be valid for any time interval at a given mobile client device. For example, in one embodiment, several different Transaction IDs may be valid/active during a given time interval, and the mobile client device may be instructed to continuously rotate through the display each of these valid Transaction IDs (e.g., every 2-3 seconds) in a sequential order during the specified time interval (e.g., 60 secs, 90 secs, 180 secs, etc.). In one embodiment, in order to successfully complete a transaction, a reading or scanning device must successfully read each of the different valid Transaction IDs during a specified time interval (e.g., 10 seconds). In some embodiments, in order to successfully complete a transaction, a reading or scanning device must successfully read each of the different valid Transaction IDs in a specific sequence during a specified time interval (e.g., 10 secs, 30 secs, 60 secs, etc.).

In at least one embodiment, the Transaction Identification Server System may track and manage the Transaction IDs, TID display orders, and associated expiration time value for a plurality of different devices/clients/systems. Using this information, the Transaction Identification Server System may be able to automatically, dynamically, and/or independently determine (or predict) which particular Transaction IDs should be validly displayed at a given mobile client device during a given time interval. Additionally, the Transaction Identification Server System may be able to automatically determine and/or identify particular mobile client devices which are (or may soon be) in need of additional batches of Transaction IDs, and may take or initiate appropriate action(s) to provide each of the identified mobile client devices with respectively different sets or batches of new Transaction IDs (along with associated TID expiration information and/or other related information).

In at least one embodiment, poll indicator 210 may operate to provide an active indicator while a client device polls the Transaction Identification Server System (and/or other components of the Transaction Identification System) for any active or pending transaction(s) involving or relating to that particular client device. For example, in one embodiment, while the client device is actively polling, poll indicator 210 may be displayed as a rotating or spinning symbol/image, and while the client device is not actively polling, poll indicator 210 may be displayed as a static or stationary symbol/image.

In at least one embodiment, the client device may be configured or designed to perform active polling during one or more active polling time interval(s). In one embodiment, an active polling time interval may be defined as period of time for performing a poll and may be dynamically configurable (e.g., by a user of the client device, by the Transaction Identification Device Application, by the Transaction Identification Server System, etc.). During the active polling time intervals, one or more polling operations may be performed, wherein, for example, the client device continuously and/or periodically queries the Transaction Identification Server System for active, pending and/or available transactions involving or relating to that particular client device. In one embodiment, if no transactions are detected, active polling operations at the client device may be set to automatically suspend (or cease) in order to save battery power, for example. At the expiration of active polling time interval, a user selectable refresh icon may replace the poll indicator icon to provide the user of the client device with the ability to manually reactivate or reinitiate polling operations, as desired.

This polling mechanism may be independent of transaction identifier 200 countdown expiration. As a not-limiting example, active polling time interval may be configured for 60 seconds and the second time interval may be configured for 3 seconds. Active polling time interval and second time interval may be adjusted in order to minimize system resources. For a poll function performed, the client system identifier may be communicated to the Transaction Identification System for authentication. Additional information may be communicated to authenticate devices for poll operations performed. Non-limiting examples of other information communicated include hardware identifiers, software identifiers, geographic location or client Secure Socket Layer (SSL) certificates. During active polling time interval, the Transaction Identification System may communicate a transaction in progress for the poll function performed with the mobile client presenting information associated with the provided agent name and password. Furthermore, other non-limiting types of agent information may be communicated to the client such as agent address, picture, logo and transaction type.

Transaction identifier 200 may be defined as a unique universal identifier (UUID) which may be represented by barcode insignia 204. Barcode insignias may be one dimension numeric barcodes or alphanumeric barcodes. Non-limiting examples of numeric barcode insignias include Code 11, EAN 13 and EAN 8. Non-limiting examples of alphanumerical barcodes include code 128 and Code 39. Furthermore, barcode insignia 204 may be represented as two dimensional barcodes. Non-limiting examples of two dimensional barcodes include QR code and Data Matrix. Transaction identifier 200 may also be represented by an image. Transaction identifier 200 may also be represented as static or animated. Other representations for transaction identifier 200 may be employed using a variety of machine readable devices (e.g. scanners) which may then be translated into UUID format. UUID may be universally unique and may be generated randomly, pseudo-randomly or not associated with randomness. For this embodiment, a UUID may be represented by random data. UUID data may be represented via encrypted or plain text. UUID may include any known information and the information may be processed by the identification system. The UUID data may be associated with user information databases associated with one or more Transaction Identification Server System(s) (TISS). For example, identification system may generate an UUID and associate its data with user financial information. Known database methods may be used to associate UUID data with user information. Database methods may include index database entries using UUID data corresponding to a user information table entry. For example, a 32 character string containing alphanumeric characters may be used as an index table for user financial information. UUID data may operate to be displayed or presented. The size for the UUID may be represented by the maximum data size the data insignia may operate to represent. Transaction identifier 200 may be temporary and exhibit a lifetime characterized by an expiration time as denoted by expiration time identifier 208 and an activation time. Activation and expiration times may be configurable. Following expiration, transaction identifier 200 may be replaced by a new transaction identifier which may be characterized by a different activation and expiration time. Transaction identifier may be replaced successively based upon the associated expiration and activation time.

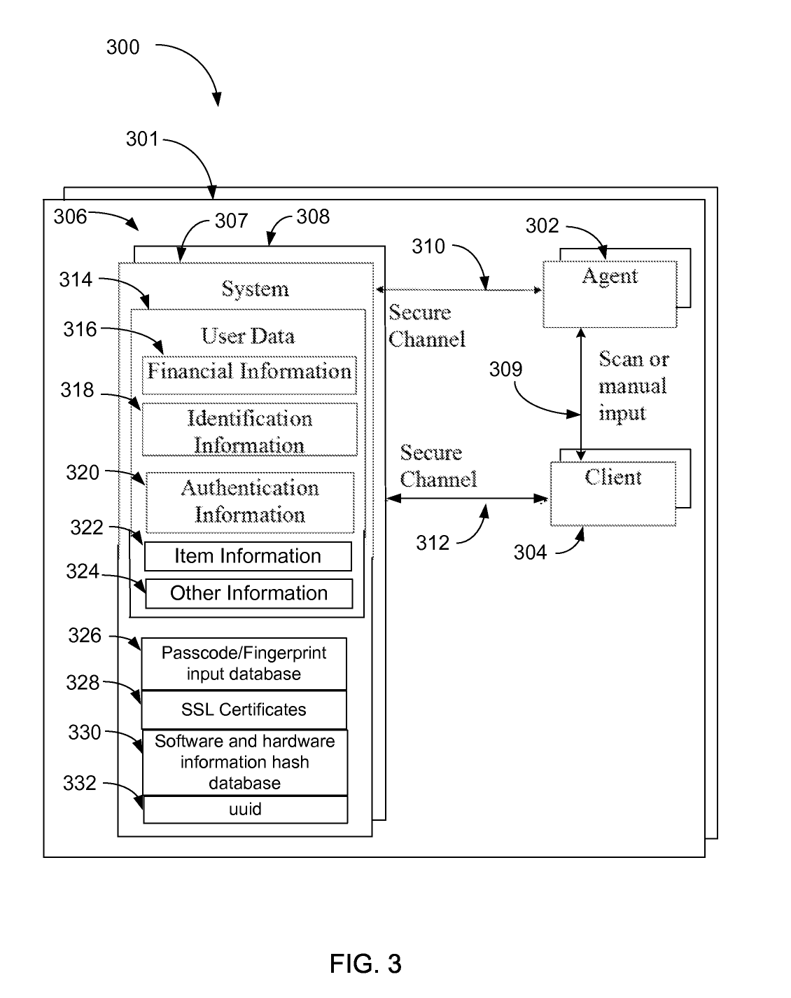

FIG. 3 presents a block diagram illustrating an example identification system for communications applications, in accordance with a specific embodiment.

An identification system 300 includes a multiplicity of identification sub-systems with a sampling denoted as an identification sub-system 301.

Identification sub-system 301 includes a multiplicity of agents with a sampling denoted as an agent 302, a multiplicity of clients with a sampling denoted as a client 304 and a Transaction Identification Server System (TISS 306).

TISS 306 includes an agent TISS 307 and a client TISS 308. Agent TISS 307 may operate to perform TISS operations associated with agent 302 and client TISS 308 may operate to perform TISS operations associated with client 304.

Agent 302 may operate to communicate identification information bi-directionally with client 304 via a communication channel 309. Non-limiting examples for communication channel 309 include barcode scanners/readers and interface devices (e.g. keyboard, mouse, fingerprint, etc.). TISS 306 may operate to communicate identification information bi-directionally with agent 302 via a secure communication channel 310 and with client 304 via a secure communication channel 312.

TISS 306 includes a user information portion 314, a passcode/fingerprint input database 326, a SSL certification database portion 328, a software/hardware hash database 330 and a UUID portion 332. User information portion 314 may operate to represent information associated with clients or agents. Passcode/fingerprint input database 326 may operate to store and communicate information associated with passcodes and fingerprints. SSL certification database portion 328 may operate to store and communicate information associated with SSL certificates. Software/hardware hash database 330 may operate to store and communicate information associated with hashes and hash tables. UUID portion 332 may operate to store and communicate information associated with UUID processing.

User information portion 314 includes a financial information portion 316, an identification information portion 318, an authentication information portion 320, an item information portion 322 and another information portion 324. Non-limiting examples of information associated with other information portion 324 includes user item information portion 322 or other types of digitally represented information used in consumer transactions. User information portion 314 may be associated with transaction oriented identifiers.

Transaction identifiers may be associated with user financial information portion 316 databases and used to perform financial transactions such as credit card payments. Furthermore, transaction identifiers may be associated with authentication information portion 320 database and be used, as an example, in performing authentication for a user to access secure content via a secure web page. Furthermore, transaction identifiers may be associated with user identification information and may, as an example, be used by an agent in order to identify a user via a user's drivers' license information.

Identification sub-system 301 may operate to perform validation and processing associated with identifiers. Non-limiting examples of identifiers include system oriented and transaction oriented. Transaction oriented identifiers may be associated with information databases. Non-limiting examples of information database include financial, identification, authentication, items databases or other user information databases associated with consumer transactions. System oriented identifier may be associated with transaction identifiers databases and security information databases. Security information databases may include passcode/biometric ID information, SSL certificates, user device software information and hardware information and transaction UUIDs. Non-limiting examples of user information databases include software version, name of mobile carrier, software build, Simple Object Access Protocol (SOAP) agent type, Internet Protocol (IP) address, telephone number, Global Positioning System (GPS) location coordinates, cell phone triangulation location, Media Access Control (MAC) addresses and International Mobile Equipment Identity (IMEI) number. User device information may also be represented and communicated in hash form associated with identification system databases. The hash may be created from software and hardware elements. For example, the hash may be created from MAC address, IMEI number and system identifier. Furthermore, as an example, a hash function associated with the identification system may use the MAC address, IMEI number and system identifier parameters as input information for creating a hash key.

Non-limiting examples of processing transaction identifiers associated with financial information include credit card and debit card transactions. Transaction identifier processing associated with authentication information may include granting access to secure resources. Granting access to a secure website may be considered a non-limiting example of transaction identifier processing associated with authentication information. Furthermore, as a non-limiting example, transaction oriented identifier processing associated with authentication information databases may include granting access to an automobile, residence or business. Transaction identifiers processing associated with identification information may be performed for obtaining or confirming the identity of a client. Non-limiting examples of transaction identifier processing associated with identification information include airport check-in and for financial purposes. Furthermore, as a non-limiting example, transaction identifier processing associated with identification information databases may include verification of age for purchase or consumption of services or products with age limitations.

Depending on the type of transaction identifier 200 (FIG. 2), transaction identifier 200 (FIG. 2) may be associated with financial (e.g. credit card, debit card, etc.) identification or authentication credentials information databases associated with the identification system. Client information associated with transaction identifier 200 (FIG. 2) may be stored in server identification system databases (e.g. server device 108 (FIG. 1B)). For example, by acquiring the transaction oriented identifier from a client, the processing agent (e.g. agent 302) may receive supported transactions available for the client (e.g. client 304) (e.g. client may be identified, authenticated or perform payments). Furthermore, client personal information may not be disclosed to the agent (e.g. agent 302). As a non-limiting example, the agent (e.g. agent 302) may receive the client's name or associated nickname and a list of available supported client transactions. Non-limiting examples of associated transactions may include payment, identification or authentication. Payment transaction options may be further subdivided. Non-limiting examples of further subdivisions include capture, void and refund. Following successful agent (e.g. agent 302) authentication, client (e.g. client 304) personal information may be revealed to agent depending on client settings associated with transaction identifier 200 (FIG. 2) and a transaction type. For example, for an identification transaction, associated client identification information may be communicated to agent. Client personal information and transaction types available to agents may be configurable via TISS 306. Clients may operate to control and configure associated personal information which may be released. Furthermore, clients may operate to control and configure associated transactions which may be accepted by processing agents. Agents may perform transaction processing based upon allowed transactions configured by a client.

System oriented identifiers may be authenticated via TISS 306. System oriented identifiers may conform to QUID having an activation and expiration time and may be associated with user (e.g. agent 302, client 304) software and hardware device information. System oriented identifiers may not be visible to the user and may not be represented by a barcode insignia. System oriented identifiers may be associated with information extracted from the user device (e.g. client 304, agent 302) and may be software or hardware associated information or other types of information that may be used for identifying a device. System oriented identifiers may be generated when a user creates an account with TISS 306. During initial account creation, users may provide associated user information. Non-limiting examples of user information include financial, identification and authentication information. Following verification of information provided by user, TISS 306 may operate to generate transaction identifier 200 (FIG. 2) associated with initialization information databases and present created transaction identifier 200 (FIG. 2) to user via a GUI device (e.g. GUI 138). Client 304 devices may then scan (e.g. using interface device 140 (FIG. 1B)) the presented transaction identifier 200 (FIG. 2) for configuring TISS 306. Furthermore, a user may manually enter the transaction oriented identifiers for initializing client 304 user device. Manual configuration may be performed via supported interface devices (e.g. interface device 140 (FIG. 1B)).

Following the performance of scanning a transaction oriented identifier and successful authentication with TISS 306, user software may operate to extract available software and hardware information from the device. Non-limiting examples of information which may be extracted include IMEI, telephone number, device geographic location, hardware address and IP address. The extracted information may be communicated to TISS 306. Furthermore, TISS 306 may operate to generate a hash-key from the received information. A hash function may operate to create a hash key from the received information. Furthermore, the created hash-key may be associated with user information databases and/or system transaction identifiers associated with TISS 306. Following receipt of information, hash-key generation and database association with client 304 user information, TISS 306 may operate to process transactions for client 304 associated user devices. Furthermore, user device may receive transaction identifier 200 (FIG. 2) from TISS 306 for presentation by client 304 device for display via a GUI (e.g. GUI 138 (FIG. 1B)).

Successful authentication may occur following a valid system oriented identifier, valid transaction identifier, valid pass-code, valid biometric IDs, valid SSL certificates, valid hardware and software device information, valid transaction UUID and other information useful for validating a user. Received information may be validated using information stored in identification system databases. For example a system identifier may be considered valid if it has a match in the identification system database. Furthermore a system oriented identifier may be considered valid if processed within its activation and expiration times as defined in the Transaction Identification System databases. Transaction oriented identifier may be validated in the same fashion. SSL certification validation may follow standard client/server SSL certificates validation. Password or passcode may be considered valid upon a match in the identification system database. Transaction UUID may be considered valid if it exists in the Transaction Identification System database for the transaction in progress. Device software and hardware information may be compared individually. For example, user device MAC address may be required to match a stored MAC address associated with the identification system for a respective user device. A hash function may operate to create hash keys for sets of software and hardware information received from the user device. As a non-limiting example, a hash function may operate to use the MAC address and IMEI as an input parameter for creation of a hash key. For purposes of comparison, the created hash key may be required to correspond to a stored hash key associated with the Transaction Identification System. Passcodes and digital biometric IDs may be compared to passcode and biometric ID databases associated with the Transaction Identification System and may be considered valid upon determination of a resulting match.

Passcodes may be provided via supported interface devices (e.g. interface device 140 (FIG. 1B)). Non-limiting examples of information provided for passcodes include alphanumeric characters, symbols and digital biometric IDs.

Non-limiting examples of financial instruments supported include VISA, MasterCard, American Express, retail store credit, discount transactions and other types of electronically communicated financial transactions. Non-limiting examples of supported identification devices include driver's license, passport and other types of identification which may be represented in a digital form or as an image. Non-limiting examples of authentication methods supported by TISS 306 include website authentication, password validation and securing physical access.

Accounts associated with identification sub-system 301 may be created using a website connected via a global network (e.g. global network 106 (FIG. 1B)). User may enter associated personal and financial information via website for submission to TISS 306 for verification. Non-limiting examples of information collected during account creation include last name, first name, address, date of birth, credit card details, driver's license details, social security number and/or other associated personal information. Following verification of received user information, transaction oriented identification may be created by TISS 306. Transaction oriented identifiers may be presented via website, communicated via email and/or communicated via (Short Message Service) SMS. Transaction oriented identifier may be configured manually or automatically configured via TISS 306. Automatic configuration may include scanning methods and/or may use methods for detecting Multipurpose Internet Mail Extensions (MIME) extensions. Furthermore, MIME extensions may be used to retrieve transaction oriented identifiers processed via software associated with client 304 device. Manual configuration methods may be performed using supported interface devices (e.g. interface device 140 (FIG. 1B)).

Transaction identifier 200 (FIG. 2) may be communicated via a network (e.g. global network 106 (FIG. 1B)) from TISS 306 to an image capable device or material. Non-limiting examples of methods for communicating transaction identifier 200 (FIG. 2) include email, SMS and/or web services. Transaction Identifier 200 (FIG. 2) may be communicated individually or as a group. Activation and expiration times associated with transaction identifier 200 (FIG. 2) may be communicated to devices supporting transaction identifier 200 (FIG. 2). A multiplicity of transaction identifier 200 (FIG. 2) may be communicated in addition to the transaction identifiers associated respective activation and expiration times. User device associated with agent 302 may operate to support communications with TISS 306 and may communicate via polling for communication exchanges or by transmission of communication messages. Communications protocols may be used for exchange of information between TISS 306 and other devices. A non-limiting example of a supported communication protocol includes SOAP.

Transaction Identifier 200 (FIG. 2) may be presented or printed via devices supporting presentation or printing of images. Non-limiting examples of devices for presentation of transaction identifier 200 (FIG. 2) include websites, magazines, mobile communication devices and televisions. Transaction identifier 200 (FIG. 2) may be presented dynamically with respect to activation and expiration times. For example, a mobile communication device may present transaction identifier 200 (FIG. 2) based upon an activation and expiration time followed by successive differing transaction identifier 200

(FIG. 2) based upon the transaction identifier's respective activation and expiration times. As a non-limiting example, a java applet may be used for performing dynamic presentation of transaction identifier 200 (FIG. 2). Transaction identifier 200 (FIG. 2) may also be presented in a static form. Non-limiting examples of static forms for presentation include jpeg, gif and png. A static transaction identifier 200 (FIG. 2) with an associated expiration time may be presented via a magazine or via a television next to an advertised product. Expiration time identifier 208 (FIG. 2) associated with transaction identifier 200 (FIG. 2) may be represented dynamically as a countdown timer for supported devices. Expiration time identifier 208 (FIG. 2) may be presented and denoted for a configured time zone. Other information associated with transaction identifier 200 (FIG. 2) may be presented. Non-limiting examples of other information presented or made available via transaction identifier 200 include activation time and transaction status.

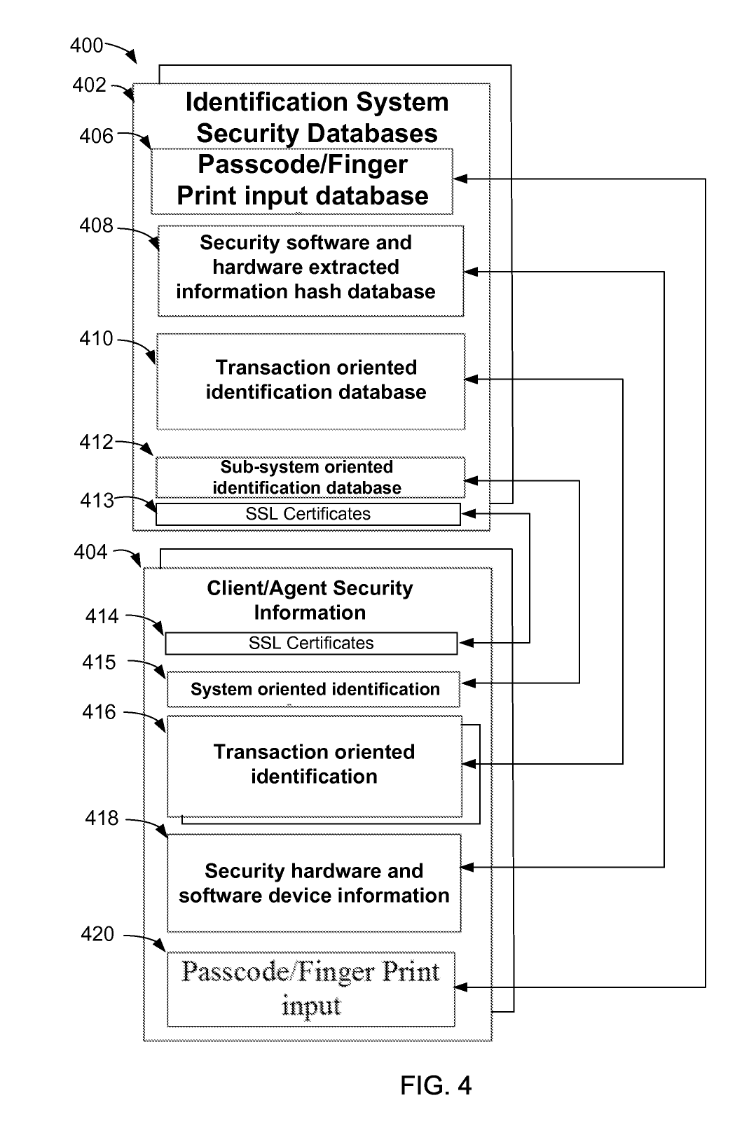

FIG. 4 presents a diagram illustrating an example protocol for communications exchange, in accordance with a specific embodiment. In at least one embodiment, a TISS 400 includes user and device information databases.

TISS 306 (FIG. 3) may operate to execute a protocol for communicating with a client and/or an agent device (e.g. agent 302 (FIG. 3), client 304 (FIG. 3)). Client 304 device (FIG. 3) may operate to initiate communications with agent 302 (FIG. 3) and vice versa.

A multiplicity of system oriented identifiers may be provided with a sampling denoted as a system oriented identifier 402 which may include information such as passcode/fingerprint data, SSL certificates, transaction UUID and transaction identifiers.

A passcode/biometric ID portion 406 may operate to execute protocols associated with passcodes and/or fingerprints. A hash portion 408 may operate to execute protocols associated with hash-keys for received information communicated via client 304 associated user devices. A transaction identifier portion 410 may operate to execute protocols associated with consumer transactions associated with user information. A sub-system oriented identification database 412 may operate to execute protocols associated with client 304 user device authentication and validity. An SSL certificate portion 413 may operate to perform validation and authentication associated with SSL.

A multiplicity of user devices may be provided with a sampling denoted as a user device 404 which includes a SSL certificate portion 414, a system identifier 415, a multiplicity of transaction identifiers with a sampling denoted as a transaction identifier 416. SSL certificate portion 414 may operate to perform validation and authentication associated with SSL. System identifier 415 may operate to execute protocols associated with client 304 (FIG. 3) user devices for performing authentication and validity. Transaction identifier 416 may operate to execute protocols associated with consumer transactions. A hash portion 418 may operate to execute protocols associated with hash-keys generated from information received from client 304 (FIG. 3) associated devices. A passcode/biometric ID portion 420 may operate to execute protocols associated with passcodes and/or fingerprints.

Security for communications exchanges may be enforced by encrypting information communicated during exchanges between agent, client and system components. Secure Socket Layer (SSL) encryption may be used for exchanges of information. Furthermore, for security purposes, client SSL security certificates may be created per user. Identification security may be implemented on a temporary basis via configuration of activation and expiration times. For example, an intercepted transaction identifier 200 (FIG. 2) may be temporary with a limited time for validity which reduces the period of time for vulnerability associated with transaction identifier 200 (FIG. 2). Transaction identifier 200 (FIG. 2) may be considered similar to temporary credit and/or identification cards. Validity of client and agent user device 404 may be verified by extracting unique hardware and software information and comparing this information with information extracted and stored by TISS 306 (FIG. 3) during system initialization. An access by agent 302 (FIG. 3) or client 304 (FIG. 3) may be accepted or rejected by TISS 306 (FIG. 3) based upon the results of the comparison of information. Non-limiting examples of information which may be compared include IP address, Media Access Control (MAC) address or other associated information such as geographic location. User validity may be confirmed via a passcode. Non-limiting examples of passcodes include a digital fingerprint and/or a password string of alphanumeric characters. Anonymity may be maintained when communicating information associated with transaction identifier 200 (FIG. 2). Other type of personal information associated with a user may also be used for communication exchanges.

A consumer transaction may initiate when the agent/client presents a transaction oriented identifier. An agent or client may scan the presented transaction identifier 200 (FIG. 2) in order to process the transaction. Agent 302 (FIG. 3) device or client 304 (FIG. 3) device may also exchange the transaction oriented identifier via other means. Non-limiting examples of other means used for communication include email and SMS. Furthermore, transaction oriented identifier information may be entered via a software or hardware keyboard. The type of transaction processed by TISS 306 (FIG. 3), for example financial, identification or authentication, may depend upon the configurations selected by the client. The time to process a transaction may be limited as a result of configured activation and expiration times for the transaction identifiers. For transaction identifier 200 (FIG. 2) not processed within the appropriate time interval, a successive transaction identifier 200 (FIG. 2) may be scanned within its appropriate time interval in order for a transaction to be considered valid.

Non-limiting examples for when transaction identifier 200 (FIG. 2) may be utilized include on-line retail, mobile-to-mobile, television marketing/sales, point-of-sale retailers, magazine product marketing/sales, identification agents, authentication agents or other entities capable of connecting and communicating with TISS 306 (FIG. 3) and communicating or presenting transaction identifier 200 (FIG. 2) associated transactions to a client or agent. For example, a grocery store supporting Transaction Identification Server System technologies may be able to scan client transaction identifier 200 (FIG. 2) enabling the client to pay for products via a user's associated mobile device. Furthermore, client may receive a list of products, payment options and an option to decline or accept the transaction. Internet websites using transaction identifier 200 (FIG. 2) technology may present transaction identifier 200 (FIG. 2) associated with item description and pricing for products advertised via an associated website. Client 304 associated device may then scan the transaction identifier in order to purchase the item. As a non-limiting example, a client may purchase a product by scanning transaction identifier 200 (FIG. 2) located adjacent to a product presented via a magazine. Internet auction websites may operate to match the expiration time for transaction identifier 200 (FIG. 2) with the expiration time of an auction enabling a client to purchase a product at the termination time for an auction. Websites requiring user authentication may operate to use TISS 306 (FIG. 3) and transaction identifier 200 (FIG. 2) for authentication. For website authentication, transaction identifier 200 (FIG. 2) may be presented via a login page with the user being granted secure access following authentication. Identification agents may identify users via transaction identifier 200 (FIG. 2) and operating to scan a mobile user's transaction identifier 200 (FIG. 2). Furthermore, agents may receive identification information following authentication via TISS 306 (FIG. 3). Furthermore, identification information received may include digital photo identification (e.g. driver' license or other identification) or other identification information (e.g. date of birth, social security number, etc.). Furthermore, identification information may indicate status information associated with a client. As a non-limiting example, status information may indicate a client's status with regard to being a minor

Generally, the Transaction Identification techniques described herein may be implemented in software and/or hardware. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the Transaction Identification techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

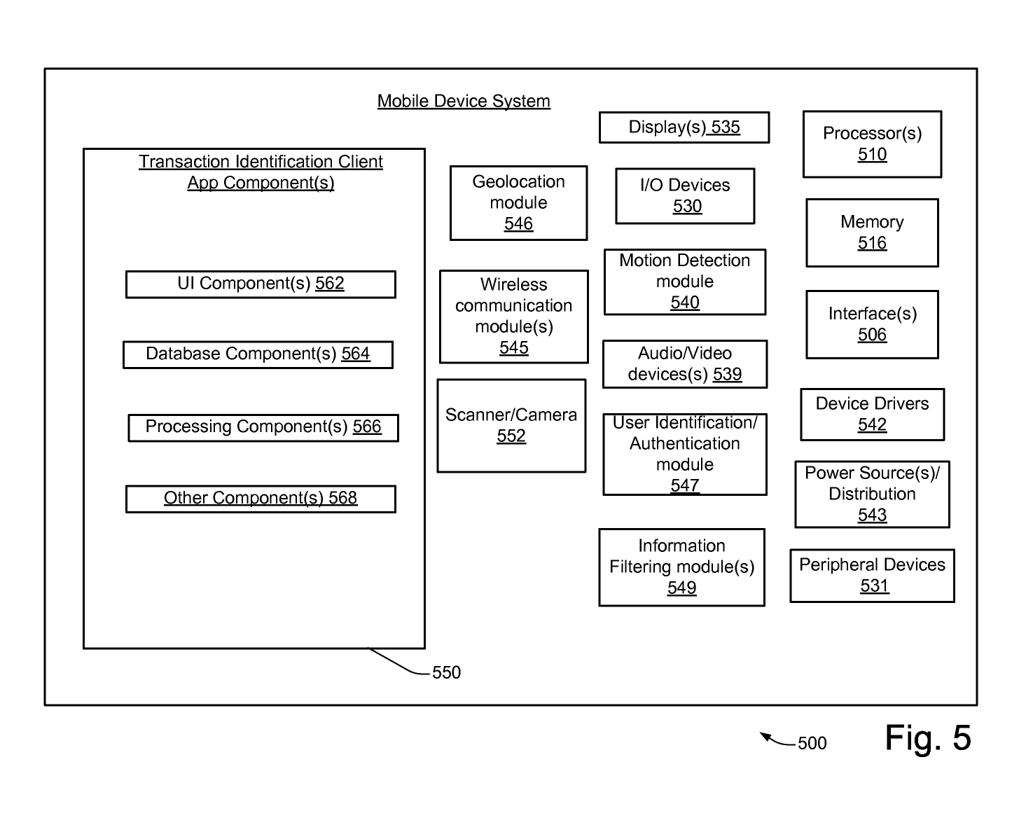

FIG. 5 is a simplified block diagram of an exemplary mobile client system 500 in accordance with a specific embodiment. In at least one embodiment, the mobile client system may include Transaction Identification Client App Component(s) which have been configured or designed to provide functionality for enabling or implementing at least a portion of the various Transaction Identification techniques at the mobile client system. For example, in at least one embodiment, the Transaction Identification Device Application may provide functionality and/or features for enabling a user to engage in various types of electronic transactions such as those described herein.

As illustrated in the example of FIG. 5 mobile client system 500 may include a variety of components, modules and/or systems for providing various functionality. For example, as illustrated in FIG. 5, mobile client system 500 may include, but is not limited to, one or more of the following (or combinations thereof):
Transaction Identification Device Application Components 550
   UI Components 562 such as those illustrated, described, and/or referenced herein.
   Database Components 564 such as those illustrated, described, and/or referenced herein.
   Processing Components 566 such as those illustrated, described, and/or referenced herein.
   Other Components 568 which, for example, may include components for facilitating and/or enabling the Mobile Client System to perform and/or initiate various types of operations, activities, functions such as those described herein.
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Transaction Identification techniques described herein. The program instructions may control the operation of an operating system and/or one or more applications, for example. The memory or memories may also be configured to store data structures, metadata, Transaction ID information/images, and/or information/data relating to other features/functions described herein. Because such information and program instructions may be employed to implement at least a portion of the Transaction Identification techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 542. In at least one implementation, the device driver(s) 542 may include functionality similar to at least a portion of functionality implemented by one or more computer system driver devices such as those described herein and/or generally known to one having ordinary skill in the art.
At least one power source (and/or power distribution source) 543. In at least one implementation, the power source may include at least one mobile power source (e.g., battery) for allowing the mobile client system to operate in a wireless and/or mobile environment. For example, in one implementation, the power source 543 may be implemented using a rechargeable, thin-film type battery. Further, in embodiments where it is desirable for the device to be flexible, the power source 543 may be designed to be flexible.
Geolocation module 546 which, for example, may be configured or designed to acquire geolocation information from remote sources and use the acquired geolocation information to determine information relating to a relative and/or absolute position of the mobile client system.
Motion detection component 540 for detecting motion or movement of the mobile client system and/or for detecting motion, movement, gestures and/or other input data from user. In at least one embodiment, the motion detection component 540 may include one or more motion detection sensors such as, for example, MEMS (Micro Electro Mechanical System) accelerometers, that can detect the acceleration and/or other movements of the mobile client system as it is moved by a user.
User Identification/Authentication module 547. In one implementation, the User Identification module may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). Alternatively, the mobile client system may be adapted to automatically determine the identity of the current user based upon one or more external signals such as, for example, an RFID tag or badge worn by the current user which provides a wireless signal to the mobile client system for determining the identity of the current user. In at least one implementation, various security features may be incorporated into the mobile client system to prevent unauthorized users from accessing confidential or sensitive information.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable. Additionally, in at least one embodiment the information displayed on display(s) 535 may utilize e-ink technology (such as that available from E Ink Corporation, Cambridge, Mass., www.eink.com), or other suitable technology for reducing the power consumption of information displayed on the display(s) 535.
One or more user I/O Device(s) 530 such as, for example, keys, buttons, scroll wheels, cursors, touchscreen sensors, audio command interfaces, magnetic strip reader, optical scanner, etc.
Audio/Video device(s) 539 such as, for example, components for displaying audio/visual media which, for example, may include cameras, speakers, microphones, media presentation components, wireless transmitter/receiver devices for enabling wireless audio and/or visual communication between the mobile client system 500 and remote devices (e.g., radios, telephones, computer systems, etc.). For example, in one implementation, the audio system may include componentry for enabling the mobile client system to function as a cell phone or two-way radio device.
Other types of peripheral devices 531 which may be useful to the users of various mobile client systems, such as, for example: PDA functionality; memory card reader(s); fingerprint reader(s); image projection device(s); social networking peripheral component(s); etc.
Information filtering module(s) 549 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 549 may also be adapted to display, in real-time, filtered information to the user based upon a variety of criteria such as, for example, geolocation information, casino data information, player tracking information, etc.
Wireless communication module(s) 545. In one implementation, the wireless communication module 545 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Scanner/Camera Component(s) 552 which may be configured or designed for use in scanning Transaction IDs and/or other transaction identifiers from other devices and/or objects such as for example: mobile device displays, computer displays, static displays (e.g., printed on tangible mediums), etc.
Etc.

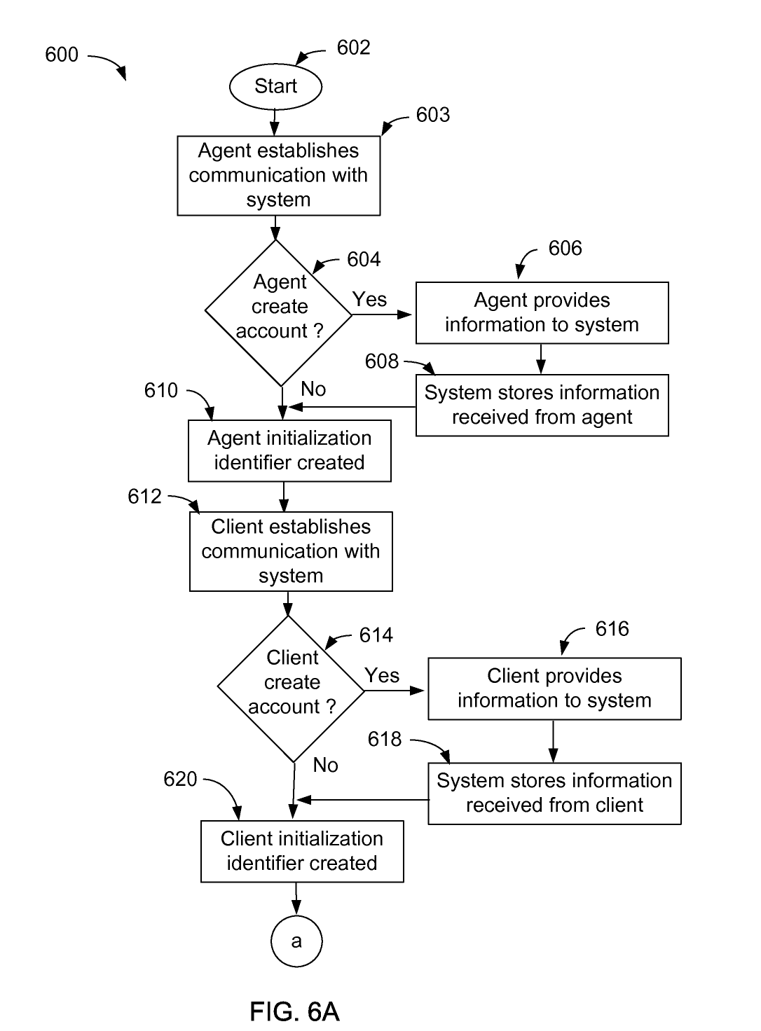

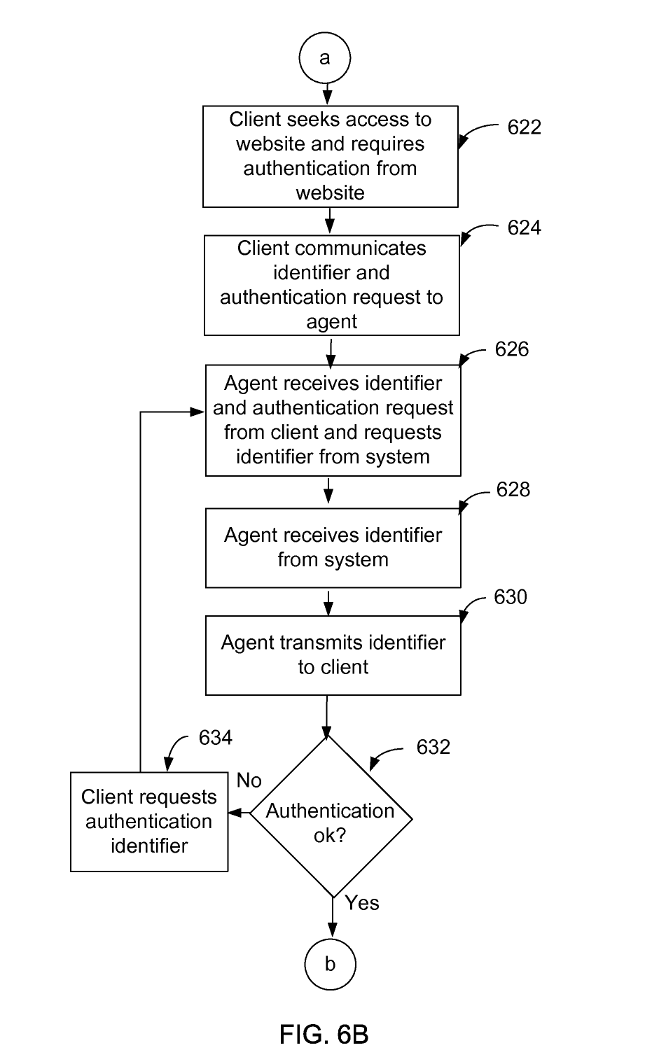

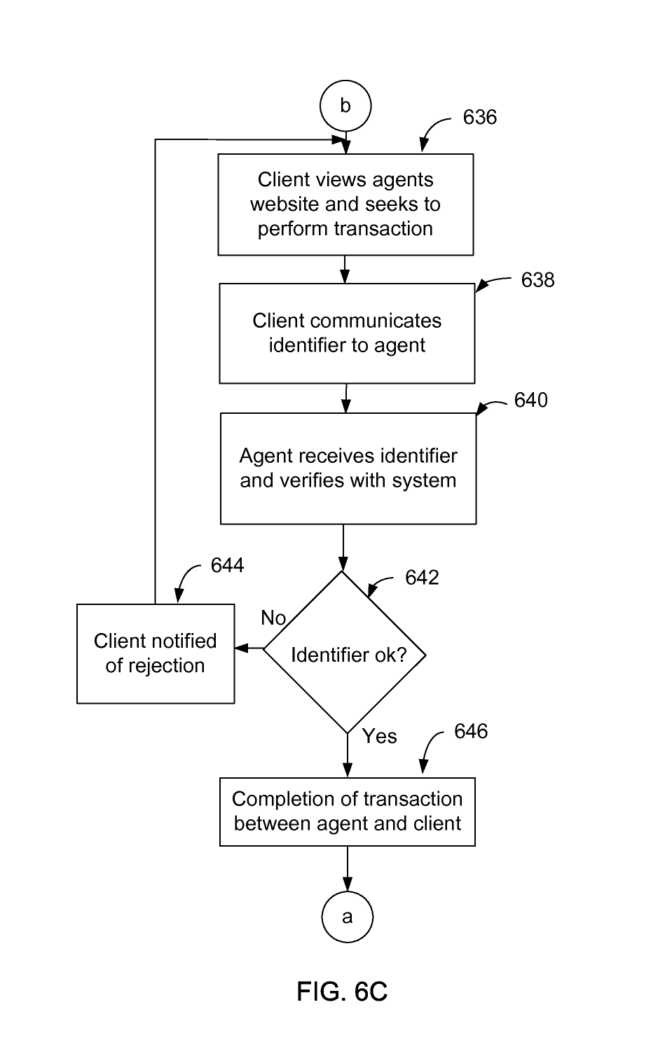

FIGS. 6A-C present a flow chart illustrating an exemplary method 600 for interaction with the elements of identification sub-system 301 (FIG. 3) using transaction identifier 200 (FIG. 2) via communication system 100 (FIG. 1B), system protocol 400 (FIG. 4) and computer system 500 (FIG. 5), in accordance with a specific embodiment.

In at least one embodiment, the process initiates in a step 602 (FIG. 6A). In a step 603, agent 302 (FIG. 3) may operate to initiate communications with TISS 306 (FIG. 3). In a step 604, a determination for agent creating an account may be performed. For a determination of agent creating an account in step 604, agent 302 (FIG. 3) may communicate agent associated information to TISS 306 (FIG. 3) in a step 606. In a step 608, TISS 306 transfers agent associated information to system database (e.g. database associated with server device 108 (FIG. 1B)). Following system transferring agent 302 (FIG. 3) information to TISS 306 (FIG. 3) database in step 608 or for a determination of agent 302 (FIG. 3) not creating a new account in step 604, in a step 610, creation of agent initialization transaction identifier 200 (FIG. 2) may be performed.

In a step 612, client 304 (FIG. 3) may operate to initiate communications with TISS 306 (FIG. 3). In a step 614, a determination for client creating an account may be performed. For a determination of client creating an account in step 614, client 304 (FIG. 3) may communicate client associated information to TISS 306 (FIG. 3) in a step 616. In a step 618, TISS 306 (FIG. 3) transfers client associated information to system database (e.g. database associated with server device 108 (FIG. 1B)). Following TISS 306 (FIG. 3) transferring client 304 (FIG. 3) information to TISS 306 (FIG. 3) database in step 618 or for a determination of client 304 (FIG. 3) not creating a new account in step 614, in a step 620, creation of client initialization transaction identifier 200 (FIG. 2) may be performed.

In a step 622 (FIG. 6B), client 304 (FIG. 3) seeks access to agent 302 website and may require authentication from agent 302 (FIG. 3) website. In a step 624, client communicates transaction identifier 200 (FIG. 2) and authentication request to agent 302 (FIG. 3) website. In a step 626, agent 302 receives transaction identifier 200 (FIG. 2) and authentication request from client and requests transaction identifier 200 (FIG. 2) from TISS 306 (FIG. 3). In a step 628, agent 302 (FIG. 3) receives transaction identifier 200 (FIG. 2) from TISS 306 (FIG. 3). In a step 630, agent 302 (FIG. 3) transmits transaction identifier 200 (FIG. 2) to client 304. In a step 632, a determination for agent 302 authentication via transaction identifier 200 (FIG. 2) may be performed. For a determination of an invalid authentication request in step 632, in a step 634, client 304 may request authentication from agent 302 with execution of method 600 transitioning to step 626. For a determination of a valid authentication in step 632, client 304 may view agent 302 website and client 304 may seek to perform a transaction with agent 302 in a step 636. In a step 638, client 304 may communicate a request for a transaction and transaction identifier 200 (FIG. 2). In a step 640, agent 302 (FIG. 3) may receive transaction identifier 200 (FIG. 2) from client 304 (FIG. 3) and verify validity of transaction identifier 200 (FIG. 2) with TISS 306 (FIG. 3). In a step 642, a determination for a valid transaction identifier 200 (FIG. 2) may be performed. For a determination of an invalid transaction identifier 200 (FIG. 2) in step 642, in a step 644 client 304 (FIG. 3) may be notified of rejection with execution of method 600 transitioning to step 636. For a determination of a valid transaction identifier 200 (FIG. 2) in step 642, in a step 646 completion of the transaction between client 304 (FIG. 3) and agent 302 (FIG. 3) may be performed with execution of method 600 transitioning to step 622 (FIG. 6B).

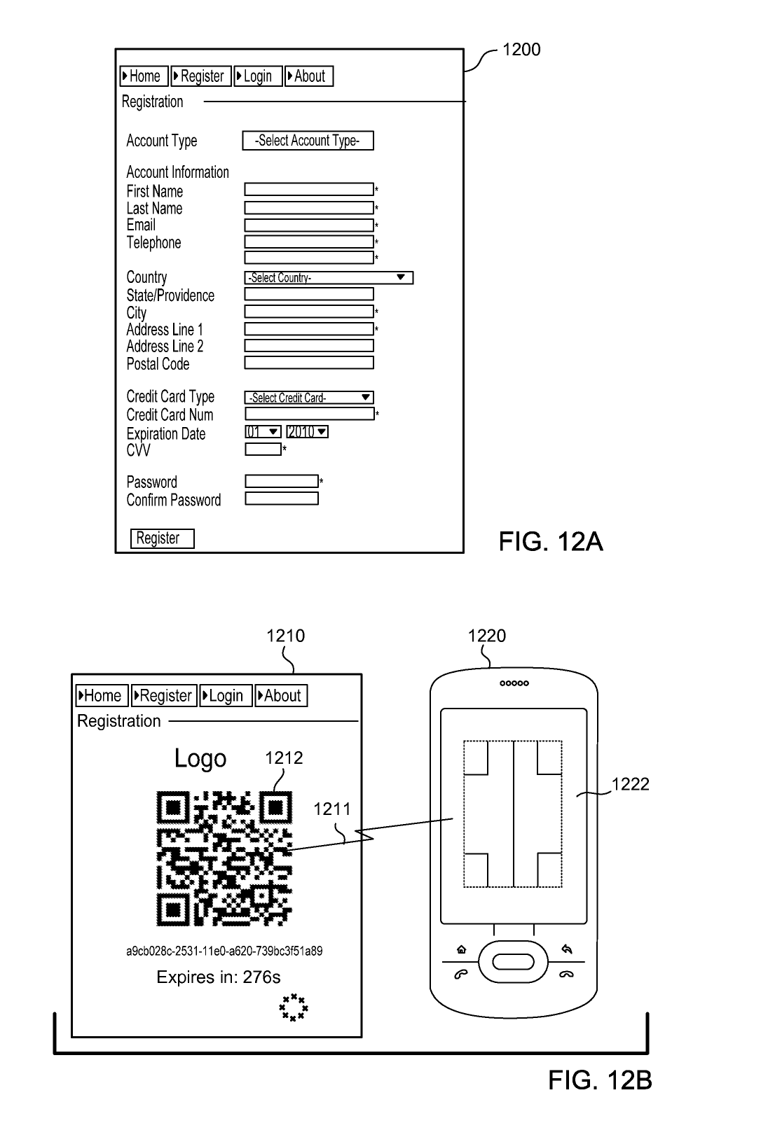

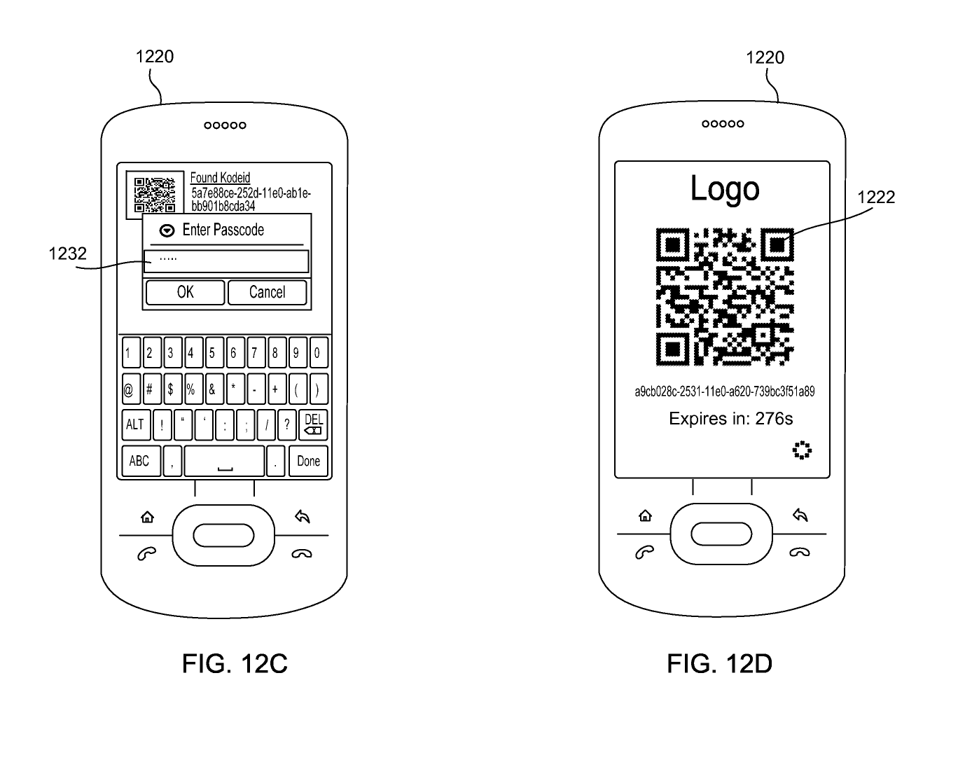

FIGS. 12A-12D illustrate example screenshots of a Transaction Identification System user registration/account creation sequence in accordance with a specific embodiment.

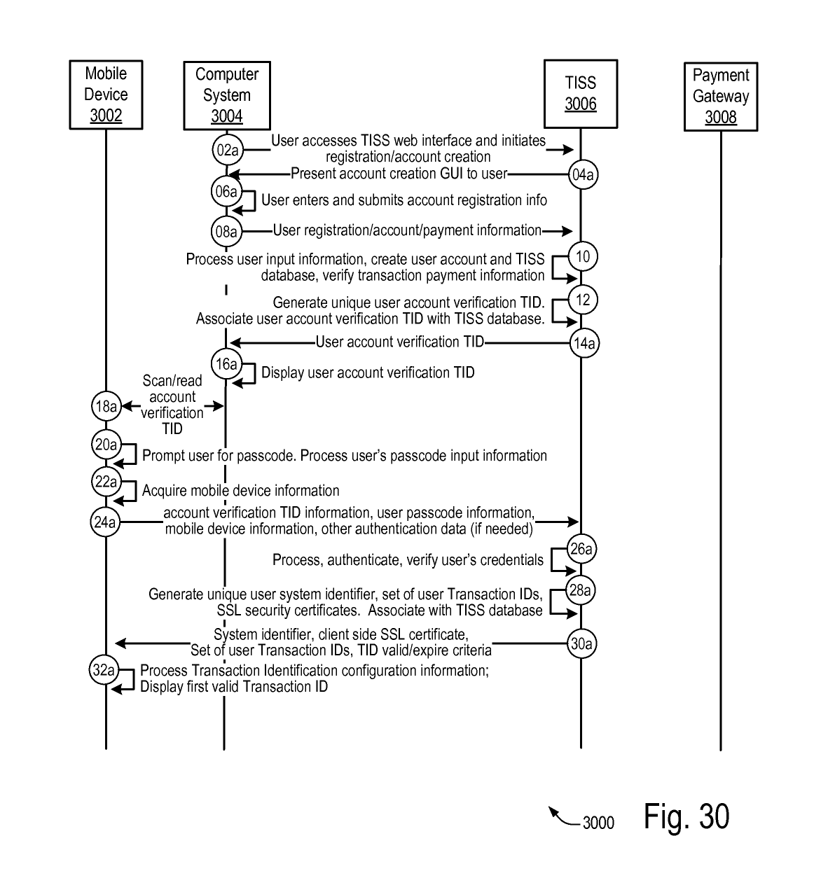

FIG. 30 shows a specific example embodiment of an interaction diagram illustrating various communication flows and actions which may be initiated and/or performed during a Transaction Identification System user registration/account creation sequence such as that illustrated, for example, in FIGS. 12A-12D.

For purposes of illustration, the interaction diagram of FIG. 30 will now be described by way of example with reference to the FIGS. 12A-12D. In this particular example, it is assumed that a user of a mobile client device (3002) desires to utilize client computer system 3004 to register the user and the user's mobile client device with the Transaction Identification Server System (TISS) 3006.

As illustrated in the example embodiment of FIG. 30, at 2a it is assumed that a user has access to mobile device 3002 and computer system 3004, and uses computer system 3004 to access (2) the Transaction Identification Server System (TISS 3006) web interface for initiating user/device registration and account creation.

As shown at 4a, the TISS may present an account creation/registration GUI (e.g., 1200, FIG. 12A) to be displayed to the user via computer system 3004. In at least one embodiment, the user may be presented with one or more options for selecting the type of account can be created (e.g., purchasers/consumer account, merchant account, authentication account, etc.)

As shown at 6a and 8a, it is assumed that the user enters and submits his or her registration/account information, which, for example, may include, but is not limited to, one or more of the following (or combinations thereof):
user name
address information
user communication/contact information (e.g., phone, email, cell phone, etc.)
transaction payment information (e.g., bank accounts, credit cards, PayPal account(s), etc.)
user profile/preference information (e.g., age, gender, consumer preferences, default transaction type(s), etc.)
security information (e.g., login password, Transaction ID passcode, PIN, drivers license number, Social Security number, secret security questions/answers, biometric ID information, etc.)
password recovery information
information relating to other previously registered devices
merchant/vendor related information
tax related information
authorized user information
etc.

As shown at 10a, the TISS 3006 may receive the user's input information, and may initiate and/or perform one or more operations such as, for example, one or more of the following (or combinations thereof):
create user account
create/populate TISS database
verify transaction payment information
etc.

As shown at 12a, the TISS may generate a unique user account verification Transaction ID (TID), and may associate the user account verification TID with the user's account and/or TISS database.

As shown at 14a, the TISS may provide the user account verification TID to the client computer system 3004 for display.

As shown at 16a, the client computer system 3004 may display the user account verification TID, as illustrated, for example, in FIG. 12B. For example, as illustrated in the example embodiment of FIG. 12B, the computer system display 1210 is shown displaying a user account verification TID 1212. In other embodiments (not shown), the user account verification TID may be presented to the user via other techniques. For example, in at least some embodiments where a user is using his or her mobile device to perform account registration with the TISS, the user account verification TID may be presented to the user via one or more of the following mechanisms (or combinations thereof):
email communication
SMS communication
via voice/phone communication
via user's mobile device display
via script, instructions, and/or other types of coded information which may cause the user's mobile device to automatically receive and process the user account verification TID information.

As illustrated in the example embodiment of FIG. 30, at 18a (and as illustrated in FIG. 12B), it is assumed that the user operates his or her mobile device 3002 (e.g., 1220, FIG. 12B) to perform (e.g., 1211, FIG. 12B) an optical scan or read of the displayed user account verification TID (e.g., 1212). In at least one embodiment, the user account verification TID may remain valid/active for only a specified time interval (e.g., 1 hour, 24 hours, etc.). In one embodiment, if the user account verification TID expires before the user registration process is completed, a new user account verification TID may need to be generated and displayed (or otherwise provided) to the user.

In at least one embodiment, the reading, scanning, and/or processing of the user account verification TID information may be performed by (or facilitated by) a Transaction Identification Device Application (e.g., 163, FIG. 1A) running at the mobile device 3002.

In at least one embodiment, as shown at 20a (FIG. 30), the mobile device may present a GUI (e.g., 1232, FIG. 12C) prompting the user to input a personalized passcode or PIN. In at least one embodiment, when the user is engaging in future transactions via the Transaction Identification System, the user may be required to enter his/her personalized passcode (e.g., as an additional security measure) in order to allow a given transaction to be successfully completed (e.g., depending upon the type of transaction being performed).

As shown at 22a, the mobile device may automatically determine and/or acquire different types of mobile device information to be provided to the TISS. Examples of such mobile device information may include, but is not limited to, one or more of the following (or combinations thereof):
International Mobile Equipment Identifier (IMEI)
Carrier Name
Location GPS/GSM
MAC address
IP Address
Operating system type
Software Version
Serial Number
Telephone Number
Mobile device hardware information
Mobile device software information
Etc.

As shown at 24a, the mobile device 3002 may automatically transmit to TISS 3006, verification information, mobile device information, and/or other types of information, such as, for example, one or more of the following (or combinations thereof):
account verification TID information
user passcode information
mobile device information
other authentication information (if needed/desired)
etc.

As shown at 26a, the TISS may process the information received from the mobile device. In at least one embodiment, the TISS may use at least a portion of the received information to authenticate and/or verify user's credentials. Additionally, the TISS may associate and/or store at least a portion of the received mobile device information with one the TISS database.

As shown at 28a, it is assumed that the TISS has successfully verified the user's credentials. Accordingly, in at least one embodiment, the TISS may generate various types of identifiers and/or other information which, for example, may be used to complete the user registration process. In at least one embodiment, the TISS may associate at least a portion of the generated identifiers and/or other information with TISS database. Examples of the various types of identifiers and/or other information may include, but are not limited to, one or more of the following (or combinations thereof):
a unique user system identifier
one or more set(s) of temporary user Transaction IDs
SSL security certificate(s)
Activation times
UUID for the registration transaction
etc.

In at least one embodiment, the unique user system identifier may be associated with the user's mobile device information and/or the TISS database, and may be used, for example, as an additional security measure for authenticating and/or validating the identity of the user and/or the identity of a given mobile device (e.g., 3002). In at least one embodiment, the user system identifier may be implemented as a hidden identifier which is not readily visible or discoverable by the user.

In at least one embodiment, a set of temporary user Transaction IDs may include one or more (e.g., six) different temporary Transaction IDs, which are to be displayed in particular sequence. In at least one embodiment, each temporary Transaction ID has associated therewith a respective, predefined valid time interval which defines a specific window of time in which that particular Transaction ID is valid for use.

As shown at 30a, the TISS may provide to the mobile device 3002 various types of Transaction Identification configuration information such as, for example, one or more of the following (or combinations thereof):
the user system identifier
one or more set(s) of Transaction IDs
client-side SSL security certificate(s)
Transaction ID (TID) valid/expire criteria
Activation times
UUID for the registration transaction
etc.

In at least one embodiment, the set(s) of Transaction IDs which are provided to the mobile device may include one or more of the following (or combinations thereof):
one or more online type TID(s)
one or more offline type TID(s)

As shown at 32a, the mobile device may process the received Transaction Identification configuration information, and complete the user registration process. After having completed the user registration process, the mobile device 3002 may proceed to display a first valid Transaction ID (e.g., 1242, FIG. 12D) at the mobile device display (e.g., as illustrated in FIG. 12D) to thereby enable the user to conduct one or more electronic transactions via mobile device 3002.

In one embodiment, it may be possible for multiple different persons (users) to be authorized to use a given mobile device. For example, in one embodiment, a mobile device may be shared between multiple different users (e.g., husband/wife, company employees, etc.). Each user may register the MD at Transaction Identification Server System under his/her user account, and register a unique PIN to be associated with the MD. When User A uses the mobile device to perform a transaction, User A will enter his unique PIN (e.g., PIN A), allowing the Transaction Identification Server System to associate the transaction as being initiated/performed by User A. When User B uses the mobile device to perform a transaction, User B will enter her unique PIN (e.g., PIN B), allowing the Transaction Identification Server System to associate the second transaction as being initiated/performed by User B. In at least one embodiment, the identification for each user may be the PIN or passcode.

According to different embodiments, one or more the following combination(s) may also be implemented:

| | |
|---|---|
| single user(s) <-> single device(s) <-> single account(s) | 000 |
| multiple user(s) <-> single device(s) <-> single account(s) | 100 |
| single user(s) <-> multiple device(s) <-> single account(s) | 010 |
| single user(s) <-> single device(s) <-> multiple account(s) | 001 |
| multiple user(s) <-> multiple device(s) <-> single account(s) | 110 |
| multiple user(s) <-> single device(s) <-> multiple account(s) | 101 |
| single user(s) <-> multiple device(s) <-> multiple account(s) | 011 |
| multiple user(s) <-> multiple device(s) <-> multiple account(s) | 111 |

In at least one embodiment, TID(s) can be installed and registered on any device (desktop PC, laptop, tablet etc. with an attached scanner—not only a mobile device). For example, you could install Transaction Identification client device software on your home desktop PC, and register it on the TID(s) website using a scanner. Then you can use your desktop PC to do all of your online shopping for example.

In one embodiment, User B first launches TIS client app, and creates invoice & total amounts before scanning Client TID (similar to Safeway example). In one embodiment, the client app may scan/read different bar codes of goods/services, and dynamically generate an itemized invoice and total amount due which can be sent to TISS along with Client TID info.

### Quick Transaction(s):

In at least one embodiment, quick transaction functionality may be enabled or provided to allow a user to perform a TIS-related transaction without having to provide a passcode or other security credentials. For example, in one embodiment, Client displayed valid TID. Scanned by Agent device. Once TISS validates Client TID, transaction is automatically processed without any approval/action from Client/User A. Example use cases:
Payments under $10
BART/MUNI Entrance
Fastrak
etc.

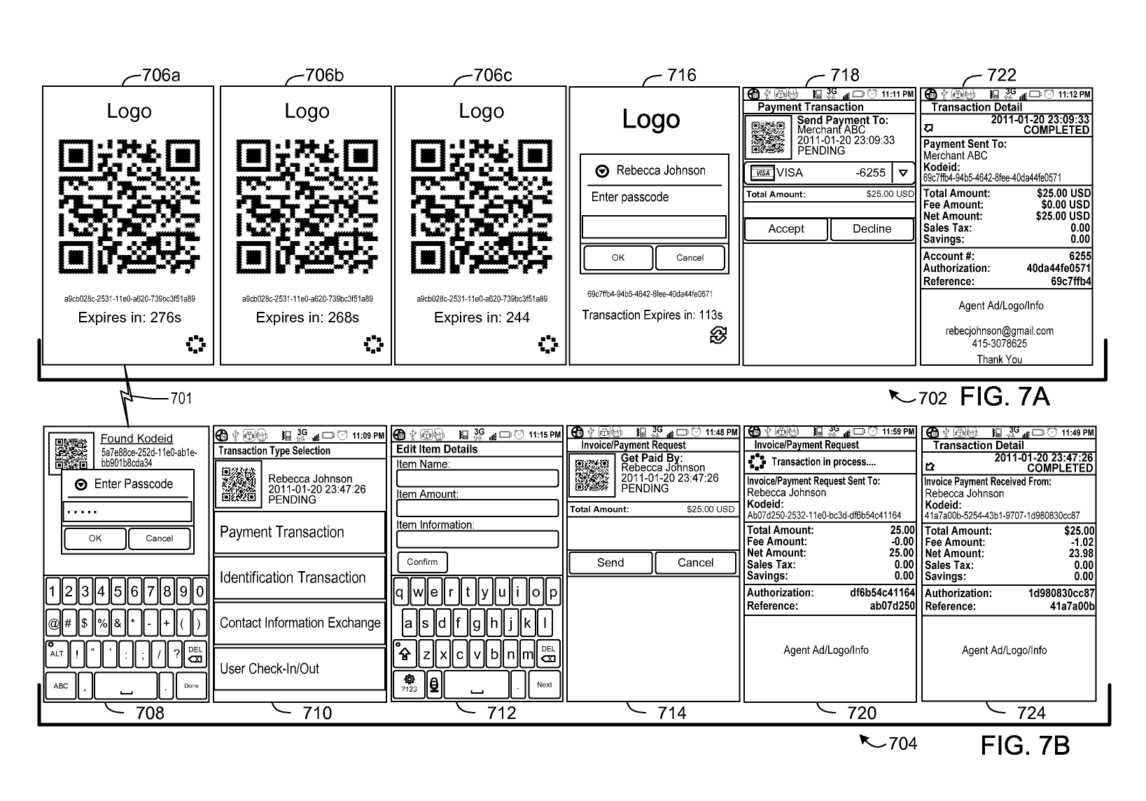

FIGS. 7A-7B illustrate example screenshots relating to an example mobile-to-mobile payment transaction which is being conducted between two mobile devices, in accordance with a specific embodiment.

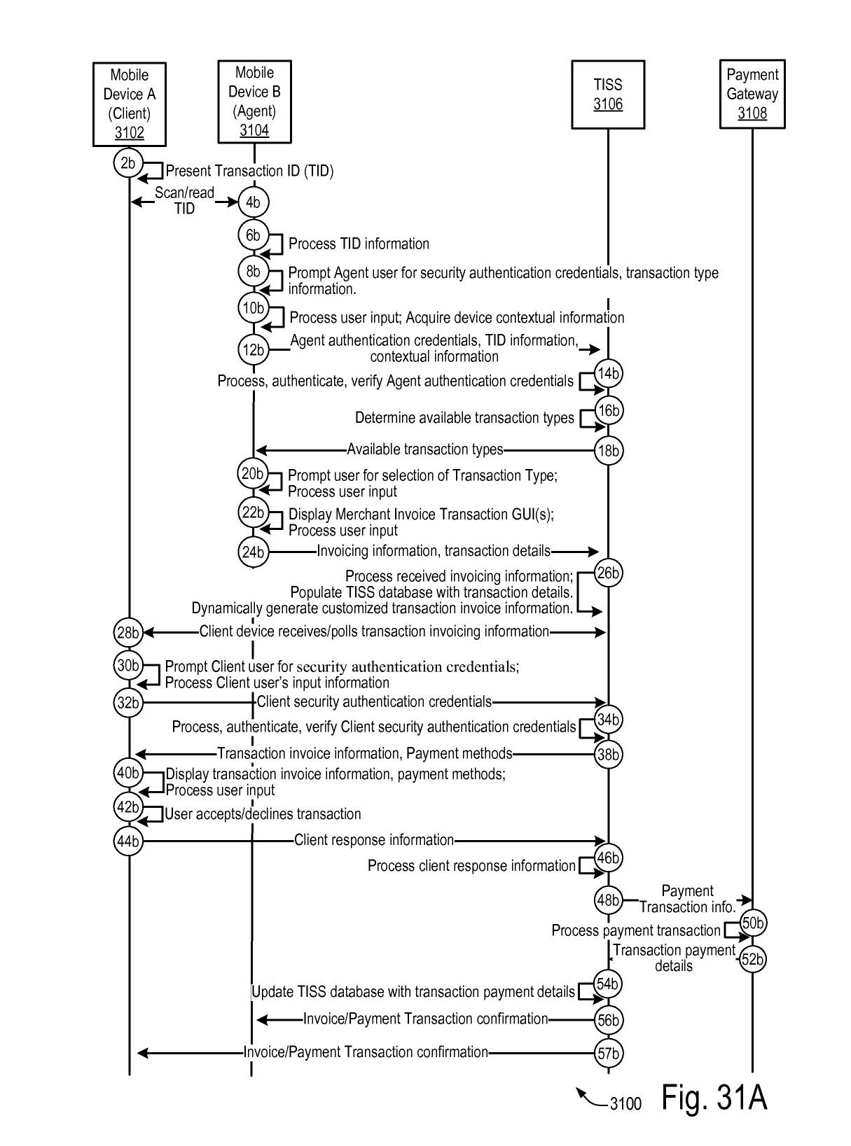

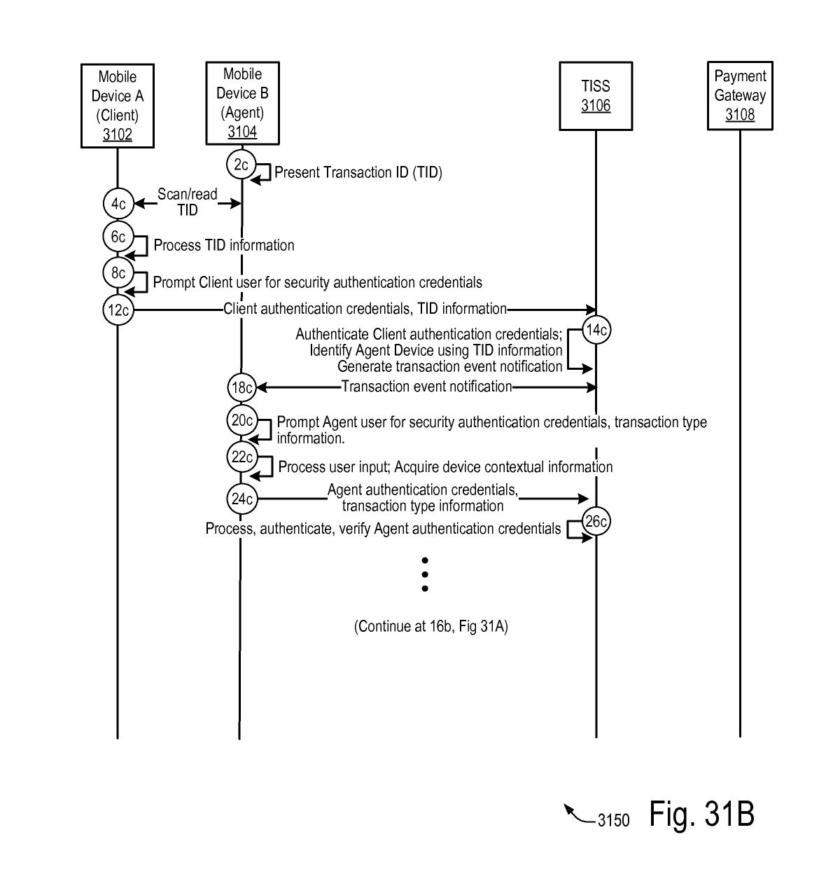

FIG. 31A shows a specific example embodiment of an interaction diagram illustrating various communication flows and actions which may be initiated and/or performed during a mobile-to-mobile payment transaction such as that illustrated, for example, in FIGS. 7A-7B.

For purposes of illustration, the interaction diagram of FIG. 31 will now be described by way of example with reference to the example screenshots illustrated in FIGS. 7A-7B. In this particular example, it is assumed that a first user (User A) is operating Mobile Device A 3102 and that a second user (User B) is operating Mobile Device B 3104. Additionally, in this example, it is assumed that User B is a vendor who desires to provide User A with an invoice or payment request for specific goods/services, and that User A desires to pay for the specific goods/services via an electronic payment transaction using his/her mobile device.

As described in greater detail herein, the Transaction Identification System technology disclosed herein may be utilized to enable User B to use Mobile Device B to provide User A with an electronic invoice or payment request. Additionally, the Transaction Identification System technology may be utilized to enable User A to use Mobile Device A to provide an electronic payment to User B.

In at least one embodiment, a Transaction UUID may be a UUID generated to represent the transaction. It may not be visual and the user may be unaware of it. It may be analogized to a transaction token or cookie to identify the transaction itself once the user has been authenticated successfully.

In one embodiment, User A operates Transaction Identification Device Application on MD A to cause TID to be displayed at MD A. In one embodiment, User B operates Transaction Identification Device Application on MD B to cause MD B to scan TID to be displayed at MD A.

FIGS. 7A-B present diagrams illustrating an example transaction performed between an agent and a client via an associated mobile device, in accordance with a specific embodiment.

As illustrated in the example embodiment of FIGS. 7A-B, the transaction includes a client presentation sequence 7A and an agent presentation sequence 7B.

For client presentation sequence, client may operate to present transaction identifier to agent. Client may operate to perform polling operations. Client may operate to receive agent transaction information and enter passcode information. Client may operate to select payment type and accept or decline transaction. Client may operate to receive transaction status information.

For agent presentation sequence, agent may operate to scan transaction identifier and enter passcode information. Agent may operate to receive transaction identifier information. Agent may operate to enter item associate information. Agent may operate to communicate identification request. Agent may operate to perform polling operation for transaction confirmation. Agent may operate to receive transaction status information.

For a mobile client presentation, a client user may seek to purchase a product from an agent's commercial establishment. Client may initiate a Transaction Identification Device Application (e.g. client software) with an associated client device (e.g. mobile device) and may present a transaction identifier to the agent.

For a mobile agent presentation, agent may initiate a Transaction Identification Device Application (e.g. agent software) associated with an agent device (e.g. mobile device) and select to perform a scan operation. Agent may scan client's transaction identifier. Agent device may present a prompt for a password, with agent entering password and selecting to submit operation for execution.

For a mobile agent presentation, agent device may receive information associated with transaction identifier. Furthermore, during the time interval prior to receiving transaction identifier information, Client device may perform a polling operation of agent device.

For a mobile agent presentation, agent may enter information associated with product or item (e.g. item name, quantity, description, etc.). Client device may continue to perform a polling operation of agent device.

For a mobile agent presentation, agent device may communicate a payment transaction request to system server.

For a mobile client presentation, client device may present a prompt for a password, followed by client entering password and submitting operation for execution.

For a mobile client presentation, user associated with client device may operate to review payment requested associated with agent. User associated with client device may select a payment type and whether to accept/decline transaction.

For a mobile agent presentation, agent device polls for transaction confirmation.

For a mobile client presentation, client device may receive transaction status information and present to client device user.

For a mobile agent presentation, agent device may receive transaction status information and present to agent device user.

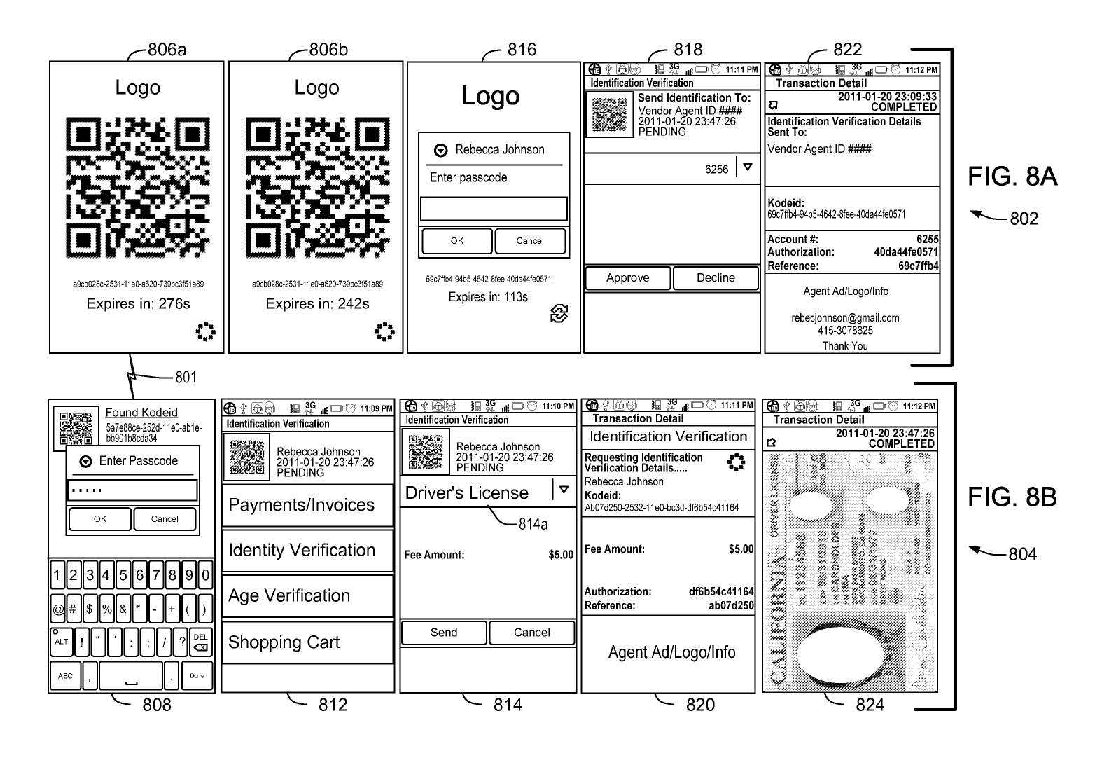

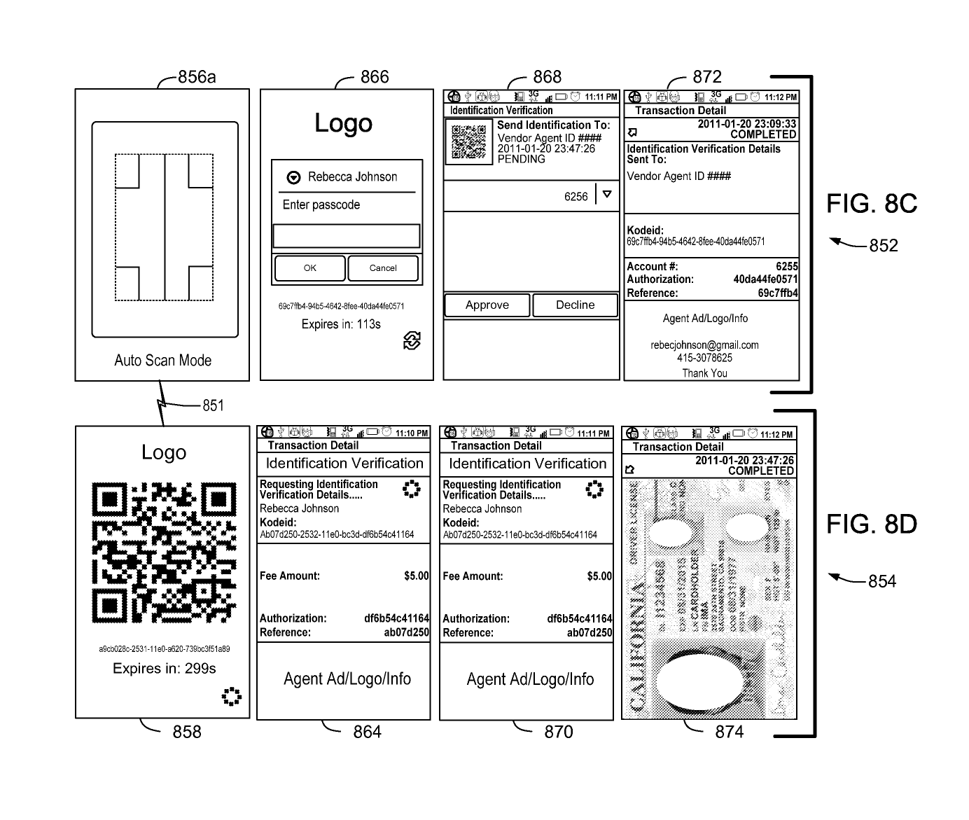

FIGS. 8A-D present diagrams illustrating an example mobile-to-mobile identification transaction, in accordance with a specific embodiment.

In at least one embodiment, an identification transaction includes a client presentation sequence and an agent presentation sequence.

For client presentation sequence, client may operate to present transaction identifier to agent. Client may operate to perform polling operations. Client may operate to receive agent transaction information and provide passcode information. Client may operate to accept or decline identification request. Client may operate to receive transaction status information.

For agent presentation sequence, agent may operate to scan transaction identifier and provide passcode information. Agent may operate to receive transaction identifier information. Agent may operate to select identification type. Agent may operate to communicate identification request. Agent may operate to poll for transaction confirmation. Agent may operate to receive identification and transaction status information.

For a mobile client presentation, a client user may seek to access an entity requiring identity verification. Client may initiate a Transaction Identification Device Application (e.g. client software) via a client device (e.g. mobile device) and may present an associated transaction identifier to agent user.

For a mobile agent presentation, agent may initiate a Transaction Identification Device Application (e.g. agent software) via an agent device (e.g. mobile device) and may select to perform a scan operation. Agent may then scan client's transaction identifier. Agent device may present a prompt for password, followed by user entering correct password and selecting to submit operation for execution.

For a mobile agent presentation, agent device may receive transaction identifier associated information. Furthermore, client device may operate perform polling of agent device.

For a mobile agent presentation, agent may operate to select an identification type (e.g. driver's license).

For a mobile agent presentation, agent user may instruct agent device to communicate identification request to identification system.

For a mobile client presentation, client device may operate to present a prompt for password to client user, followed by client user entering password and selecting to submit operation for execution.

For a mobile client presentation, following authentication by identifier system, client user may select to accept or decline agent's identification request.

For a mobile agent presentation, agent device may continue to poll identification system for transaction confirmation.

For a mobile client presentation, client device receives transaction status information.

For a mobile agent presentation, agent device receives identification information and associated transaction status.

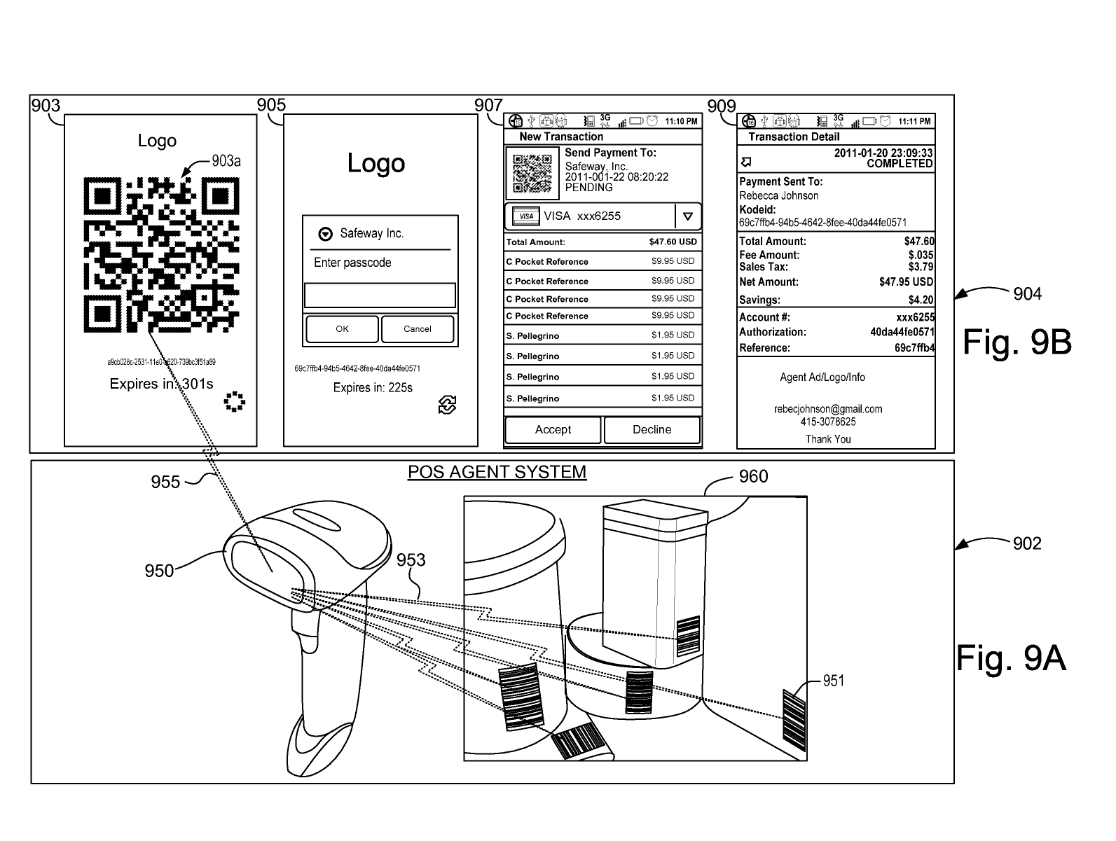

FIGS. 9A-B present diagrams illustrating an example POS transaction in a retail merchant (e.g., brick and mortar store) environment, in accordance with a specific embodiment.

In at least one embodiment, a POS transaction includes a client portion and an agent portion.

As illustrated in the example embodiment of FIG. 9A, agent portion may include a merchant system which is operable to scan items associated with client and scan communicated transaction identifier.

FIG. 9B illustrates a sequence of GUIs (e.g., screenshots) which may be displayed to a user of the client device. Client may operate to present transaction identifier to agent, receive transaction and enter passcode. Client may operate to receive item list, payment options and accept/decline transaction. Client may operate to receive transaction status information.

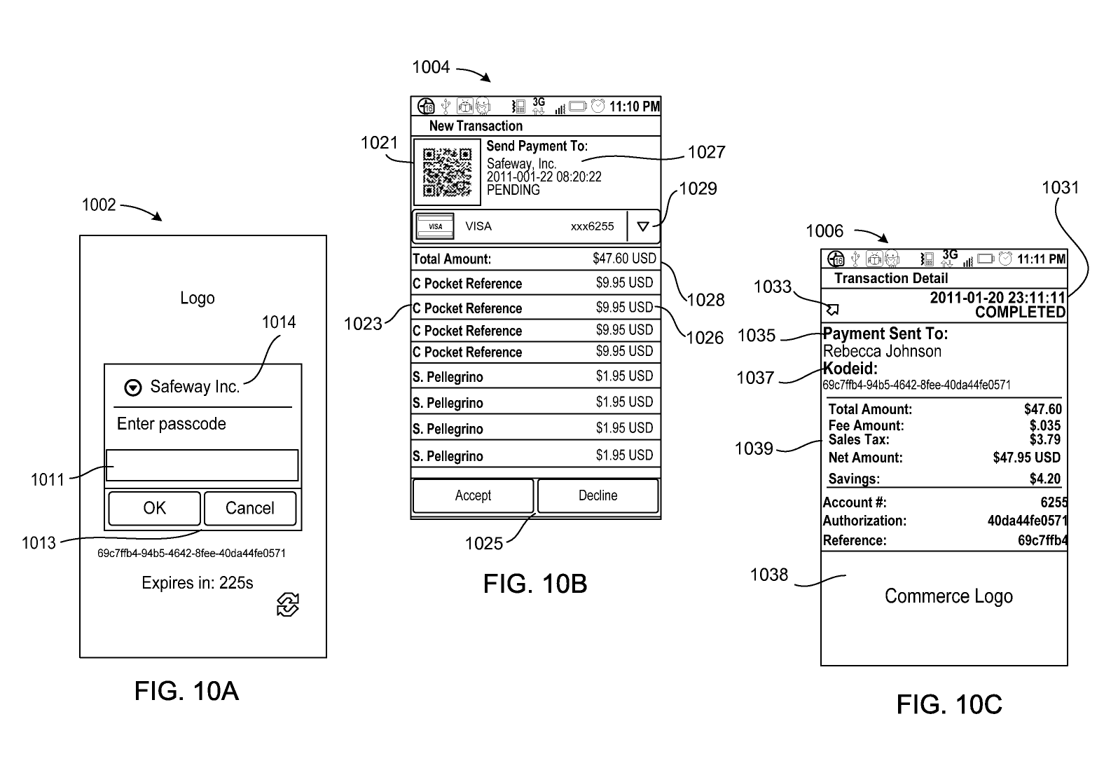

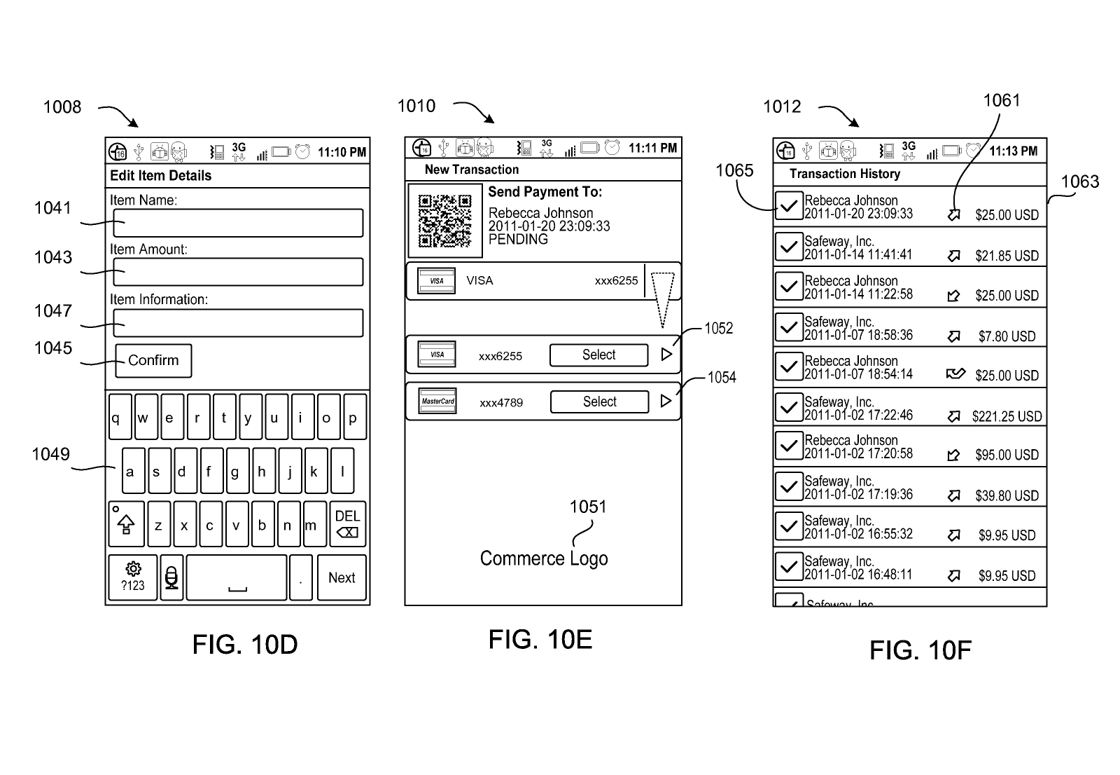

FIGS. 10A-F presents diagrams illustrating example application GUIs for a mobile device, in accordance with a specific embodiment. As illustrated in the example embodiments of FIGS. 10A-F, the Transaction Identification System may be operable to generate and/or utilize a variety of different types of GUIs having a variety of different features, which, for example, may include, but are not limited to, one or more of the following (or combinations thereof):
System login GUI 1002
   merchant/agent name/ID 1014
   passcode input 1011
   input confirmation buttons 1013
Item list and payment options GUI 1004
   machine-readable TID content 1012
   transaction type, agent/client name, transaction status portion 1027
   payment account drop-down menu 1029
   total amount due 1028
   item unit Price 1026
   item name/description 1023
   transaction confirmation buttons 1025
Transaction confirmation receipt GUI 1006
   status indicator 1033
   transaction type 1035
   transaction identifier reference 1037
   transaction details 1039
   agent/client logo/ad information 1038
   transaction status details 1031
Agent item input GUI 1008
   item name input 1041
   item pricing input in 1043
   item description input 1047
   input confirmation 1045
   software keyboard 1049
Payment account selection GUI 1010
payment method/payment account selection options 1052, 1054
Transaction history GUI 1012
   transactions selection 1065
   status indicator 1061
   transaction record 1063
      In at least one embodiment, example transaction record details may include, but are not limited to, one or more of the following (or combinations thereof):
Transaction amount
Currency type
Transaction type
Transaction status
Transaction timestamp

In at least one embodiment, System login GUI may operate to enable gaining access to system. Item list/payment options GUI may operate to present item and payment associated information. Confirmation receipt GUI may operate to present confirmation information. Agent item input GUI may operate to enable entry of agent associated information. Account selection GUI may operate to enable account selection. Transaction history GUI may operate to present information associated with historical transactions.

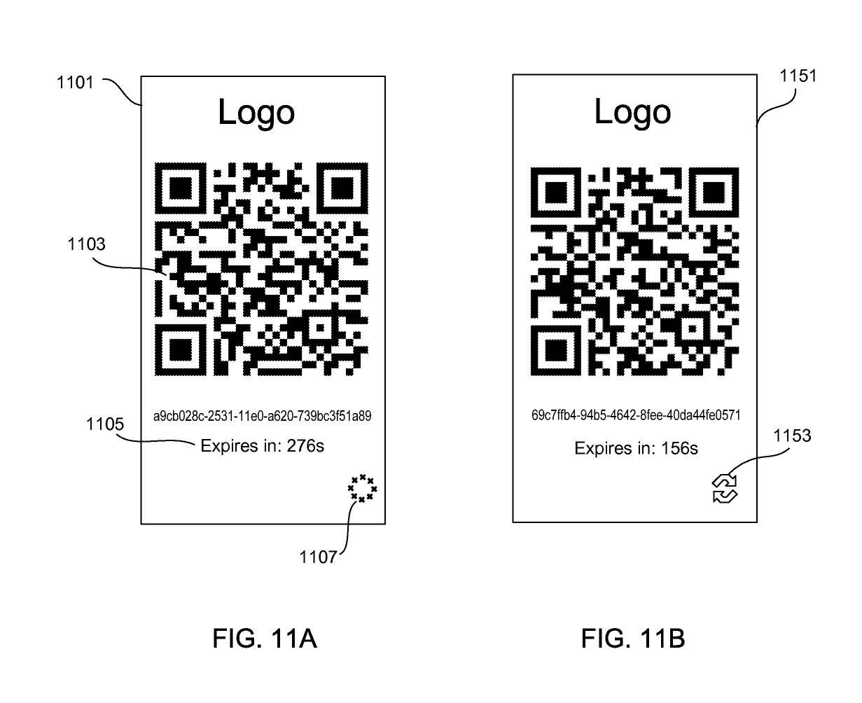

FIGS. 11A-B presents diagrams illustrating an example transaction identifier and operation of associated transaction identifier poll indicator, in accordance with a specific embodiment. As illustrated in the example embodiments of FIG. 11A-B, the Transaction Identifiers may be configured or designed to include and/or display various types of content and/or features such as, for example, one or more of the following (or combinations thereof):
machine-readable transaction identifier content 1103
transaction identifier expiration indicator content 1105
active polling indicator 1107
manual refresh/polling indicator 1153
etc.

In the example of FIG. 11A, a transaction identifier (TID) 1103 is shown as being currently active with the TID indicator (1105) indicating 276 seconds remaining before the TID's expiration. The polling indicator (1107) indicates that the device is still in active polling mode, wherein the device may automatically and periodically poll the Transaction Identification Server System for active/pending transactions (and/or other information). For example, in one embodiment, while in active polling mode, the device may actively poll the TISS about every 3 seconds. If, after 60 seconds no active/pending transactions are detected, the device may then switch to manual polling mode.

In the example of FIG. 11B, the transaction identifier (TID) is shown as being currently active with the TID indicator indicating 156 seconds remaining before the TID's expiration. The polling indicator (1153) indicates that the device is in manual polling mode. In at least one embodiment, a user may tap or select manual polling icon 1153 in order to cause the device to initiate a polling operation.

As a non-limiting example, transaction identifier may operate to present an expiration countdown and poll indicator status. Furthermore, client may operate to restart polling process by selecting poll indicator.

When a client launches the transaction identifier associated application (client software) on a client device (e.g. mobile device) a transaction oriented identifier may be presented. An expiration timer indication may be presented near the lower portion of the transaction identifier. The timer associated with the timer indication may count down time from a predetermined time, for example seconds. Furthermore, when the timer reaches zero the transaction oriented identifier may operate to disappear with a new transaction oriented identifier displayed in its location.

The polling indicator may operate in two states, active and inactive. The Transaction Identification Device Application (client software) may operate to poll the transaction identifier server (system server) for associated transactions for a set period of time—for example 60 seconds. During this active state the polling indicator may operate to display an indicator. As a non-limiting example, indicator may appear as a spinning motion. Furthermore, as an example, after presentation for a period of time polling may cease to be performed with the polling indicator being displayed as a refresh symbol. Furthermore, selecting the refresh symbol may operate to restart polling operation for system transactions.

Furthermore, an alternative method may be used not requiring polling. For non-polling operation, the user software may operate a server daemon (observing port for example for server transactions) during the presentation of an active indicator. Furthermore, the identification sever software may operate to communicate with the client device when the transaction may operate to be processed. Furthermore, IP device information may be provided to the server following a user device performing a first connection to the identification system.

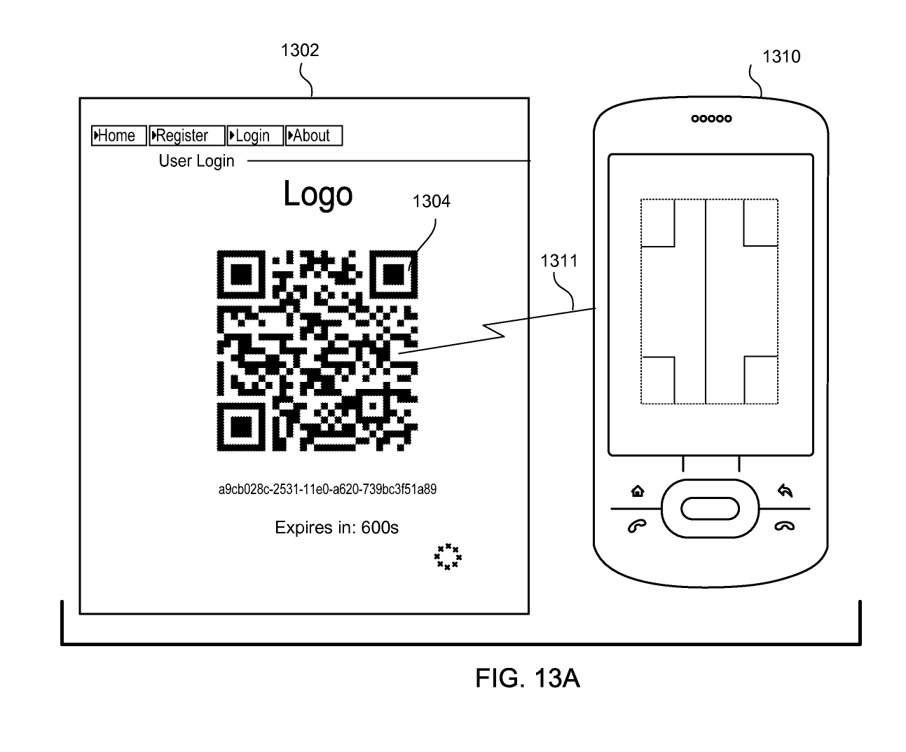

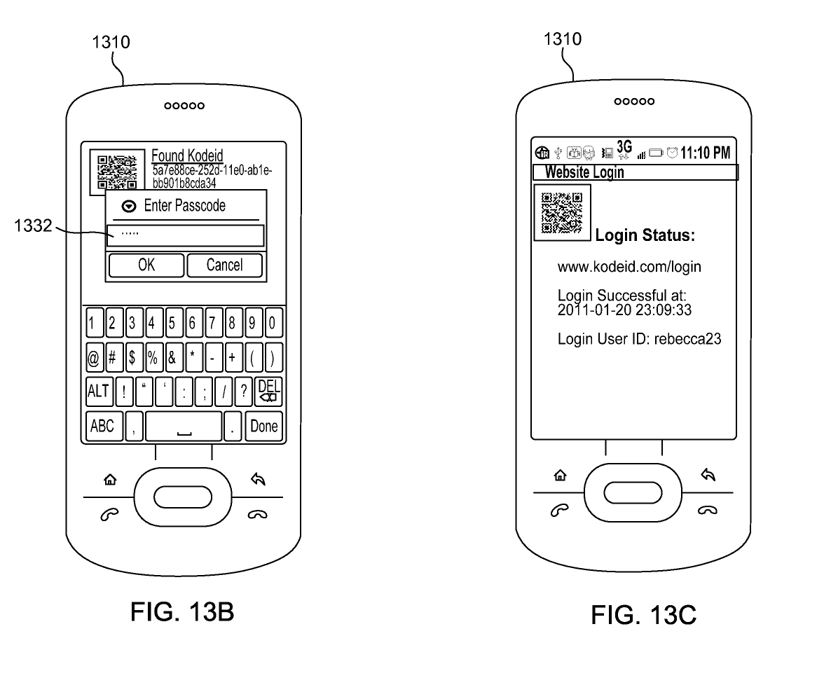

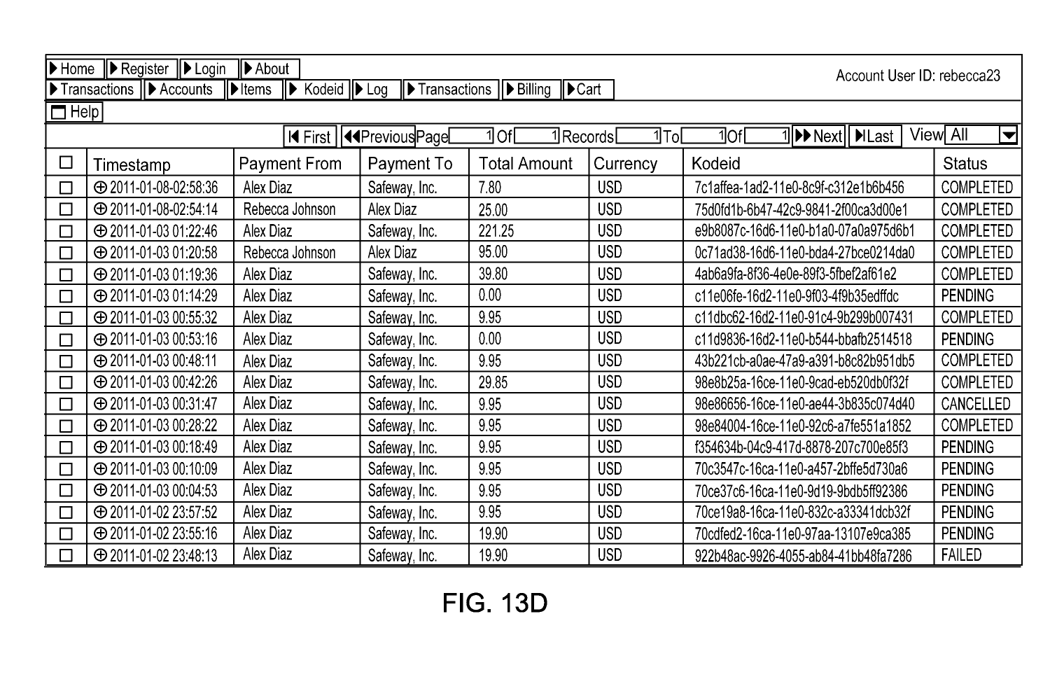

FIG. 13A-D present diagrams illustrating an example operation for a website authentication, in accordance with a specific embodiment.

Client may operate to access login page via web browser. Identification system may operate to generate transaction oriented identification. Client may operate to scan transaction identifier. Client may operate to enter passcode for gaining access to system. Client may operate to review agent authentication information and may accept/decline authentication. Client may receive transaction status information. Following successful authentication, secure content may be presented.

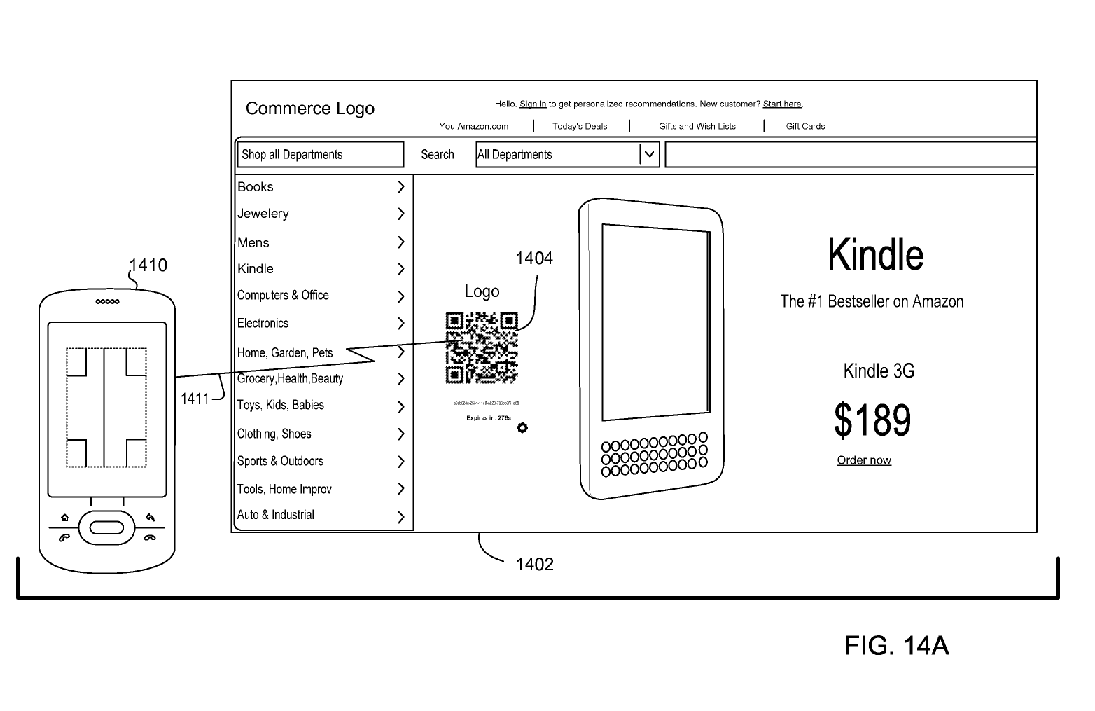

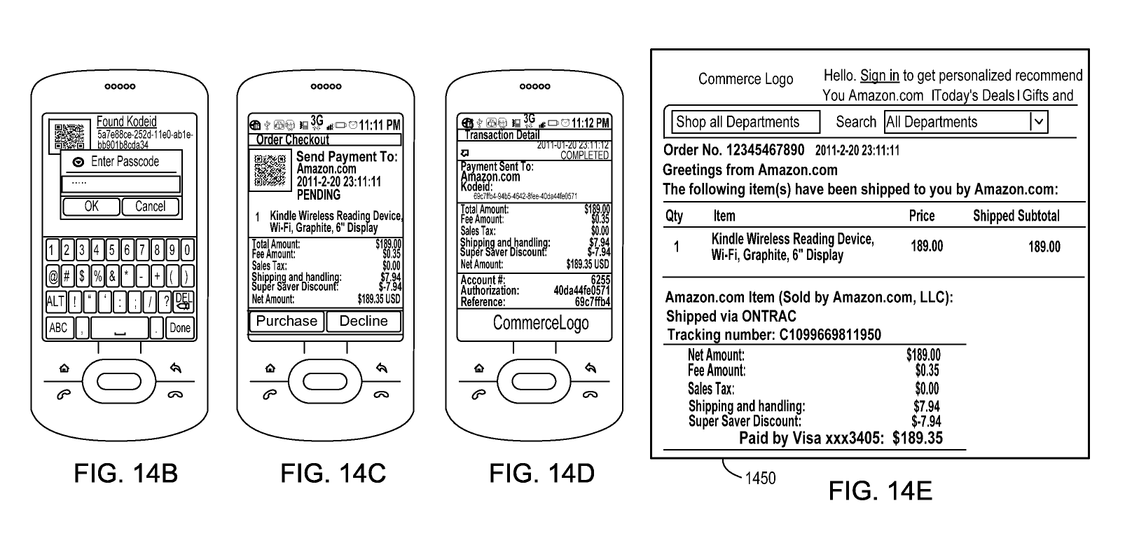

FIGS. 14A-E present diagrams illustrating an example operation for a commerce transaction associated with a website, in accordance with a specific embodiment.

Client may operate to access login web site via a web browser. Identification system generates transaction oriented identification. Client scans transaction identifier. Client enters passcode for gaining access to system. Client reviews transaction information and item information and may accept/decline transaction. Client may operate to receive transaction status information.

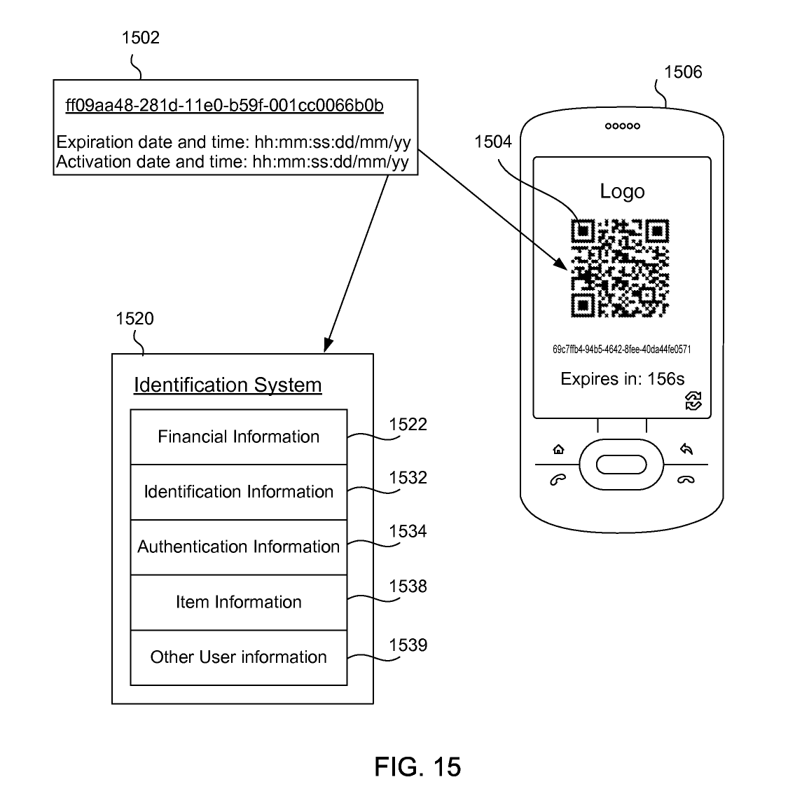

FIG. 15 presents a diagram illustrating an example associating a transaction identification and identification system database as described with reference to FIG. 3, in accordance with a specific embodiment. User information portion 314 (FIG. 3) may operate to store and retrieve a transaction identifier information 1502 for a transaction identifier 1504 associated with a user device 1506.

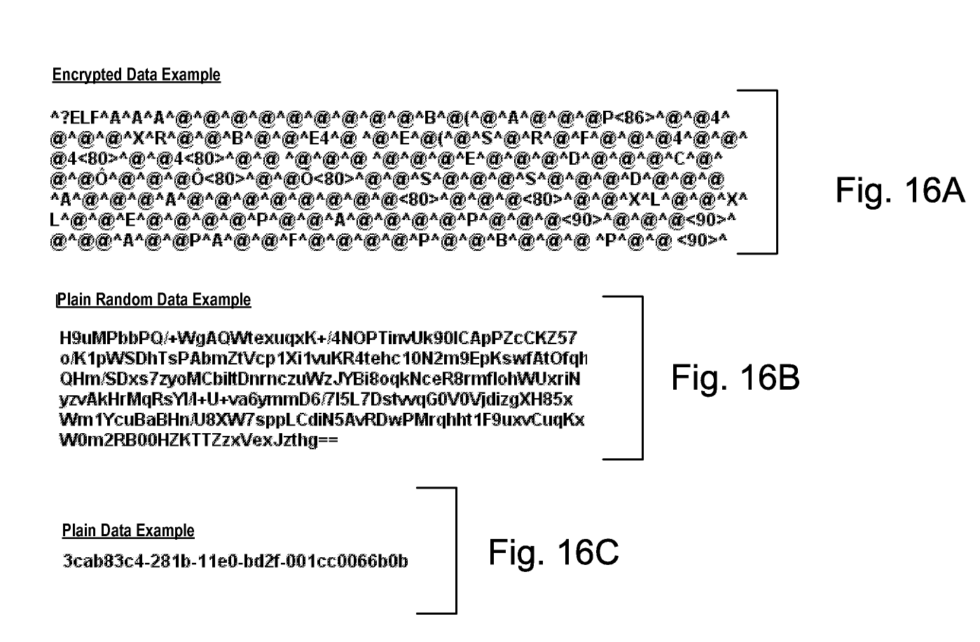

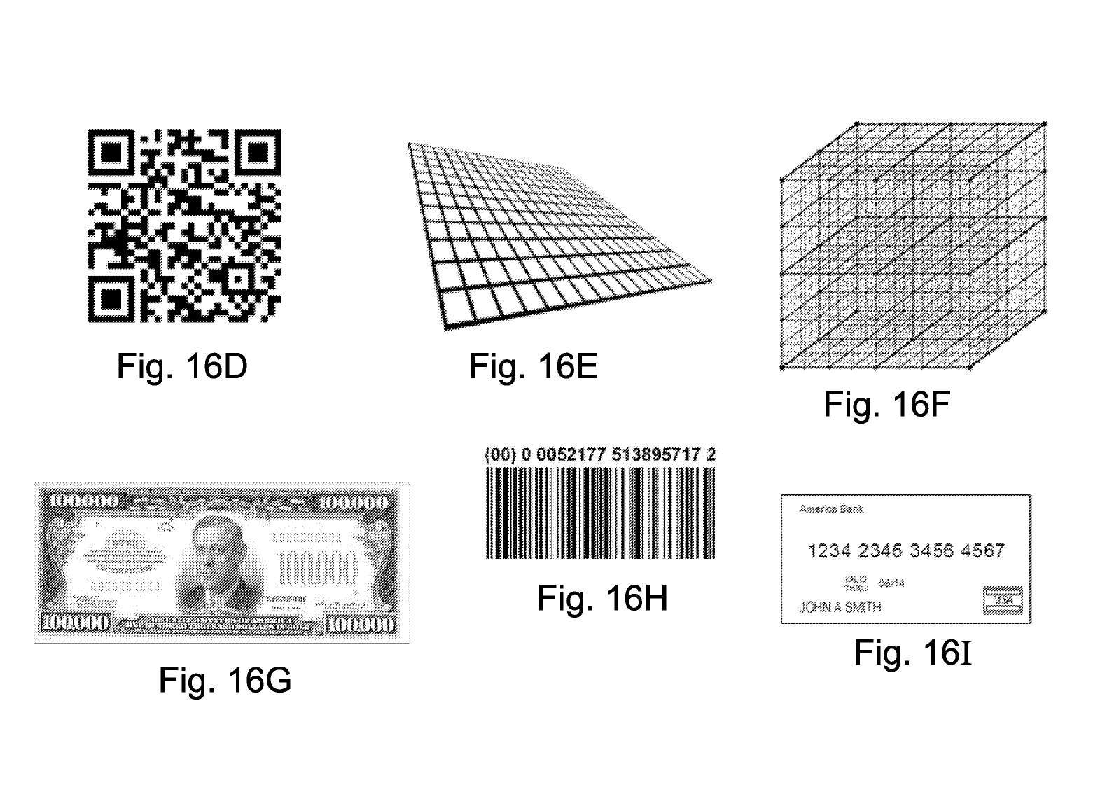

FIGS. 16A-I present diagrams illustrating example transaction identification data types, in accordance with a specific embodiment. Non-limiting examples of presentations for transaction identifiers include data, barcodes, currency, credit cards, checks, and/or other types of machine-readable information.

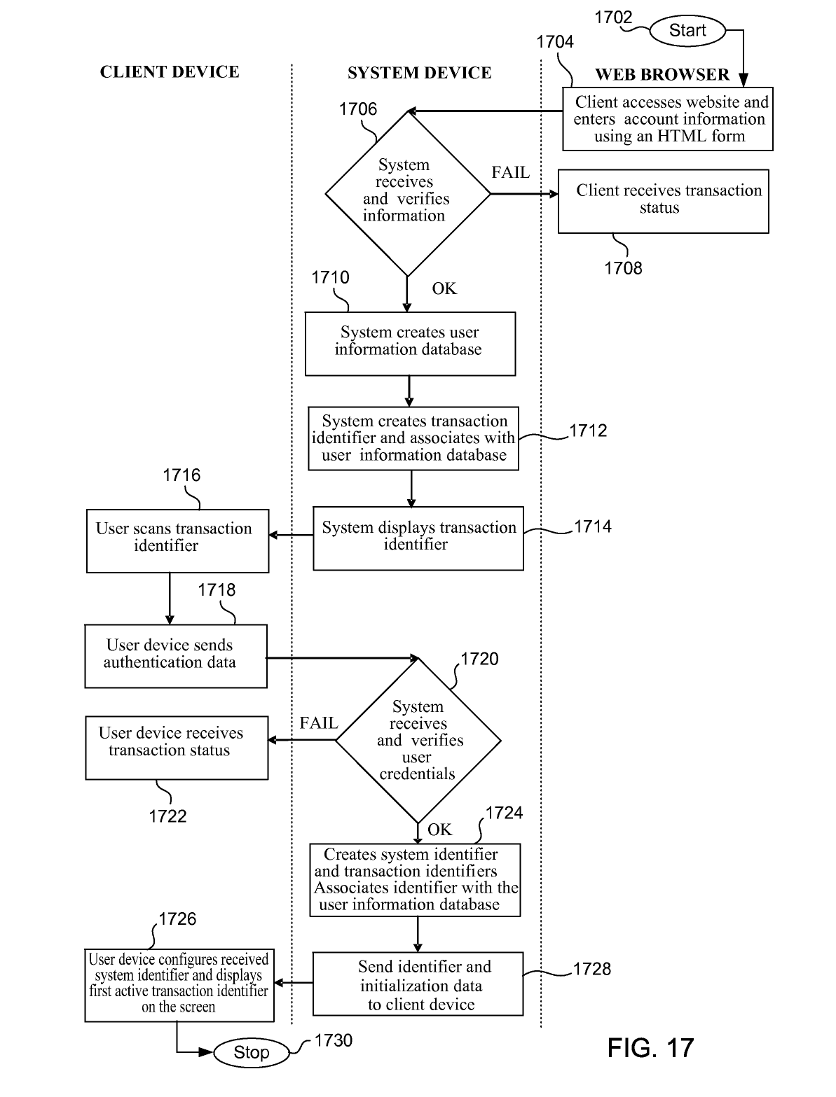

FIG. 17 presents a flow chart illustrating an exemplary method for account creation, in accordance with a specific embodiment.

In at least one embodiment, a method 1700 initiates in a step 1702. In a step 1704, a user via a client device (e.g. client 304 (FIG. 3)) may operate to access a website hosted by a server device (e.g. server device 108 (FIG. 1B)) for entering account associated information. In a step 1706, a determination for user entering correct information in step 1704 may be performed. For a determination of incorrect information entered in step 1706, client may be offered opportunity to enter correct information in a step 1708. For a determination of correct information entered in step 1706, system may operate to create an account associated with user in a step 1710. In a step 1712, system may operate to create a transaction identifier (e.g. transaction identifier 200 (FIG. 2)) associated with user via information database. In a step 1714, system may present created transaction identifier to user for viewing. In a step 1716, user may operate to scan presented transaction identifier. In a step 1718, user device may operate to communicate authentication data to system. In a step 1720, system may receive scanned information and perform verification of the credentials associated with user. For a determination of a verification failure in step 1720, user associated device may receive in a step 1722 transaction status associated with failure. For a determination of successful verification in step 1720, system may operate in a step 1724 to create a system identifier and transaction identifiers and perform association of system identifier and transaction identifiers with user via information database. In a step 1728, identifiers and initialization associated information may be communicated to client device. In a step 1726, user device may operate to configure received system identifier and present the first active transaction identifier for viewing to the user. In a step 1730, execution of method 1700 may terminate.

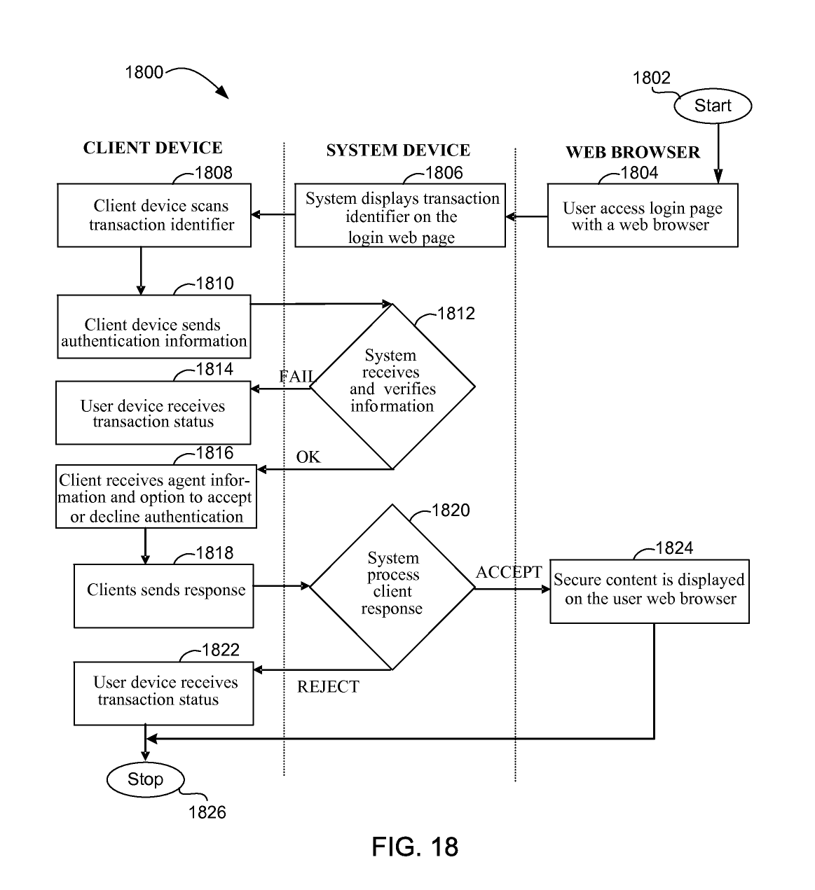

FIG. 18 presents a flow chart illustrating an exemplary method for performing authentication, in accordance with a specific embodiment.

In at least one embodiment, a method 1800 initiates in a step 1802. In a step 1804, a user may be provided opportunity for accessing system via a web browser. In a step 1806, system may operate to present a transaction identifier (e.g. transaction identifier 200 (FIG. 2)) via web page for gaining access to system. In a step 1808, user may operate to scan transaction identifier via client device (e.g. client 304 (FIG. 3)). In a step 1810, client device may operate to communicate authentication information to system. In a step 1812, system may operate to receive authentication information and perform verification of authentication information. For a determination of authentication failure in step 1812, user device in a step 1814 may operate to receive and present transaction status to user. For a determination of authentication success in step 1812, client may operate in a step 1816 to receive information associated with agent with an option for accepting or declining authentication. In a step 1818, client may communicate an information response to system. In a step 1820, system may receive and process information response communicated by client and performs a determination for accepting or rejecting response. For a determination of rejecting response in step 1820, user device may operate to receive in a step 1822 transaction status associated with rejection from system. For a determination of accepting response in step 1820, secure content may be presented in a step 1824 to user. Following execution of step 1822 or step 1824, method 1800 may terminate execution in a step 1826.

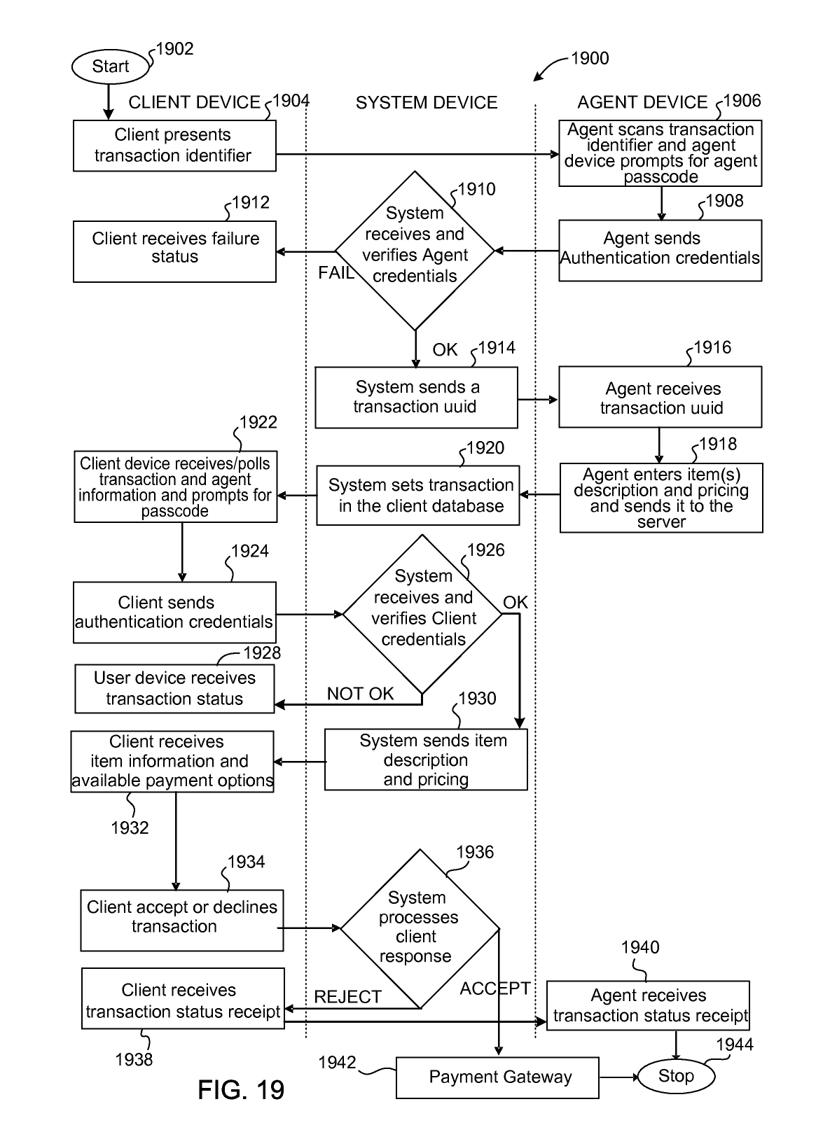

FIG. 19 presents a flow chart illustrating an exemplary method for performing payment transactions, in accordance with a specific embodiment.

In at least one embodiment, a method 1900 initiates in a step 1902. In a step 1904, client (e.g. client 304 (FIG. 3)) may operate to present a transaction identifier (e.g. transaction identifier 200 (FIG. 2)) to agent (e.g. agent 302 (FIG. 3)). In a step 1906, agent may operate to scan received transaction identifier and prompt for agent passcode. In a step 1908, agent may operate to communicate authentication credentials to system. In a step 1910, a verification operation may be performed for credentials associated with agent. For a verification failure in step 1910, client in a step 1912 may receive an information notification indicating a failure status. For verification success in step 1910, system may in a step 1914 communicate a transaction QUID to agent. In a step 1916, agent may operate to receive transaction QUID of step 1914. In a step 1918, agent may provide and communicate item descriptions and associated pricing information to system server. In a step 1920, system may operate to associate a transaction with client database. In a step 1922, client associate device may receive transaction and agent information and prompt for passcode information. In a step 1924, client may operate to communicate authentication credentials to system. In a step 1926, system may operate to receive and verify authentication credentials. For an authentication failure in step 1926, user device may in a step 1928, receive a transaction failure status indication. For authentication success in step 1926, system may in a step 1930 communicate item description and associated pricing. In a step 1932, client may operate to receive item information and associated available payment options. In a step 1934, client may accept or decline a transaction. In a step 1936, system may operate to process client response. For a determination of rejecting client response in step 1936, client may in a step 1938 receive a rejection status notification and in a step 1940, agent may receive a rejection status notification. For a determination of accepting client response in step 1936, payment transaction may be performed in a step 1942. Following step 1940 and step 1942, method 1900 may terminate execution in a step 1944.

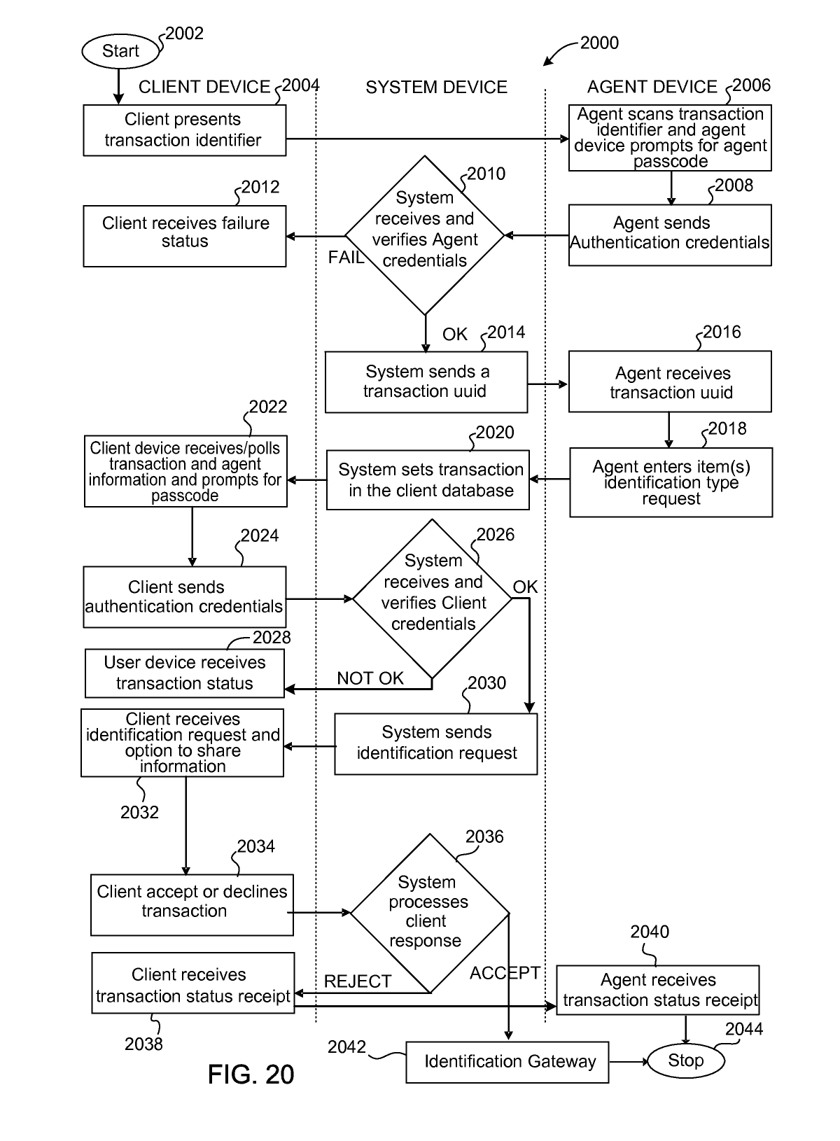

FIG. 20 presents a flow chart illustrating an exemplary method for performing identification processing, in accordance with a specific embodiment.

In at least one embodiment, a method 2000 initiates in a step 2002. In a step 2004 client (e.g. client 304 (FIG. 3)) may operate to present a transaction identifier (e.g. transaction identifier 200 (FIG. 2)) to agent (e.g. agent 302 (FIG. 3)) for performing identification processing. In a step 2006, agent may operate to scan transaction identifier and prompt for agent passcode. In a step 2008, agent may operate to communicate authentication credentials to system. In a step 2010, system may operate to receive and verify agent credentials. For verification failure in step 2010, in a step 2012, client may receive a failure status notification. For verification success in step 2010, in a step 2014, system may communicate a transaction QUID to agent. In a step 2016, agent may operate to receive transaction QUID. In a step 2018, agent may provide item identification type request. In a step 2020, system may associate a transaction for client via database. In a step 2022, client may operate to receive transaction and agent information and prompt for a passcode. In a step 2024, client may operate to communicate authentication credentials to system. In a step 2026, system may operate to receive and verify credentials associated with client. For a verification failure identified in step 2026, user device may in a step 2028 operate to receive transaction failure status notification. For verification success in step 2026, system may in a step 2030 operate to communicate an identification request to client. In a step 2032, client may operate to receive identification request with an associated option to share identification information. In a step 2034, client may operate to accept or decline transaction. In a step 2036, system may operate to process client response. For a declined transaction in step 2036, client may in a step 2038 receive a transaction status receipt notification. In a step 2040, agent may operate to receive a transaction status receipt notification. For an accepted transaction in step 2036, identification operation may be performed in a step 2042. Following step 2040 and step 2042, method 2000 may terminate execution in a step 2044.

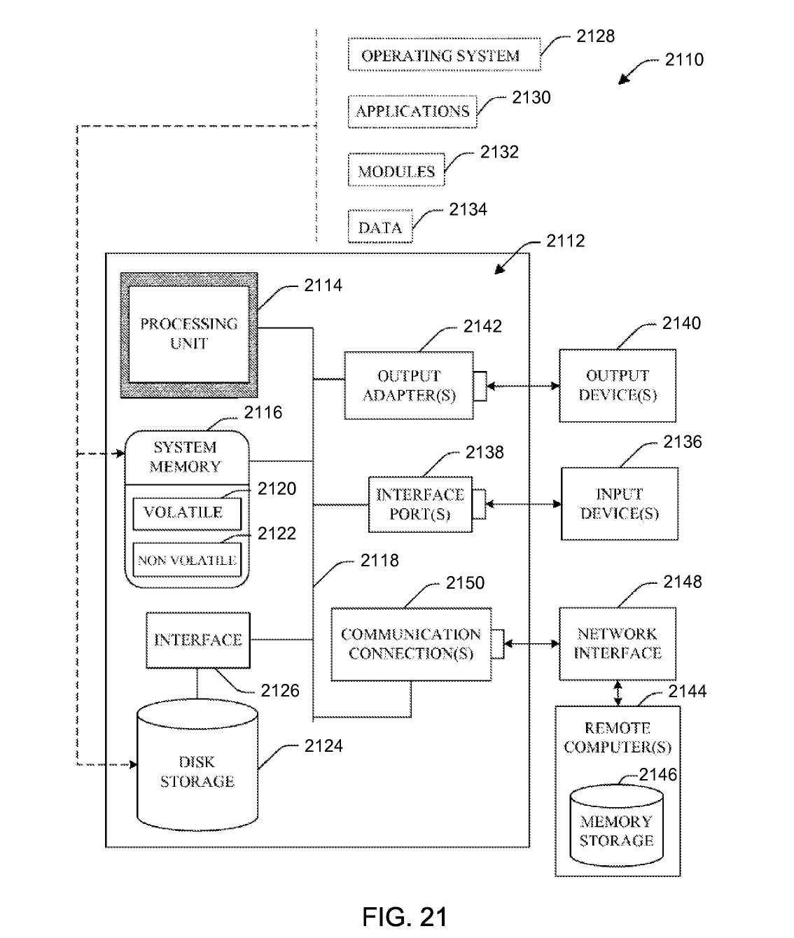

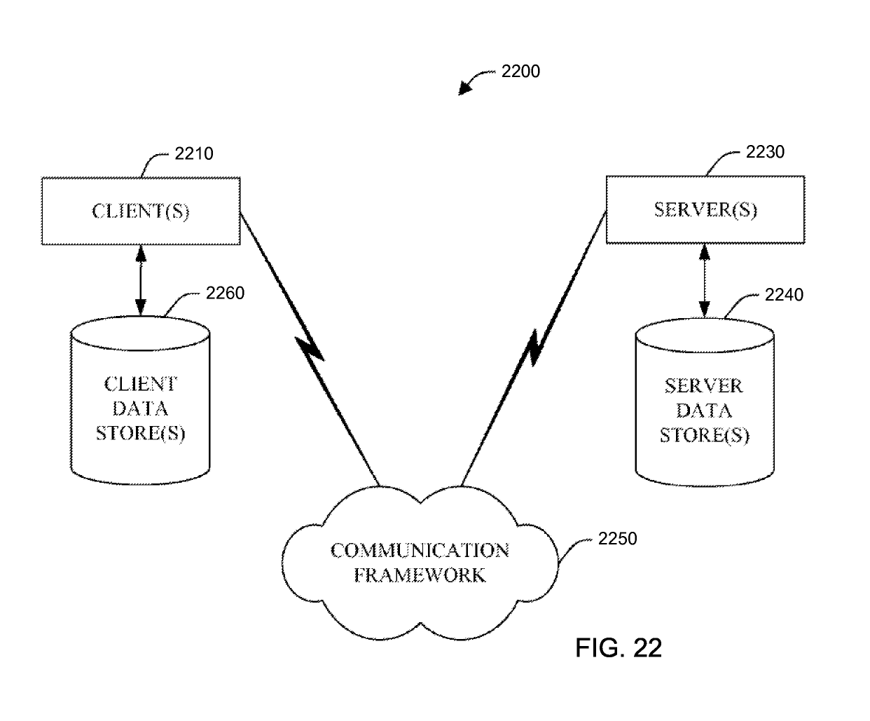

Referring now to FIGS. 21 and 22, there are illustrated block diagrams of an exemplary computer system operable to execute aspects of the disclosed subject matter. In order to provide additional context for various aspects of the subject disclosure, FIGS. 21 and 22, and the following discussion, are intended to provide a brief, general description of a suitable computing environment 2100 and networking environment 2200 in which the various aspects of the disclosure can be implemented. Additionally, while the disclosure has been described above in the general context of computer-executable instructions that may run on one or more computers, those skilled in the art will recognize that aspects of the disclosure also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media as well as removable and non-removable media. By way of example, and not limitation, computer-readable media can comprise computer storage media and communication media. Computer storage media can include both volatile and nonvolatile, removable and non-removable media implemented in any suitable method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 21, the exemplary environment 2100 for implementing various aspects of the invention includes a computer 2102, the computer 2102 including a processing unit 2104, a system memory 2106 and a system bus 2108. The system bus 2108 couples components of system 2100 including, but not limited to, the system memory 2106 to the processing unit 2104. The processing unit 2104 can be any of various commercially available processors. Dual microprocessors and other multi-processor architectures can also be employed as the processing unit 2104.

The system bus 2108 can be any of several types of bus structure that may further interconnect to a memory bus (with or without a memory controller), a peripheral bus, and a local bus using any of a variety of commercially available bus architectures. The system memory 2106 includes read-only memory (ROM) 2110 and random access memory (RAM) 2112. A basic input/output system (BIOS) is stored in a non-volatile memory 2110 such as ROM, EPROM, EEPROM, which BIOS contains the basic routines that help to transfer information between elements within the computer 2102, such as during start-up. The RAM 2112 can also include a high-speed RAM such as static RAM for caching data.

The computer 2102 further includes an internal hard disk drive (HDD) 2114 (e.g., EIDE, SATA), which internal hard disk drive 2114 may also be configured for external use in a suitable chassis (not shown), a magnetic floppy disk drive (FDD) 2116, (e.g., to read from or write to a removable diskette 2118) and an optical disk drive 2120, (e.g., reading a CD-ROM disk 2122 or, to read from or write to other high capacity optical media such as the DVD). The hard disk drive 2114, magnetic disk drive 2116 and optical disk drive 2120 can be connected to the system bus 2108 by a hard disk drive interface 2124, a magnetic disk drive interface 2126 and an optical drive interface 2128, respectively. The interface 2124 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 2102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. It is appreciated that the invention can be implemented with various commercially available operating systems or combinations of operating systems.

A user can enter commands and information into the computer 2102 through one or more wired/wireless input devices, e.g., a keyboard 2138 and a pointing device, such as a mouse 2140. Other input devices (not shown) may include a microphone, an IR remote control, a joystick, a game pad, a stylus pen, touch screen, or the like. These and other input devices are often connected to the processing unit 2104 through an input device interface 2142 that is coupled to the system bus 2108, but can be connected by other interfaces, such as a parallel port, an IEEE1394 serial port, a game port, a USB port, an IR interface, etc.

A monitor 2144 or other type of display device is also connected to the system bus 2108 via an interface, such as a video adapter 2146. In addition to the monitor 2144, a computer typically includes other peripheral output devices (not shown), such as speakers, printers, etc.

The computer 2102 may operate in a networked environment using logical connections via wired and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wired/wireless connectivity to a local area network (LAN) 2152 and/or larger networks, e.g., a wide area network (WAN) 2154. Such LAN and WAN networking environments are commonplace in offices and companies, and facilitate enterprise-wide computer networks, such as intranets, all of which may connect to a global communications network, e.g., the Internet.

When used in a LAN networking environment, the computer 2102 is connected to the local network 2152 through a wired and/or wireless communication network interface or adapter 2156. The adapter 2156 may facilitate wired or wireless communication to the LAN 2152, which may also include a wireless access point disposed thereon for communicating with the wireless adapter 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wired or wireless device, is connected to the system bus 2108 via the serial port interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11(a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 22 Mbps (802.11a) or 54 Mbps (802.11b) data rate, for example, or with products that contain both bands (dual band), so the networks can provide real-world performance similar to the basic 9BaseT wired Ethernet networks used in many offices.

Referring now to FIG. 22, there is illustrated a schematic block diagram of an exemplary remote communication environment operable to execute aspects of the disclosed subject matter. The system 2200 includes one or more client(s) 2210. The client(s) 2210 can be hardware and/or software (e.g., threads, processes, computing devices). The client(s) 2210 can house cookie(s) and/or associated contextual information related to data exchanged between a first remote device (2210) (e.g., including a MCD) and a second remote device (2230) (e.g., including a financial account server) as described herein, for example.

The system 2200 also includes one or more server(s) 2230. The server(s) 2230 can also be hardware and/or software (e.g., threads, processes, computing devices). The servers 2230 can house threads to perform transformations by employing the invention, for example. One possible communication between a client 2210 and a server 2230 can be in the form of a data packet adapted to be transmitted between two or more computer processes. The data packet may include a cookie and/or associated contextual information, for example. The system 2200 includes a communication framework 2250 (e.g., a global communication network such as the Internet) that can be employed to facilitate communications between the client(s) 2210 and the server(s) 2230.

Communications can be facilitated via a wired (including optical fiber) and/or wireless technology. The client(s) 2210 are operatively connected to one or more client data store(s) 2260 that can be employed to store information local to the client(s) 2210 (e.g., cookie(s) and/or associated contextual information). Similarly, the servers 2230 are operatively connected to one or more server data store(s) 2240 that can be employed to store information local to the servers 2230.

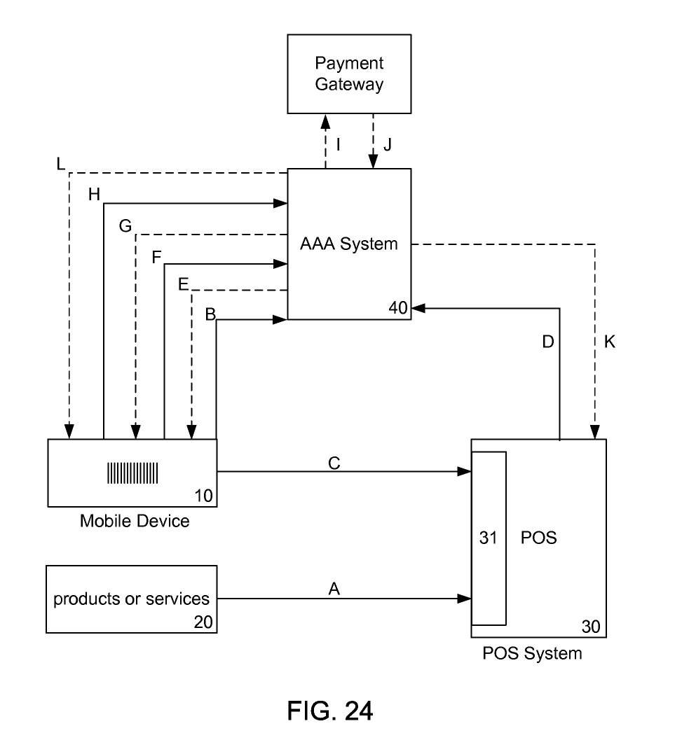

FIG. 24 is a diagram illustrating the architectural layout and interaction between the components of an exemplary centralized debit or credit accounting system during a credit or debit transaction, in accordance with one embodiment. At least one embodiment comprises a mobile device 10, a retailer POS system 30, an authentication, authorization and accounting (AAA) system 40, and a payment gateway 50. Those skilled in the art, in light of the present teachings, may readily recognize that multiple mobile devices may be connected to the Transaction Identification System. Furthermore, alternate embodiments may comprise multiple POS systems, multiple AAA systems or multiple payment gateways. In at least one embodiment, the Transaction Identification System is used to enable a user to authenticate and easily pay for products or services 20 from POS system 30 using mobile device 10 through a transaction A. At least one embodiment enables any type of credit or debit card to be used including, but not limited to, Master Card, Visa, Discover, etc. At least one embodiment also allows 3^{rd} party payment processors such as, but not limited to, PayPal and Google checkout to be used.

Mobile device 10 comprises a CPU, memory, Internet access, and is capable of displaying a machine-readable insignia that may be scanned from the display of mobile device 10 at POS system 30 through a scanning connection C. Examples of machine-readable insignia include, without limitation, 1D or 2D bar codes (e.g., code 128, maxicode, datamatrix, etc), images in any format (e.g., jpeg, png, gif etc), 3D animations (e.g., 3D grids or shapes) or any type of data representation that may be displayed in the mobile client screen and may be transformed or translated with a scanner device to an authentication id for the mobile client. POS system 30 is equipped with a scanner capable of scanning machine-readable insignia from the display of mobile device 10. Scanner types that may be used include, without limitation, a charge-coupled device (CCD) scanner, a photographic scanner, a camera, etc. Upon scanning the mobile client insignia, a connection D is established between POS system 30 and AAA system 40, and one or more types of information may be transmitted such as, for example: mobile client ID, POS ID and passcode, total transaction amount, transaction type, etc. Other information may be sent to AAA system 40 and adapted to the POS requirements, such as, for example: itemized transactions or other detailed information.

In at least one embodiment, Connection D is kept alive until a response is received from AAA system 40 or the connection timer times out. Alternative poll methods may be used to communicate to the AAA system. Upon processing the transaction, POS system 30 receives a transaction response K from AAA system 40. The type of response given in transaction response K depends on the transaction type and outcome. For example, without limitation, transaction response K may indicate that the transaction was approved or denied, or that the transaction is pending, etc. Transaction response K is displayed on the display screen of POS system 30.

The centralized debit or credit accounting system may function as a stand-alone application or may be integrated into existing retail POS software through a simple object access protocol (SOAP) application programming interface (API). The SOAP API offers the flexibility to use the Transaction Identification System in any platform and facilitates the integration into existing payment systems. The Transaction Identification System may be deployed at virtually any POS. In at least one embodiment, the Transaction Identification System uses SOAP technology over secure sockets layer (SSL) to secure the communication.

Those skilled in the art, in light of the present teachings, may readily recognize that any other type of protocol and message type may be implemented in alternate embodiments for example, without limitation, HTTP POST and GET methods or AJAX PUSH technologies may be used to exchange messages between systems.

In at least one embodiment, the communication between systems uses TCP/IP for communication and the connection between systems is maintained using keep alive techniques, but poll methods may be used too. In at least one embodiment, the Transaction Identification System uses the Internet or WIFI as the media to transfer the information. Internet access providers such as, but not limited to, AT&T, Verizon, or T-Mobile using Edge, 2G, or 3G technologies may be used to enable mobile device 10 to communicate with the Transaction Identification System. Alternatively, stores may provide WIFI connectivity to customers for the purposes of consuming their products or services. For instance, without limitation, retail stores may provide WIFI connectivity to cell phones or other mobile devices to enable clients to pay for goods, services, groceries, etc. In alternate embodiments, other means of communication may be used such as, but not limited to: 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, SMS technology, etc. For example, in one embodiment, messages between the mobile device and the AAA system are exchanged using SMS technology with the help of a mobile provider.

In at least one embodiment of FIG. 24, AAA system 40 and POS system 30 are described as different devices; however, in alternate embodiments, both system may be part of one device and communicate within the device. AAA system 40 comprises databases containing the following information: mobile client and POS authentication information mobile client credit card information or preferred payment gateways, itemized transaction information, transaction types, etc. In alternate embodiments, additional databases and information may be added or adapted to the retail POS existing infrastructure such as, for example, one or more of the following (or combinations thereof):
advertisements;
retail store discounts;
memberships;
POS products and services;
customer profile information such as address, age, sex, etc;
databases which track consumer preference statistics and demographics;
etc.

In at least one embodiment, one or more or selected portions of this information may be managed using the SOAP API designed for POS system 30. However, in embodiments using different communication means, this information is managed by the particular communication means used by the Transaction Identification System. In at least one embodiment, AAA System 40 may support standard credit card transactions such as, but not limited to one or more of the following (or combinations thereof):
authorization and capture;
authorization only;
prior authorization and capture;
capture only;
credit;
unlinked credit;
void;
cash back;
automated teller machine (ATM) operations;
etc.

According to different embodiments, other types of transactions may also be implemented and used (e.g., via the POS SOAP API) such as, but not limited to, one or more of the following (or combinations thereof):
authentication or identification only;
account creation;
modification or deletion;
account information;
blacklist;
revoke or suspend insignias transaction history;
mobile-mobile transaction;
mobile-retail store transaction(s)
mobile-PC transaction(s);
Internet transaction(s)
etc.

In at least one embodiment, AAA system 40 communicates with mobile device 10, POS system 30 and payment gateway 50 to process a transaction. AAA system 40 receives a connection B from mobile device 10 when the insignia is displayed on mobile device 10. AAA system 40 accepts connection B and keeps it alive if the mobile client ID of mobile device 10 is valid in AAA system 40. When the mobile client insignia is scanned at POS system 30, connection D originating from POS system 30 is established with AAA system 40. Information from mobile user device 10 and POS system 30 is sent through connection D. AAA system 40 authenticates POS system 30. If the authentication is successful, AAA system 40 sends an authentication request E to mobile device 10. Authentication request E appears on the display of mobile device 10 as a passcode prompt.

When AAA system 40 receives authentication information F from mobile device 10 and, upon successful authentication, AAA system 40 sends back a transaction request G to mobile device 10. In the event the transaction is accepted by the mobile user, AAA system 40 receives a response message H and establishes a connection I with payment gateway 50. In at least one embodiment, payment gateway 50 may represent a standard payment processor such as, for example, one or more of the following: PayPal, Google Checkout, and/or other credit card or debit card processor(s).

In one embodiment, payment gateway 50 receives transaction requests I from AAA system 40 and returns transaction results J back to AAA system 40. It is through connection I that AAA system 40 sends pre-configured mobile user billing information. AAA system 40 receives transaction result J from payment gateway 50. Then, AAA system 40 sends a receipt message L to mobile device 10 and transaction response K to POS system 30.

In at least one embodiment, account authentication and security is accomplished by creating a virtual ID, the user insignia A, which hides or masks one or more of the user's account(s). The insignia itself may represent a randomized value and have no meaning if used without the AAA system. The virtual ID represents a complement key B, and the insignia is rendered useless without its complement key C. Complement keys are created from a universally unique identifier UUID generated by the AAA system. The UUID may configured or implemented as one or more of the following (or combinations thereof): a binary, an alpha-numeric string, and/or other suitable identifiers. In at least one embodiment, each UUID may be configured or implemented as a globally unique identifier. In some embodiments, UUIDs may be random based, name based, time based, node based, etc. Other types of UUIDs may be generated as long its uniqueness is respected and reproducibility is below desired minimum threshold value(s).

In at least one embodiment, the UUID string or value is broken in two parts or complements: one complement C is kept in the AAA system and the other one is the mobile client complement key B represented by the insignia A. Both UUID are concatenated together using a concatenation function H. Other functions or operations that may reproduce the same single string given two input values may be used.

In at least one embodiment, a hash string or value is obtained by applying a cryptographic hash function G to the complement keys (G and C). The cryptographic functions that may be used are, but not limited, MD4, MD5, SHA-1, SHA-2 or any other hash algorithm that is able to produce one or more time the same output value or string when apply to an input string. The output is the hash value or string F that is kept in the AAA server along with the complement key C. In at least one embodiment two different UUIDs were generated and at least one used as complements, but a single UUID could have been broken in two parts to create the complement keys.

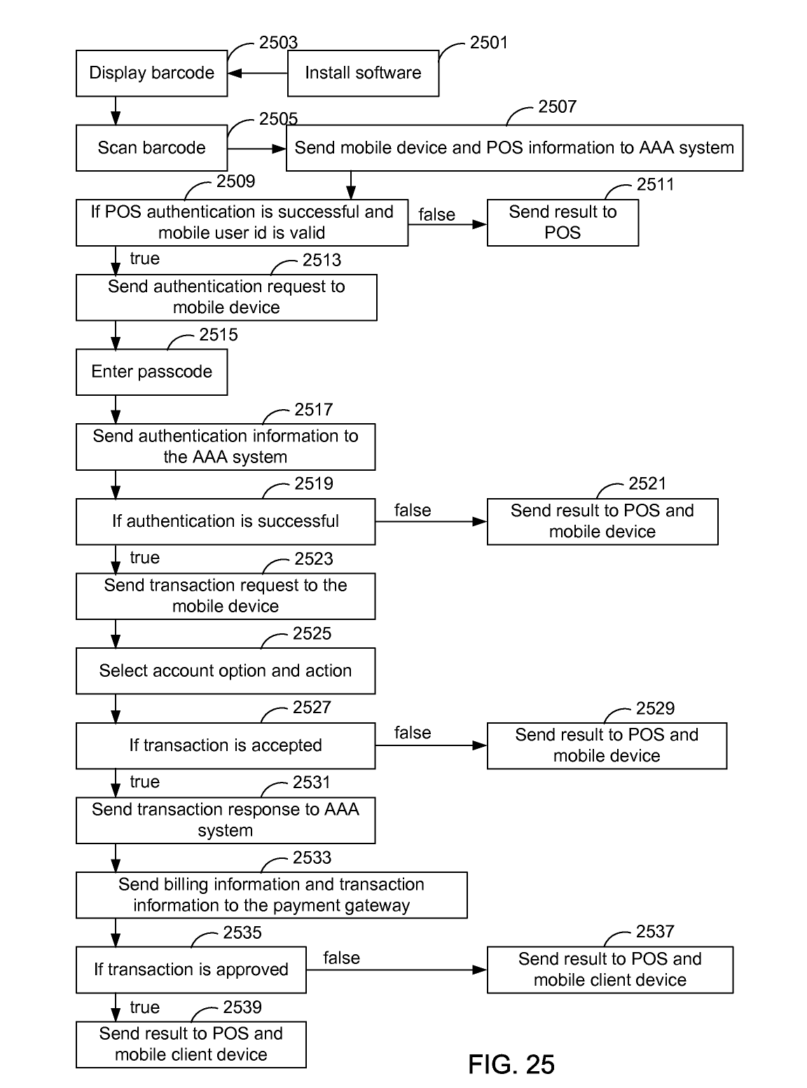

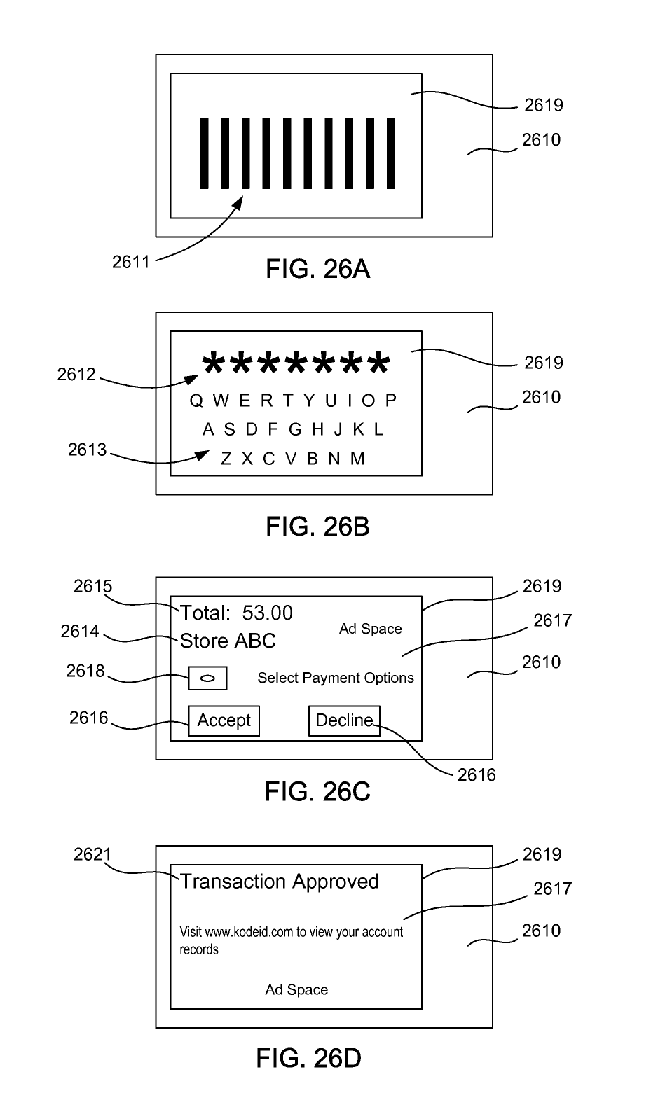

Upon scanning the insignia, the complement key is send to the AAA server for authentication 100. The AAA server applies the concatenate function H to the mobile client key B and its complement C stored in the AAA system. In at least one embodiment, it may apply the hash function G to the resulting string, as illustrated, for example, in FIG. 25. Additionally, it may compare the hash output D against the stored hash key F, as illustrated, for example, in FIGS. 26A-D. In one embodiment, if both hashes match, the mobile user is considered valid and a passcode request is sent to the client. The mobile client complement key may be verified in one or more connection(s).

In at least one embodiment, security is enforced may be achieved via use of a passcode (e.g., only known to the user), PIN, biometric identifier (e.g., fingerprint of user, voice print recognition, iris scan, etc.), RFID tag, and/or other types of security mechanisms. In at least one embodiment, the passcode may be numerical, alphanumerical or any string that may be entered using the mobile device keyboard. If the passcode matches the one stored in the AAA server the authentication is complete. Note that hash and passcode authentication may be successful to fully authenticate the mobile user.

In the event the insignias are lost or compromised in any way, for example, without limitation, due to a stolen mobile device or stolen passcode, such insignias may be disabled, revoked, blacklisted, and/or replaced. The passcode may be reset or changed at user request. These operations are available through a secure channel in the mobile client application, web portal, direct download or any other method that has the ability to secure the transfer and avoid the interception of the key or passcode.

At least one embodiment provides a centralized transaction history for one or more of the transactions performed using the centralized credit or debit accounting system. The transaction information may be accessible through a web portal or through the mobile software application. This feature enables the user to have a centralized tracking system for one or more of the accounts the mobile user has. In some embodiments, spending history graphics or budget management software may be integrated to the Transaction Identification System. Alternate embodiments may not provide the option of accessing a centralized transaction history.

At least one embodiment may also include a failover or backup accounts option. If an account using a failover option does not have enough funds or if the transaction is declined, the Transaction Identification System may use a backup account or failover to the next account until the transaction is approved. This option guarantees funds availability in a similar manner as a margin account does. Backup accounts may be configured by the user and may failover in a cascade fashion. Alternate embodiments may be implemented without a failover or backup accounts option.

FIG. 25 is a flow diagram illustrating exemplary procedures involved in processing a credit or debit transaction using a centralized debit or credit accounting system, in accordance with one embodiment. As illustrated in the example embodiment of FIG. 25, at operational block 2501, it is assumed that selected Transaction Identification software (e.g., Transaction Identification Device Application) is installed on a user's mobile device. As illustrated in the example embodiment of FIG. 25, at operational block 2503, when the user wishes to use the Transaction Identification System to perform a credit or debit transaction, the user may launch the Transaction Identification Device Application at the user's mobile device to thereby cause a transaction insignia (also referred to as a Transaction ID) to be displayed on the mobile device display.

In at least one embodiment, the insignia or Transaction ID represents a universal unique identifier (UUID) that may require a passcode for authentication. The insignia may be used to enable POS access to perform a transaction using an associated credit card, debit card, and/or account of the mobile user, and/or selected payment gateway for payment/processing.

In the example embodiment of FIG. 25, it is assumed that the mobile user presents the displayed Transaction ID to a POS operator (e.g., merchant, vendor, etc.).

As illustrated in the example embodiment of FIG. 25, at operational block 2505, the POS operator scans the insignia in operational block 2505.

At operational block 2507 mobile device information and POS information is sent to an AAA system. In operational block 2509 the POS is authenticated and the validity of the mobile user ID is checked. If the POS is not properly authenticated or the mobile user ID is not valid, this result is sent back to the POS in operational block 2511. If the POS is authenticated and the mobile user ID is valid, an authentication request is sent in the form of a passcode prompt from the AAA system to the mobile device in operational block 2513. In operational block 2515, the user enters a passcode into the mobile device in order to be authenticated. In operational block 2517 this authentication information is sent to the AAA system. In operational block 2519 it is determined if the user has been successfully authenticated. If the user is not authenticated, this result is sent to the POS system and to the mobile device in operational block 2521. If the user is successfully authenticated, a transaction request is sent to the mobile device in operational block 2523.

At this point, the user may choose which account he would like to use to complete the transaction if multiple accounts are attached to his mobile ID. In operational block 2525 the user selects an account option and action. The user may be presented with multiple account options such as, but not limited to, Visa, Master Card, American Express or PayPal. The account options may change depending on customer preferences and POS available or preferred accounts. For example if the customer is at Bloomingdales the customer might have the option to settle the transaction with a Bloomingdales account made available by the POS or a preferred customer account such as PayPal. Other options available to the user could be promotional sales displayed on the mobile screen. The user may select the promotional sale and the amount may be added automatically to the total. A cash back option may also be implemented and the POS may pay the mobile user upon successful authentication. Further options may be gratuities (Tips) in restaurants where the tip amount could be calculated by selecting the percentage amount or entered manually using the mobile keyboard. Any other option that subtracts or adds to the original amount received may be implemented. The user may then accept or decline the transaction in operational block 2527. If the user declines the transaction, this result is sent to the POS system and the mobile device in operational block 2529. If the user accepts the transaction, this transaction response is sent from the mobile device to the AAA system in operational block 2531. Then, in operational block 2533, billing and transaction information is sent to a payment gateway. The payment gateway may approve or decline the transaction in operational block 2535. If the transaction is declined, this result is sent to the POS system and the mobile device in operational block 2537. If the transaction is approved, the account is debited and this result is sent to the POS system and the mobile device in operational block 2539.

FIGS. 26A through 26D are diagrams illustrating exemplary display content of a mobile device 2610 at multiple steps of a transaction performed using a centralized debit or credit accounting system, in accordance with one embodiment. FIG. 26A shows the display of a machine-readable insignia 2611. FIG. 26B shows the entry of a passcode 2612. FIG. 26C shows an option to accept or decline a transaction, and FIG. 26D shows a transaction receipt 2621.

In at least one embodiment, in order to use the centralized debit or credit accounting system on mobile device 2610, mobile application software is installed on mobile device 2610 via the Internet. The mobile application software may be a mobile application written in any language such as, but not limited to, Java for android devices or objective c for iphone devices. The software may be downloaded and installed through a web portal or through mobile application stores such as, but not limited to, Android market by Google or appstore by Apple. The client may also be an Ajax web client using push technology such as the one described in the Ajax push engine (APE) project. Those skilled in the art, in light of the present teachings, may readily recognize that the application software may be installed on the mobile device using various different means such as, but not limited to, downloading from a computer, being preinstalled by the manufacturer, etc. Once the software is installed, insignia 2611 is generated by the AAA system, which contains a complement key. The application provides or displays information including, without limitation, user prompts, an input keyboard 2613, transaction information, advertisements space, and action buttons. The order in which the information appears to the user may be configured by the client designer. The order may be authentication first and transaction information second or vice versa. The information may include detailed transaction information or only desirable transaction information.

In at least one embodiment, referring to FIG. 26A, the software is capable of displaying machine-readable insignia 2611 on a display 2619 of mobile device 2610. Machine-readable insignia 2611 may be in the form of a 1D or 2D barcode. In alternate embodiments, other types of machine-readable indicia may be used as the insignia including, but not limited to, 1D or 2D bar codes (code 26128, maxicode, datamatrix, etc), images in any format (jpeg, png, gif etc), 26D animations (3D grids or shapes for example) or any type of data representation that may be displayed in the mobile client screen and may be transformed or translated with a scanner device to an authentication id for the mobile client. In at least one embodiment, insignia 2611 represents a mobile user identity for performing transactions at a POS. The mobile user identity comprises a QUID and a complement ID to a second ID located in the AAA system. When insignia 2611 is displayed on mobile device 2610, the application establishes a connection to the AAA system. The connection is maintained until a response is received from the AAA system or the transaction timer time outs. Then, an authentication request message is received from the AAA system. The mobile device software displays a passcode prompt on mobile device display 2619 upon receiving the authentication request message.

Referring to FIG. 26B, passcode 2612 is a pin or password that may comprise numeric, alphabetical or alphadecimal characters only known by the mobile user. The user enters passcode 2612 using keypad 2613 on mobile device 2610. In at least one embodiment, keypad 2613 comprises only alphabetical characters; however, keypads in alternate embodiments may comprise various other types of characters such as, but not limited to, numeric characters, alphadecimal characters, symbols, etc. Depending on the type of device that mobile device 2610 is, keypad 2613 may have various different forms. For example, without limitation, in touch screen mobile devices the keypad may be digital, and in non-touch screen devices, the keypad is mechanical. The application is able to receive and process the input passcode 2612 from mobile device keypad 2613. When the mobile user enters passcode 2612 and sends an authentication information message to the AAA system, a transaction request message is received on mobile device 2610 upon successful authentication.

In at least one embodiment, the POS system also has a passcode to access the centralized debit or credit accounting system. The POS passcode may be preconfigured into the POS software application and sent to the AAA system without user interaction. Alternatively, the POS passcode may be entered manually by the POS agent using a keyboard or other type of entry device such as, but not limited to, a numeric keypad or a mouse. The POS could be in fact another mobile device charging or transferring funds to another mobile device. The mobile device acting as POS may perform a transaction in a similar manner as the retail POS. For example mobile device acting at the POS may scan the insignia of the mobile device acting as the customer. The mobile device acting as POS may then authenticate credit, debit or perform in the same way described in the invention.

Referring to FIG. 26C, In at least one embodiment when the transaction request is received, the application software displays an amount 2615, a merchant name 2614, a payment options drop down menu 2618, and buttons 2616 to accept or decline the transaction. Detailed information may be displayed by tapping or otherwise selecting amount 2615 as selection actions may vary depending on the type of mobile device being used. This detailed information may include information such as, but not limited to, an itemized sum, tax amount, discount amount, timestamp or any other information the merchant would like to make available to the customer. Those skilled in the art, in light of the present teachings, may readily recognize that various different types of information and in different ways may be displayed on the transaction request message in alternate embodiments.

At least one embodiment enables the configuration of multiple accounts and provides the user with an option to choose the account to be debited. These accounts may be credit cards, debit cards, bank accounts, payment processors, or any other account that may be debited or used to perform a transaction at the POS for example, without limitation, Master Card, Visa, American Express, Citibank, PayPal, Google Checkout, store credit cards, etc. Payment options drop down menu 2618 provides the user with an option to choose the account to be debited if there are multiple credit cards or accounts attached to the user's mobile user ID. Alternate embodiments may only enable one account to be associated with at least one mobile user ID. At least one embodiment allows an identification mechanism which allows the POS to allow or deny access to services or products based on the information obtained, For example a mobile user may be identified as minor and be denied the purchase of alcohol or cigarettes. In another embodiment a mobile user may be identified as member of a certain membership such COSTCO or SAFEWAY or and gain access to facilities, services or discounts. The AAA system may include official identification information such as a driver's license information for example. The mobile user may then be identified using the driver's license number, picture, name, date of birth, expiration etc. In order to avoid identity theft or spoofing the digital identification information may be communicated directly to the AAA server from trusted sites once the user is properly authenticated. Another application of user authentication and identification is for access to a service or property. ZIP cars members may be identified and unlock their car for driving with the appropriate hardware and the current invention. People could use the invention to get access to their homes, hotel rooms and office if the door is equipped with related hardware and this invention. In the previous example the mobile client may act the POS and scan the insignia or have the insignia scanned by the other entity. The invention may also be used to authenticate Internet users to access secure web sites using their mobile devices. In the case of online baking for example Citibank may display on the web login page the insignia that corresponds to its identity. The mobile user may then scan the insignia with the mobile device and authenticate with the AAA server. If the authentication is successful after the user enters passcode information, the bank receives confirmation and the mobile user is granted access to the site. This is particularly useful when accessing bank accounts in public computers because one or more authentication information is entered through the mobile device and not the public computer. An alternate method accomplishing the same is to let the public computer act as the POS. In this scenario the insignia is scanned from the public computer and the bank web site sends the information to the AAA server for authentication. The mobile user then receives an authentication request and enters the passcode in the mobile device. Upon successful authentication the mobile user is granted access to the site. Authentication may also take place using only the mobile device web browser. In this case bank insignia value or string may be retrieved using the API or HTTP POST and GET methods. Once retrieved the mobile user may proceed to authenticate with the AAA server.

In some embodiments preferred accounts may be reinforced by the POS and given as an option to the mobile device. For instance, without limitation, if a customer is shopping at Nordstrom the first option for the user may be reinforced by the store to be the Nordstrom account. This gives the POS the opportunity to promote their cards and encourage their use rather than other accounts such as, but not limited to, Visa, PayPal, etc. Discount cards or membership cards may also be preconfigured in the Transaction Identification System in some embodiments, for example, without limitation, club store membership accounts and grocery store discount cards. In a non-limiting example using a Costco membership card, a user may identify his membership to Costco and enjoy the benefits of the membership by scanning a mobile device rather than showing the membership card at the entrance. The same idea may be applied to discount cards; for example, without limitation, when the mobile device is scanned at the POS, the discounted prices associated with the discount card are applied to the transaction. This feature may also be used to apply other types of automatic POS discounts if POS discount accounts are configured into the Transaction Identification System for example, without limitation, discounts for frequent shopping, etc.

Referring to FIG. 26D In at least one embodiment, the mobile user responds to the transaction request and a message is sent to the AAA system. Once the transaction is processed, a receipt message is sent back to mobile device 2610. The application software then displays receipt 2621 on mobile device display 2619. Referring to FIGS. 26C and 26D, screen space 2617 may be used for advertisement. This advertisement may include, without limitation, coupons, discounts, offers, sales, etc. Alternate embodiments may display other types of information in this screen space such as, but not limited to, store logos, software logos, instructions, etc. Other alternate embodiments may be implemented where this screen space is left blank. Advertisers may advertise products and discounts before and after processing the transactions. The advertising may be displayed in the mobile application software, as shown by way of example in FIGS. 26C and 26D or may be displayed in the centralized web portal where the user keeps track of spending history.

In addition to the transactions described in the foregoing, the Transaction Identification System In at least one embodiment supports a quick transaction method for small amount purchases. If the POS allows it and the Transaction Identification System is configured for quick transactions, one or more that is required is to scan the mobile device and the transaction is processed as long as the insignia is valid. The insignia validation if verified by the POS and the mobile user device does not may require network connectivity. This method may be used to pay for transactions of small amounts for example, without limitation, under 2610 dollars or any limit set by the client designer. In order to perform a quick transaction, the POS agent scans an insignia from the user's mobile device. The amount is debited from a preconfigured configured default account; this default account is set by the user or the POS as a preferred account for the transaction. Then, a confirmation receipt is sent to the displays the POS system and optionally to the mobile device if network connectivity is available. This method does not may require mobile user interaction other than presenting the mobile device for insignia scanning. The mobile user is not required to enter a passcode for payment settlement. Only authentication is required for this method, and, if successful, the POS receives confirmation of settlement. This type of transaction is comparable to already in use credit card transactions for small amounts that do not may require a customer signature. This method facilitates and speeds up the transactions. This method could be used, for example, without limitation, to pay toll fees. For example, without limitation, a user driving across a bridge may present his mobile device to be scanned for payment. In other non-limiting examples, a user driving through a self-service restaurant drive-though may pay for a meal by scanning his mobile device, or another user may pay for a car wash by scanning his mobile device. Alternate embodiments may not include the option of a quick transaction. Other alternate embodiments may be implemented that only perform quick transactions, and may perform these quick transactions for larger amounts.

Various different types of transactions may be performed using preferred embodiments of the present invention such as, but not limited to, POS payments, remote payments, mobile-to-mobile payments, ticket transactions, POS credits, cash back transactions, automated teller machine (ATM) operations, etc. When paying for products or services at a POS, customers may carry only their cell phones or other mobile devices to pay for products and services. There is no need to carry credit cards, debit cards or store cards. The customer may select the method of payment on the mobile device display, and the account selected is the one debited. As in typical POS transactions, the customer brings the products to the cashier; the products are then scanned and added to the bill. Once the final bill is ready, the POS agent scans the mobile device insignia for payment. The customer then chooses the account to be debited and accepts or declines the transaction.

Some embodiments may enable remote payments to be made away from a POS, for example, without limitation, in restaurants. In these embodiments wireless scanners are used to enable customers to pay restaurant bills at the table. When the bill is requested, the server brings a mobile scanner to the table and scans the user's mobile device for payment. The customer is then presented with the option to add tip and to choose the account to be debited one or more from the mobile device display.

In some embodiments, the Transaction Identification System may be used between mobile devices to transmit payments between mobile users if the mobile devices are equipped with cameras and related software. For instance, without limitation, a mobile user may pay another mobile user and receive the funds in their PayPal or Google Check out accounts.

In some embodiments, access to movies and other events such as, but not limited to, plays, concerts, art shows, etc. may be granted upon scanning a mobile device display. The ticketing agent may use a wireless scanner at the entrance of the venue to charge the mobile user. This may be accomplished in using two methods. The quick transaction method may be used for a small amount where one or more that is required for the mobile user is to present the mobile insignia, or the standard method may be used, which gives the user the option to accept or deny the charge and to select the account to be debited. In the quick transaction method, the default account to be debited may be preconfigured or assigned by the POS as a preferred account or chosen by the user.

POS credits are performed similarly to typical payment transactions. The customer presents the insignia at a POS, the insignia is scanned, and the account debited in the first place is credited the amount of the transaction. Credits may or may not require a passcode. Reservations may be performed in similar fashion as with credit cards. The POS agent scans the mobile device and preauthorizes a charge to hold the reservation.

In some embodiments cash back and ATM operations may also be performed. In embodiments that enable the user to receive cash back, the Transaction Identification System may provide a cash back option as it exists with debit cards. When purchasing products at a store, the mobile user has the option to get cash back if desired. Once the operation is approved, the POS agent gives the cash to the mobile user in the amount requested. The Transaction Identification System may also be implemented at ATMs. In these embodiments the user's mobile device performs one or more of the electronic operations of the ATM such as, but not limited to, authentication, account selection, transfers, receipts, etc. and the ATM performs the physical transactions with the user such as, but not limited to, dispensing cash, check deposits, withdrawals, etc. Mobile users may therefore withdraw or deposit money by scanning their mobile devices at ATMs.

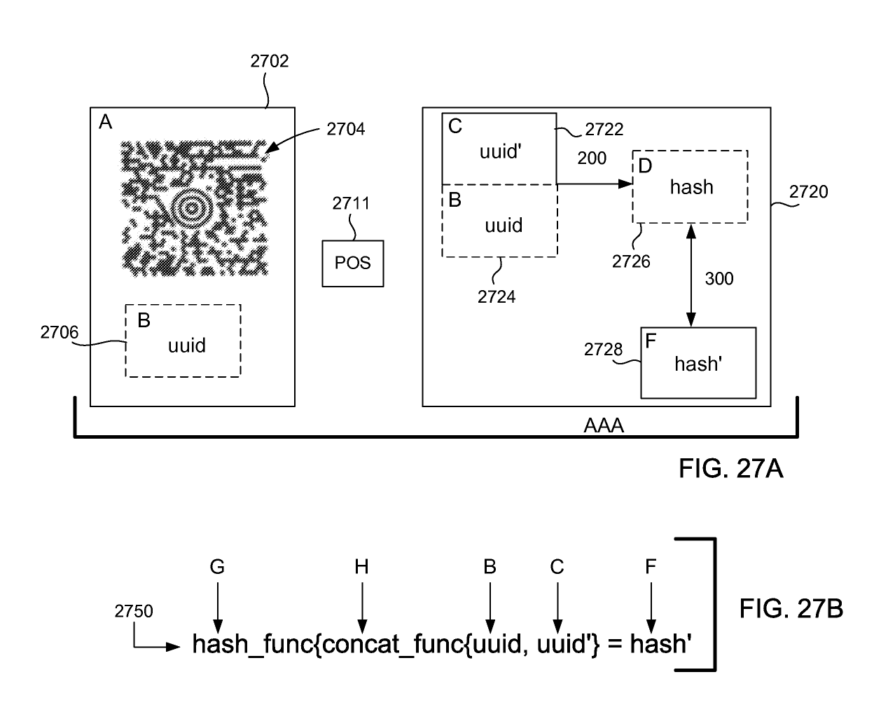

FIG. 27 shows the steps and the functions involved to authenticate the mobile device insignia in accordance to one embodiment.

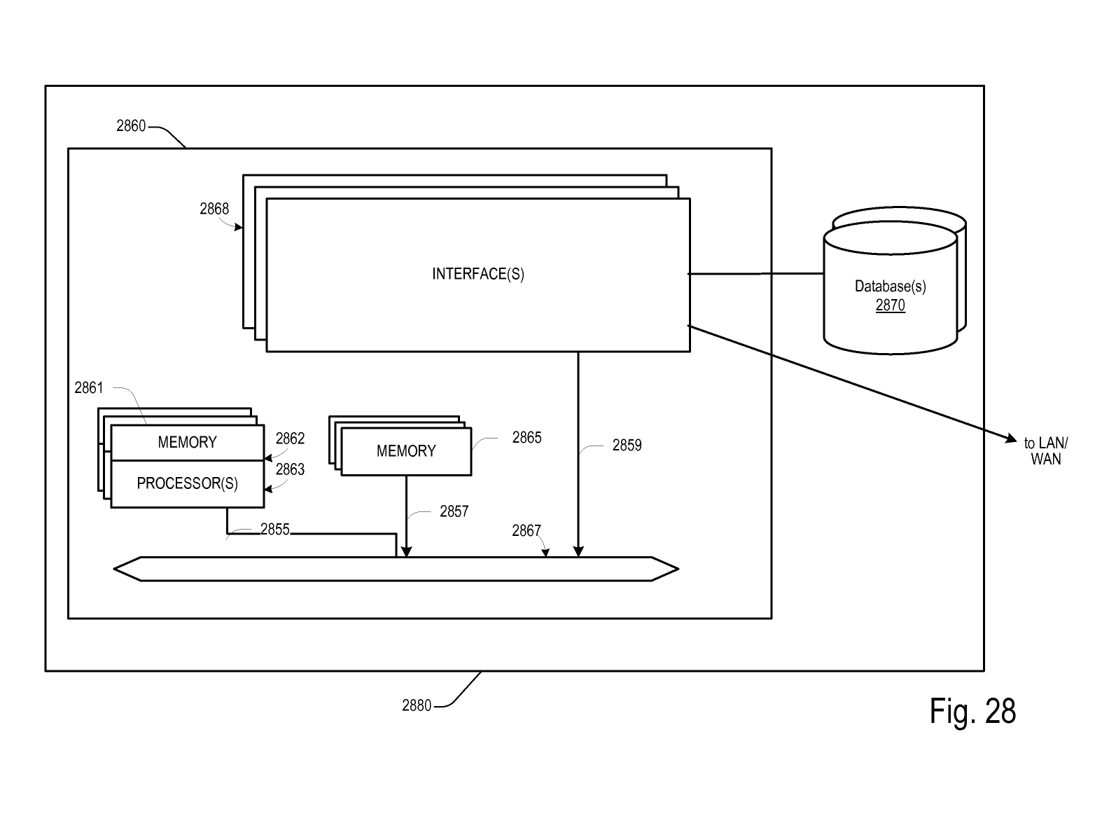

FIG. 28 illustrates an example embodiment of a Transaction Identification Server System 2880 which may be used for implementing various aspects/features described herein. In at least one embodiment, the server system 2880 includes at least one network device 2860, and at least one storage device 2870 (such as, for example, a direct attached storage device). In one embodiment, server system 2880 may be suitable for implementing at least some of the various Transaction Identification techniques described herein.

In according to one embodiment, network device 2860 may include a master central processing unit (CPU) 2862, interfaces 2868, and a bus 2867 (e.g., a PCI bus). When acting under the control of appropriate software or firmware, the CPU 2862 may be responsible for implementing specific functions associated with the functions of a desired network device. For example, when configured as a server, the CPU 2862 may be responsible for analyzing packets; encapsulating packets; forwarding packets to appropriate network devices; instantiating various types of virtual machines, virtual interfaces, virtual storage volumes, virtual appliances; etc. The CPU 2862 preferably accomplishes at least a portion of these functions under the control of software including an operating system (e.g. Linux), and any appropriate system software (such as, for example, virtualization software, enterprise software, etc.).

CPU 2862 may include one or more processors 2863 such as, for example, one or more processors from the AMD, Motorola, Intel and/or MIPS families of microprocessors. In an alternative embodiment, processor 2863 may be specially designed hardware for controlling the operations of server system 2880. In a specific embodiment, a memory 2861 (such as non-volatile RAM and/or ROM) also forms part of CPU 2862. However, there may be many different ways in which memory could be coupled to the system. Memory block 2861 may be used for a variety of purposes such as, for example, caching and/or storing data, programming instructions, etc.

The interfaces 2868 may be typically provided as interface cards (sometimes referred to as “line cards”). Alternatively, one or more of the interfaces 2868 may be provided as on-board interface controllers built into the system motherboard. Generally, they control the sending and receiving of data packets over the network and sometimes support other peripherals used with the server system 80. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

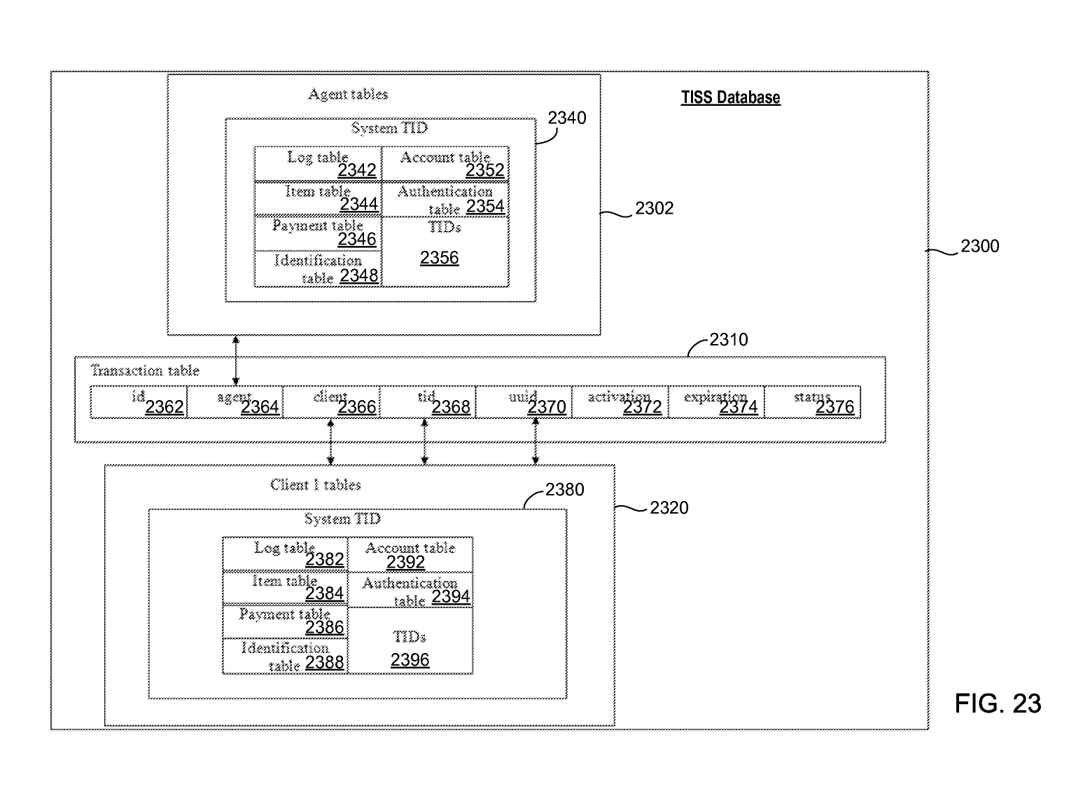

An example of at least a portion of the different types of tables, fields, and/or other information which may be stored at the Transaction Identification Server Database (and/or Mobile Client Device database) is illustrated in FIG. 23.

FIG. 23 illustrates components of an example Transaction Identification Server System database architecture in accordance with a specific embodiment.

In at least one embodiment, at least a portion of database(s) 2870 may include, but are not limited to, one or more of the following types of tables and/or data fields (or combinations thereof):

1.1 Table userAccount - stores user account data

id
systemTID
label
cc_number
cc_month
cc_year
cc_cvv
info
type
preference
status

1.2 Table userAccountType - type of user account (visa, mc,
amex . . . etc)

id
cc_name
code
description
type
pp_type
pt_type
fd_type
achw_type
status

1.3 Table authentication - authentication tid
table (being used only for the web)

id
transaction
systemTID
begin
end
log
type
status

1.4 Table encoder - Barcode

id
type
name
options
xScale
yScale
x
y
xTranslate
yTranslate
rot
llx
lly
urx
ury
density
resize
quality
text
status

1.5 Table encoderType - Barcode type

id
name
status

1.6 Table fees - used to set up transactions fees

id
low
high
percentage
amount
reversal
status
type

1.7 Table identification - holds indentification
data (passports, drivers license . . . )

id
opt1
opt2
opt3
status
transaction
type

1.8 Table im - links to instant messaging gateways

id
transaction
opt1
opt2
opt3
type
status

1.9 Table info - user information

active
address1
address2
city
comment
company
country
email
firstname
id
kodeid
label
lastname
postalcode
state
telephone
timezone
type

1.10 Table infoType - user type of information
(personal, business)

id
name
code
description
type
status

1.11 Table item - part of payment - items in the transaction

amount1
amount2
amount3
code
description
discount
id
name
opt1
opt2
opt3
preference
price
quantity
sku
status
total
transaction
weight

1.12 Table systemTID - System transaction identifier table

id
tid
begin
end
hash
encoder
password
ps
b64
image
type
status

1.13. Table tid - temporary transaction identifiers table

begin
end
id
systemTID
tid
status
type

1.14 Table option - list of options available to the user based on what
they registered (id, payment, etc)

id
kodeid
type
status

1.15 Table payment - links to payment gateways

account
currency
fee
gateway
id
opt1
opt2
savings
status
subtotal
tax
total
transaction
type

Standard PayPal API Tables such as, for example:
1.16 Table pp_ns1_DoCaptureResponseType
1.17 Table pp_ns1_DoDirectPaymentResponseTypes
1.18 Table pp_ns1_refundTransactionResponseType
1.19 Table pp_ns1_BasicAmountType
1.20 Table pp_ns3_AbstractResponseType
1.21 Table pp_ns3_CountryCodeType
1.22 Table pp_ns3_CreditCardType
1.23 Table pp_ns3_CurrencyCodeType
1.24 Table pp_ns3_DoCaptureResponseDetailsType
1.25 Table pp_ns3_ErrorType
1.26 Table pp_ns3_FMFDetailsType
1.27 Table pp_ns3_PaymentActionCodeType
1.28 Table pp_ns3_PaymentInfoType
1.29 Table pp_ns3_ThreeDSecureResponseType
1.30 Table pp_ns3_UserIdPasswordType

1.31 Table security_info - http environmental variables, hardware
variables

cell
hash
http_accept
http_accept_charset
http_accept_encoding
http_accept_language
http_host
http_user_agent
id
imei
ip
location
mac
remote_addr
remote_port
request_method
request_uri
server_protocol
status
token
transaction
whois

1.32 Table status - initiated, processing, complete

id
out
level
code
type
status

1.33 Table system_log - system level errors

file
function
hostname
id
level
line
message
security_info
status

1.34 Table timezoneSet - used for time zone conversion

id
timezone

1.35 Table transaction - Agent sends data to this table when initiating
a transaction. For example:
uuid0 = TID
uuid1 = 307d5bbb-bdd3-4715-a9a0-efdd844596b2 system TID or
web-site TID

| | |
|---|---|
| agent | |
| authorization | |
| begin | |
| client | |
| end | |
| id | |
| log | |
| reference | |
| status | 0 |
| type | |
| uuid0 | |
| uuid1 | |

1.36 Table transactionType - type of transactions (payment,
authentication, identification, im, system initialization, refund, void,
capture)

id
label
code
type
active
description

1.37 Table template - part of the QR code, html code, barcode templates,
image format etc.

cComment
cLabel
cTemplate
uTemplate
uTemplateSet
uTemplateType

1.38 Table templateType - type of template, image, postscript,
html. Jpg, png, etc.

uTemplateSet
cLabel

1.39 Table userLog - user logging

account
description
id
info
item
kodeid
level
security_info
status
transaction

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 2862 to efficiently perform routing computations, network diagnostics, security functions, etc.

In at least one embodiment, some interfaces may be configured or designed to allow the server system 2880 to communicate with other network devices associated with various local area network (LANs) and/or wide area networks (WANs). Other interfaces may be configured or designed to allow network device 2860 to communicate with one or more direct attached storage device(s) 2870.

Although the system shown in FIG. 28 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 2865, which, for example, may include random access memory (RAM)) configured to store data, program instructions for the general-purpose network operations and/or other information relating to the functionality of the various electronic transaction techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Examples of program instructions include both machine code, such as produced by a compiler, and files containing higher level code that may be executed by the computer using an interpreter.

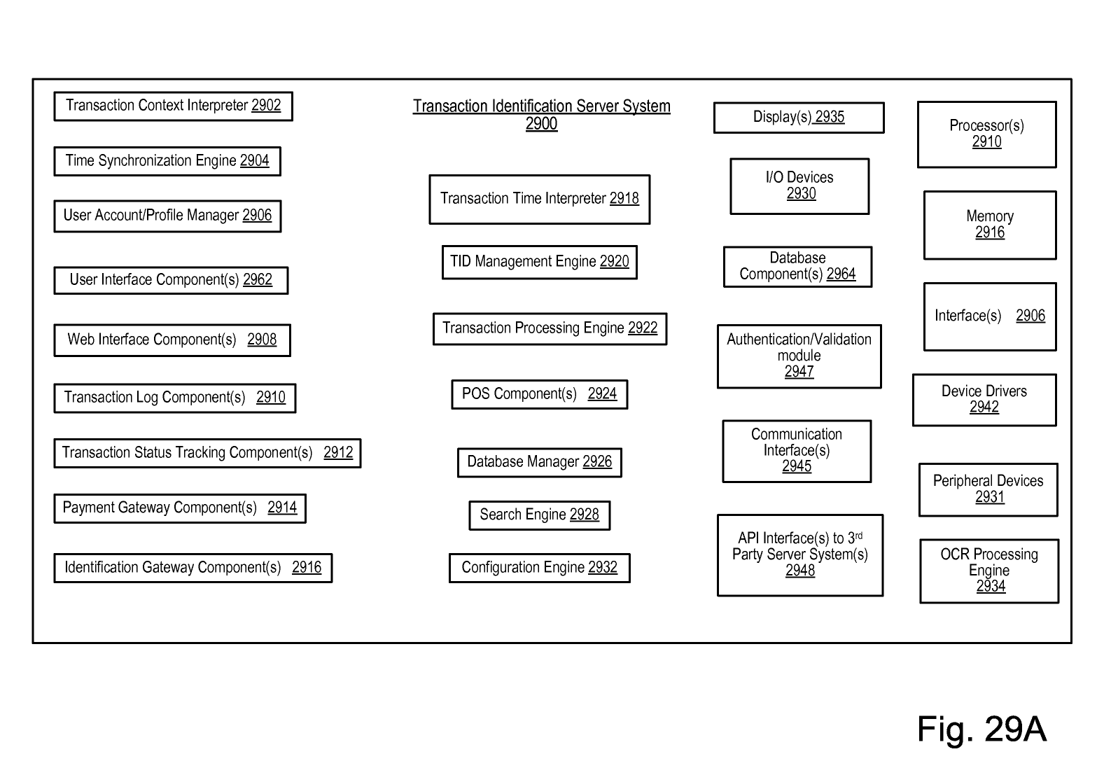

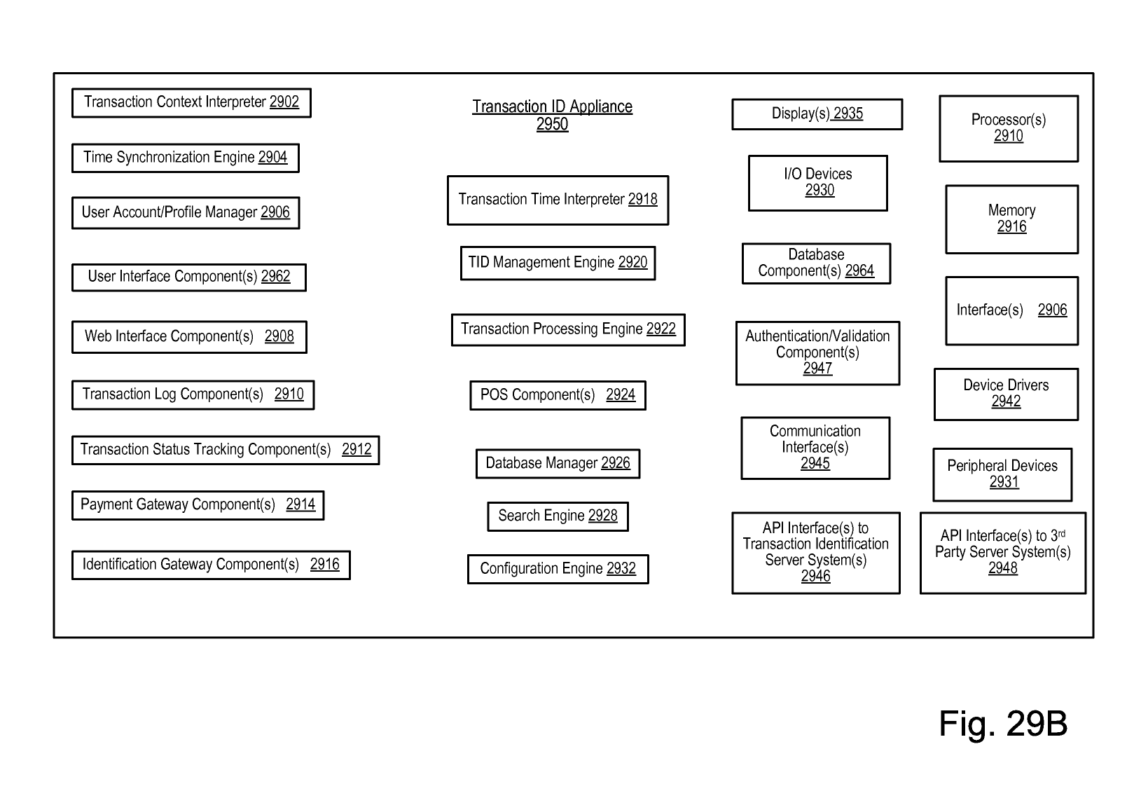

FIG. 29A illustrates an example of a functional block diagram of a Transaction Identification Server System in accordance with a specific embodiment.

FIG. 29B illustrates an example of a functional block diagram of a Transaction Identification Appliance in accordance with a specific embodiment.

In at least one embodiment, the Transaction Identification Server System(s) and/or Transaction Identification Appliance(s) may include a plurality of components operable to perform and/or implement various types of functions, operations, actions, and/or other features such as, for example, one or more of the following (or combinations thereof):
Transaction Context Interpreter (e.g., 2902) which, for example, may be operable to automatically and/or dynamically analyze contextual criteria relating to a given transaction, and automatically determine or identify the type of transaction to be performed (e.g., payment-related transaction, identification-related transaction, universal shopping cart-related transaction, etc.). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of Client user
   identity of Agent user
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
   etc.

For example, in at least one embodiment, the Transaction Identification Server System could determine that if a customer is using a mobile Transaction Identification client device at the airport (Location obtained via GPS), the customer is planning to check in or identify himself with an airport agent.
Time Synchronization Engine (e.g., 2904) which, for example, may be operable to manages universal time synchronization (e.g., via NTP and/or GPS)
Search Engine (e.g., 2928) which, for example, may be operable to search for transactions, logs, items, accounts, options in the TIS databases
Configuration Engine (e.g., 2932) which, for example, may be operable to determine and configure activation and expiration settings for one or more TIDs. In at least one embodiment, the Configuration Engine may also be operable to manage various types of TIS database information such as, for example, user credit card/payment accounts, device associations, user identification information, payment gateway information, etc.
Transaction Time Interpreter (e.g., 2918) which, for example, may be operable to automatically and/or dynamically modify or change TID activation and expiration time(s) based on various criteria such as, for example, time, location, transaction status, etc.
TID Management Engine (e.g., 2920) which, for example, may be operable to handle TID generation, delivery and management including, for example, one or more of the following (or combinations thereof):
   generating randomized TIDs
   associating TIDs with information databases
   providing TIDs to client/agent devices
   managing, replacing, invalidating, revoking, blacklisting TIDs
   maintaining TID database(s)
   etc.
Authentication/Validation Component(s) (e.g., 2947) (password, software/hardware info, TID, SSL certificates) which, for example, may be operable to perform various types of authentication/validation tasks such as, for example, one or more of the following (or combinations thereof):
   verifying/authenticating devices,
   verifying passwords, passcodes, SSL certificates, biometric identification information, and/or other types of security-related information
   verify/validate TID activation and/or expiration times
   etc.

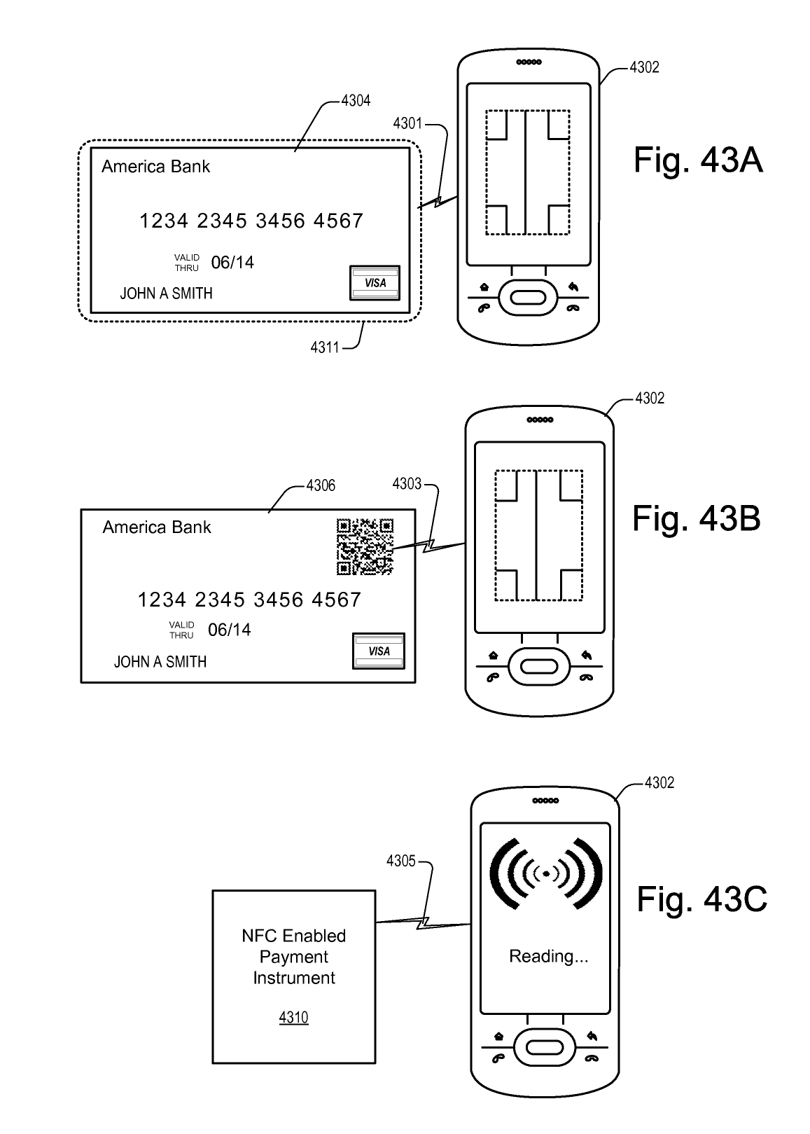

In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 2922) which, for example, may be operable to handle various types of transaction processing tasks such as, for example, one or more of the following (or combinations thereof):
   identifying/determining transaction type
   determining which payment gateway(s) to use
   associating databases information to TIDs
   etc.
OCR Processing Engine (e.g., 2934) which, for example, may be operable to perform image processing and optical character recognition of images such as those captured by a mobile device camera, for example.
Database Manager (e.g., 2926) which, for example, may be operable to handle various types of tasks relating to database updating, database management, database access, etc. In at least one embodiment, the Database Manager may be operable to manage TISS databases, Transaction Identification Device Application databases, Transaction ID Appliance databases, etc.
Transaction Log Component(s) (e.g., 2910) which, for example, may be operable to generate and manage transactions history logs, system errors, connections from APIs, etc.
Transaction Status Tracking Component(s) (e.g., 2912) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Payment Gateway Component(s) (e.g., 2914) which, for example, may be operable to facilitate and manage communications and transactions with external Payment Gateways.
Identification Gateway Component(s) (e.g., 2916) which, for example, may be operable to facilitate and manage communications and transactions with external Identification Gateways
POS Component(s) (e.g., 2924) which, for example, may be operable to facilitate and manage communications and transactions with external POS gateways/systems.
Web Interface Component(s) (e.g., 2908) which, for example, may be operable to facilitate and manage communications and transactions with TIS web portal(s).
API Interface(s) to Transaction Identification Server System(s) (e.g., 2946) which, for example, may be operable to facilitate and manage communications and transactions with API Interface(s) to Transaction Identification Server System(s)
API Interface(s) to 3rd Party Server System(s) (e.g., 2948) which, for example, may be operable to facilitate and manage communications and transactions with API Interface(s) to 3rd Party Server System(s)
OCR Processing Engine (e.g., 2934) which, for example, may be operable to perform image processing and optical character recognition of images such as those captured by a mobile device camera, for example. In at least one embodiment, the OCR Processing Engine may be configured or designed to process an image of a credit card or ATM card (e.g., captured by a mobile device camera), and extract relevant information from the credit/ATM card image such as, for example, one or more of the following (or combinations thereof):
   credit card account number
   financial institution information (e.g., bank name, Visa, MasterCard, etc.)
   TID information (e.g., as illustrated, for example, in FIG. 43B)
   card holder name
   card expiration date
   card type information (e.g., credit card, ATM card, etc.)
   etc.
At least one processor 2910. In at least one embodiment, the processor(s) 2910 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 2916, which, for example, may include volatile memory (e.g., RAM), non-volatile memory (e.g., disk memory, FLASH memory, EPROMs, etc.), unalterable memory, and/or other types of memory. In at least one implementation, the memory 2916 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, Transaction ID information/images, and/or information/data relating to other features/functions described herein. Because such information and program instructions may be employed to implement at least a portion of the Transaction Identification System techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 2906 which, for example, may include wired interfaces and/or wireless interfaces. In at least one implementation, the interface(s) 2906 may include functionality similar to at least a portion of functionality implemented by one or more computer system interfaces such as those described herein and/or generally known to one having ordinary skill in the art.
Device driver(s) 2942. In at least one implementation, the device driver(s) 2942 may include functionality similar to at least a portion of functionality implemented by one or more computer system driver devices such as those described herein and/or generally known to one having ordinary skill in the art.
One or more display(s) 2935. According to various embodiments, such display(s) may be implemented using, for example, LCD display technology, OLED display technology, and/or other types of conventional display technology. In at least one implementation, display(s) 2935 may be adapted to be flexible or bendable. Additionally, in at least one embodiment the information displayed on display(s) 2935 may utilize e-ink technology (such as that available from E Ink Corporation, Cambridge, Mass., www.eink.com), or other suitable technology for reducing the power consumption of information displayed on the display(s) 2935.
Etc.

FIG. 29B illustrates an example of a functional block diagram of a Transaction Identification Appliance in accordance with a specific embodiment. According to different embodiments, a Transaction Identification Appliance may:
be deployed w/in enterprise's internal LAN
provide similar functionality to TISS except that the enterprise (where Appliance is installed) has control of hardware/software
provide secure way of providing access to secure data
enable secure communications between TISS and TISS Appliances running w/in trusted source's network (e.g., DMV records, Bank records, Medical records, Government records, etc.)

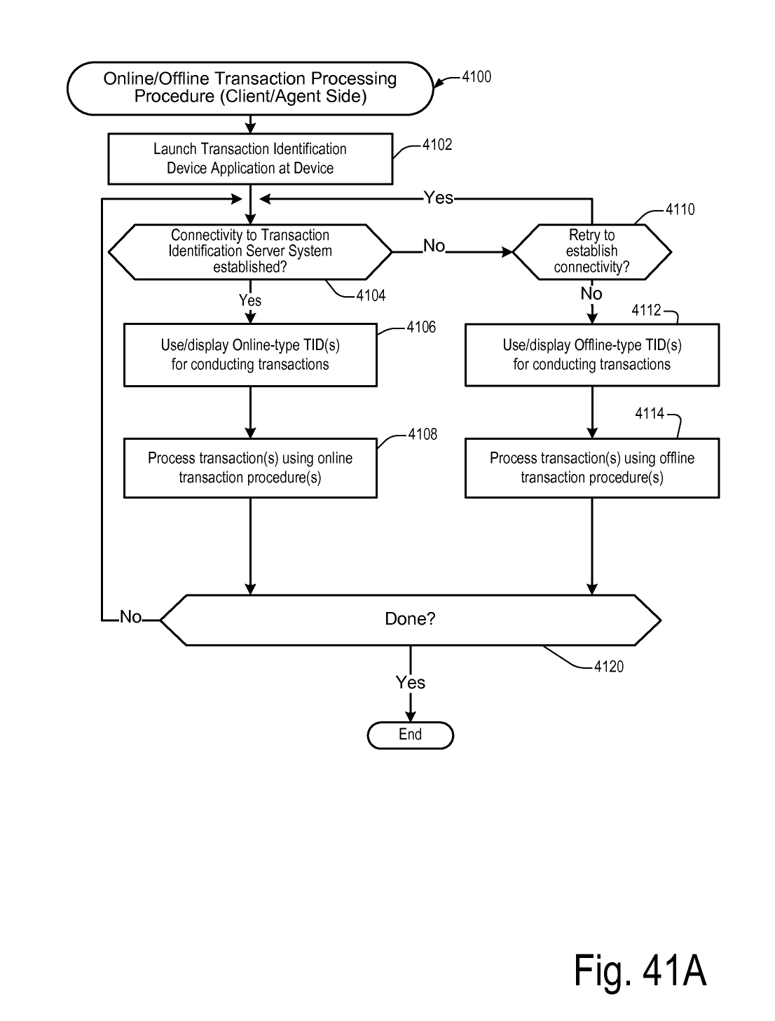

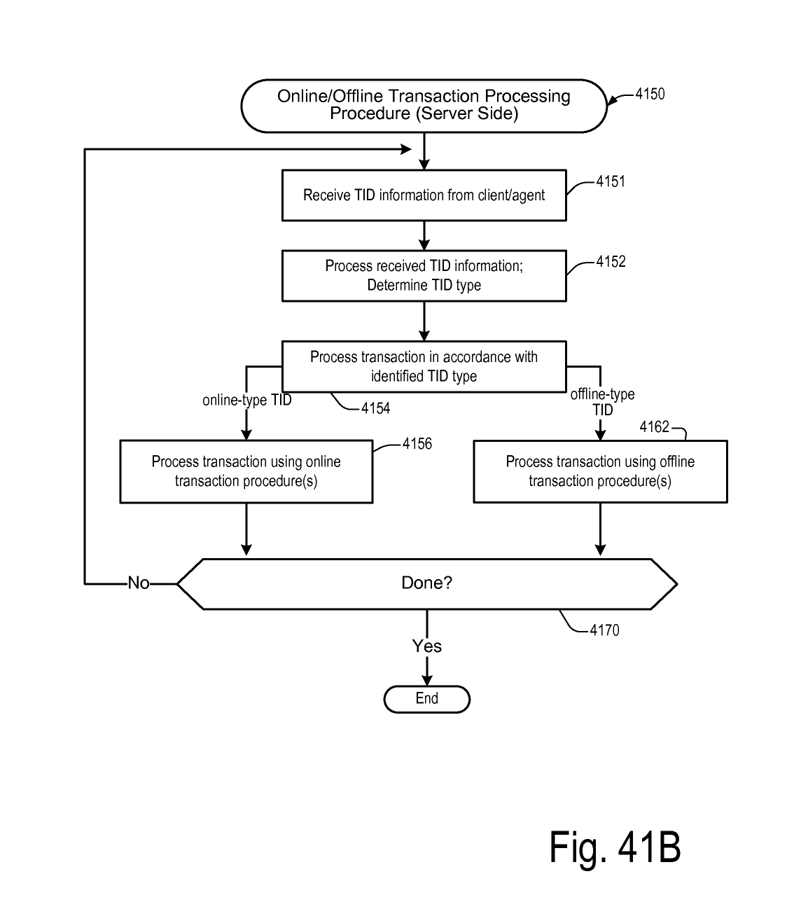

FIG. 41A shows a flow diagram of a Client/Agent Online/Offline Transaction Processing Procedure in accordance with a specific embodiment.

In at least one embodiment, the Client/Agent Online/Offline Transaction Processing Procedure may be initiated at the Client Device, Agent Device, and/or at other devices and/or systems of the TIS, and may be operable to perform and/or implement various types of functions, operations, actions, and/or other features such as, for example, one or more of the following (or combinations thereof):
Determining whether an identified device (e.g., Client Device) is able to establish connectivity to the Transaction Identification Server System.
Causing or facilitating transactions to be processed in accordance with online transaction procedure(s) in response to detecting that the identified device is able to establish connectivity to the TISS.
Causing or facilitating transactions to be processed in accordance with offline transaction procedure(s) in response to detecting that the identified device is not able to establish connectivity to the TISS.
Causing or facilitating an online-type TID to be displayed at the identified device in response to detecting that the identified device is able to establish connectivity to the TISS.
Causing or facilitating an offline-type TID to be displayed at the identified device in response to detecting that the identified device is not able to establish connectivity to the TISS.
etc.

According to specific embodiments, multiple instances or threads of the Client/Agent Online/Offline Transaction Processing Procedure may be concurrently implemented and/or initiated via the use of one or more processors and/or other combinations of hardware and/or hardware and software.

For example, in at least some embodiments, various aspects, features, and/or functionalities of the Client/Agent Online/Offline Transaction Processing mechanism(s) may be performed, implemented and/or initiated by one or more of the following types of systems, components, systems, devices, procedures, processes, etc. (or combinations thereof):
Mobile devices
Client/Agent Computer systems
Transaction Identification Device Application software
etc.

According to different embodiments, one or more different threads or instances of the Client/Agent Online/Offline Transaction Processing Procedure may be initiated in response to detection of one or more conditions or events satisfying one or more different types of criteria (such as, for example, minimum threshold criteria) for triggering initiation of at least one instance of the Client/Agent Online/Offline Transaction Processing Procedure. Examples of various types of conditions or events which may trigger initiation and/or implementation of one or more different threads or instances of the Client/Agent Online/Offline Transaction Processing Procedure may include, but are not limited to, one or more of the following (or combinations thereof):
detecting the launching of a Transaction Identification Device Application at a Client Device and/or Agent Device;
receiving input or instructions from a user to perform a TIS related transaction
detecting a condition or event for causing a Transaction ID to be displayed at a Client Device and/or Agent Device
detecting or receiving a request to initiate the Client/Agent Online/Offline Transaction Processing Procedure
etc.

According to different embodiments, one or more different threads or instances of the Client/Agent Online/Offline Transaction Processing Procedure may be initiated and/or implemented manually, automatically, statically, dynamically, concurrently, and/or combinations thereof. Additionally, different instances and/or embodiments of the Client/Agent Online/Offline Transaction Processing Procedure may be initiated at one or more different time intervals (e.g., during a specific time interval, at regular periodic intervals, at irregular periodic intervals, upon demand, etc.).

In at least one embodiment, a given instance of the Client/Agent Online/Offline Transaction Processing Procedure may utilize and/or generate various different types of data and/or other types of information when performing specific tasks and/or operations. This may include, for example, input data/information and/or output data/information. For example, in at least one embodiment, at least one instance of the Client/Agent Online/Offline Transaction Processing Procedure may access, process, and/or otherwise utilize information from one or more different types of sources, such as, for example, one or more databases. In at least one embodiment, at least a portion of the database information may be accessed via communication with one or more local and/or remote memory devices. Additionally, at least one instance of the Client/Agent Online/Offline Transaction Processing Procedure may generate one or more different types of output data/information, which, for example, may be stored in local memory and/or remote memory devices.

As illustrated in the example embodiment of FIG. 41A, at 4102 it is assumed that an instance of the Transaction Identification Device Application is initiated or launched at a given device (e.g., Client Device, Agent Device, etc.)

As illustrated in the example embodiment of FIG. 41A, at 4104 a determination may be made as to whether or not connectivity to Transaction Identification Server System is able to be established.

In at least one embodiment, if it is determined that connectivity to Transaction Identification Server System is established, one or more actions(s)/operation(s) may be initiated such as, for example, one or more of the following (or combinations thereof):
Use (or cause to be displayed) (4106) Online-type TID(s) for conducting transactions;
Process (4108) transaction(s) using online transaction procedure(s);
etc.

In at least one embodiment, if it is determined that connectivity to the Transaction Identification Server System cannot be established, one or more actions(s)/operation(s) may be initiated such as, for example, one or more of the following (or combinations thereof):
Determine (4110) whether additional attempt(s) should be performed to establish connectivity to the Transaction Identification Server System;
Use (or cause to be displayed) (4112) Offline-type TID(s) for conducting transactions;
Process (4114) transaction(s) using offline transaction procedure(s);
etc.

In at least one embodiment, if it is determined (e.g., at 4104) that connectivity to the Transaction Identification Server System cannot be established, one or more additional attempt(s) may be performed to establish connectivity to the Transaction Identification Server System, in accordance with specific criteria such as, for example, one or more of the following (or combinations thereof):
retry to establish connectivity to the TISS for specified time interval
retry to establish connectivity to the TISS a predetermined number of times
query the user for permission to retry to establish connectivity to the TISS
etc.

It will be appreciated that different embodiments of the Client/Agent Online/Offline Transaction Processing Procedure (not shown) may include additional features and/or operations than those illustrated in the specific embodiment of FIG. 41A, and/or may omit at least a portion of the features and/or operations of Client/Agent Online/Offline Transaction Processing Procedure illustrated in the specific embodiment of FIG. 41A.

FIG. 41B shows a flow diagram of a Server Online/Offline Transaction Processing Procedure in accordance with a specific embodiment.

In at least one embodiment, the Server Online/Offline Transaction Processing Procedure may be initiated at the Transaction Identification Server System, and/or at other devices and/or systems of the TIS, and may be operable to perform and/or implement various types of functions, operations, actions, and/or other features such as, for example, one or more of the following (or combinations thereof):
Determining whether an identified device (e.g., Client Device) is able to establish connectivity to the Transaction Identification Server System.
Analyzing TID information (such as, for example, a scanned Transaction ID) received from a device (e.g., Client Device or Agent Device), and determining/identifying a TID type (e.g., online-type TID, offline-type TID) associated with the received TID information.
Causing or facilitating transactions to be processed in accordance with online transaction procedure(s) in response to identifying a received Transaction ID as an online-type TID.
Causing or facilitating transactions to be processed in accordance with offline transaction procedure(s) in response to identifying a received Transaction ID as an offline-type TID.
Causing or facilitating transactions to be processed in accordance with online transaction procedure(s) in response to detecting that the identified device is able to establish connectivity to the TISS.
Causing or facilitating transactions to be processed in accordance with offline transaction procedure(s) in response to detecting that the identified device is not able to establish connectivity to the TISS.
Causing or facilitating an online-type TID to be displayed at the identified device in response to detecting that the identified device is able to establish connectivity to the TISS.
Causing or facilitating an offline-type TID to be displayed at the identified device in response to detecting that the identified device is not able to establish connectivity to the TISS.
etc.

According to specific embodiments, multiple instances or threads of the Server Online/Offline Transaction Processing Procedure may be concurrently implemented and/or initiated via the use of one or more processors and/or other combinations of hardware and/or hardware and software.

For example, in at least some embodiments, various aspects, features, and/or functionalities of the Server Online/Offline Transaction Processing mechanism(s) may be performed, implemented and/or initiated by one or more of the following types of systems, components, systems, devices, procedures, processes, etc. (or combinations thereof):
Transaction Identification Server System(s)
Transaction Identification Appliance(s)
etc.

According to different embodiments, one or more different threads or instances of the Server Online/Offline Transaction Processing Procedure may be initiated in response to detection of one or more conditions or events satisfying one or more different types of criteria (such as, for example, minimum threshold criteria) for triggering initiation of at least one instance of the Server Online/Offline Transaction Processing Procedure. Examples of various types of conditions or events which may trigger initiation and/or implementation of one or more different threads or instances of the Server Online/Offline Transaction Processing Procedure may include, but are not limited to, one or more of the following (or combinations thereof):
receiving TID information from a device such as, for example, a Client Device and/or Agent Device;
detecting an event or condition relating to the initiation (or attempted initiation) of TIS-related transaction;
detecting or receiving a request to initiate the Server Online/Offline Transaction Processing Procedure;
detecting an event or condition which may trigger an analysis of received TID information relating to a TIS-related transaction;
etc.

According to different embodiments, one or more different threads or instances of the Server Online/Offline Transaction Processing Procedure may be initiated and/or implemented manually, automatically, statically, dynamically, concurrently, and/or combinations thereof. Additionally, different instances and/or embodiments of the Server Online/Offline Transaction Processing Procedure may be initiated at one or more different time intervals (e.g., during a specific time interval, at regular periodic intervals, at irregular periodic intervals, upon demand, etc.).

In at least one embodiment, a given instance of the Server Online/Offline Transaction Processing Procedure may utilize and/or generate various different types of data and/or other types of information when performing specific tasks and/or operations. This may include, for example, input data/information and/or output data/information. For example, in at least one embodiment, at least one instance of the Server Online/Offline Transaction Processing Procedure may access, process, and/or otherwise utilize information from one or more different types of sources, such as, for example, one or more databases. In at least one embodiment, at least a portion of the database information may be accessed via communication with one or more local and/or remote memory devices. Additionally, at least one instance of the Server Online/Offline Transaction Processing Procedure may generate one or more different types of output data/information, which, for example, may be stored in local memory and/or remote memory devices.

As illustrated in the example embodiment of FIG. 41B, at 4151 it is assumed that TID information (e.g., relating to a scanned TID) is received from a device such as, for example, a Client Device or Agent Device). In at least one embodiment, the received TID information may relate to a transaction which is to be performed by or facilitated by the Transaction Identification Server System.

As shown at 4152, the received TID information may be processed or analyzed, for example, in order to determine or identify a TID type (e.g., online-type TID, offline-type TID, etc.) associated with the received TID information

As shown at 4154, in at least one embodiment, the processing of a transaction relating to the received TID information may be affected by (and/or may be performed in accordance with) the identified TID type associated with the received TID information.

For example, in at least one embodiment, if it is determined that the received TID information corresponds to an online-type TID, transaction(s) relating to that particular TID information may be processed (4156) using online transaction procedure(s). Alternatively, if it is determined that the received TID information corresponds to an offline-type TID, transaction(s) relating to that particular TID information may be processed (4162) using offline transaction procedure(s).

It will be appreciated that different embodiments of the Server Online/Offline Transaction Processing Procedure (not shown) may include additional features and/or operations than those illustrated in the specific embodiment of FIG. 41B, and/or may omit at least a portion of the features and/or operations of Server Online/Offline Transaction Processing Procedure illustrated in the specific embodiment of FIG. 41B.

FIG. 31A shows a specific example embodiment of an interaction diagram illustrating various communication flows and actions which may be initiated and/or performed during an example mobile-mobile payment transaction. For purposes of illustration, the interaction diagram of FIG. 31A will now be described by way of example with reference to the FIGS. 7A-7B. In this particular example, it is assumed that the users of mobile devices A and B desire to conduct a payment transaction with each other using their respective mobile devices. Additionally, in this particular example, it is assumed that the user of Mobile Device B (3104) is a merchant or vendor who desires to receive a payment from the user of Mobile Device A (3102) for goods and/or services.

As illustrated in the example embodiment of FIG. 31A, at 2b it is assumed user A uses Transaction Identification Device Application software running on Mobile Device A (herein referred to as the “Client Device”) to display a Transaction ID (TID) (e.g., 706a, FIG. 7A) on the display of Client Device.

As shown at 4b, it is assumed that user B (e.g., the “merchant”) uses Transaction Identification Device Application software running on Mobile Device B (herein referred to as the “Agent Device”) to scan or read the TID displayed at the Client Device.

As shown at 6b, 8b, Agent Device may present a GUI (e.g., 708, FIG. 7B) prompting the user (e.g., merchant) to input security authentication credentials such as, for example, a personalized passcode, PIN, password, biometric data, etc.

As shown at 10b, the Agent Device may process the merchant's input. Additionally, in at least one embodiment, the Transaction Identification Device Application running at the Agent Device may also acquire contextual information relating to the Agent Device, the merchant, the transaction to be performed, etc. In at least one embodiment, the acquire contextual information may be used to aid the Transaction Identification Device Application and/or Transaction Identification Server System in automatically identifying and/or determining one or more of the following (or combinations thereof):
the type(s) of transaction(s) that is intended (or that is permitted) to be performed between the two parties (e.g., Is the scanned TID to be used for a payment transaction, an identification transaction, a universal shopping cart transaction, etc.? What types of transactions are not permitted to be performed under the currently detected conditions?)
the relative roles each user is to play in the transaction (e.g., Does user A/mobile device A represent the client or agent? Does user B/mobile device B, represent the client or agent? etc.)
the types of documents and/or other information to be generated for the transaction (e.g., invoices, forms, templates, product/service descriptions, pricing information, etc.)
payment method(s) which are available (and/or allowed) for use in the present transaction.
etc.

According to different embodiments, examples of the various different types of contextual information which may be acquired may include, but are not limited to, one or more of the following (or combinations thereof):
time/date information
content displayed at either of the mobile devices
prior activities of the mobile device(s)
prior activities of the user(s)
location-based information (e.g., geolocation of client device, geolocation of agent device, etc.)
identity of Client user
identity of Agent user
user profile information
transaction history information
proximate business-related information (e.g., information which may be used to determine whether the client device is currently located at or near a recognized business establishment such as a bank, gas station, restaurant, supermarket, etc.)
etc.

As shown at 12b, the Agent Device may transmit information to the TISS 3106, such as, for example, the merchant's authentication credentials, Agent Device authentication credentials, TID information (e.g., relating to the scanned Client Device TID), contextual information, transaction type information (which, for example, may be manually input by the merchant), etc.

As shown at 14b, the TISS may process the information received from the Agent Device. In at least one embodiment, the TISS may use at least a portion of the received information to authenticate and/or verify the merchant's/agent's authentication credentials. In the present example of FIG. 31A, it is assumed that the TISS successfully authenticates the merchant's credentials (and/or Agent Device credentials).

As shown at 16b, the TISS may use at least a portion of the received information to determine and/or identify the type(s) of available transactions which may be performed (e.g., between the two users).

As shown at 18b, the TISS may provide to the Agent Device information relating to the available transaction types.

In at least one embodiment, the TISS may optionally generate Client and Agent Transaction UUIDs which, for example, may be exchanged between the TISS and Client and Agent Devices during TISS API function calls, and used to increase security.

In at least one embodiment, the Agent Device may be operable to prompt the user to input the transaction type to be performed and/or to select from a list of transaction types available to the user of the Agent Device. Similarly, in at least one embodiment, the Client Device may be operable to prompt the user to input the transaction type to be performed and/or to select from a list of transaction types available to the user of the Client Device.

For example, as shown at 20b, the Agent Device display a Transaction Type Selection GUI (e.g., 710, FIG. 7A) prompting the user to select the type of transaction to be performed. In this particular example, it is assumed that the merchant has provided input indicating that a payment transaction is to be performed. In at least one embodiment, the merchant may also provide input confirming that Mobile Device B corresponds to the Agent (e.g., merchant) side of the payment transaction.

As shown at 22b, the Agent Device may be operable to display one or more Merchant Invoice Transaction GUIs (e.g., 712, 714, FIG. 7B) to facilitate the acquiring of the invoicing information and/or transaction details.

In some embodiments (not illustrated), the merchant may use the Agent Device to scan/read additional TID(s) relating to products/services to be paid for, pricing information, transaction details, and/or other types of invoicing information In one embodiment, the Transaction Identification Device Application may be configured or designed to scan/read QRcodes and/or any type of barcode insignia (and/or other types of machine readable data) relating to various types of goods/services, and to automatically and dynamically generate an itemized invoice and total amount due, which, for example, can be displayed at the Agent Device, and/or forwarded to the TISS and/or Client Device.

As illustrated in the example embodiment of FIG. 31A, at 24b, the Agent Device may provide various types of information to the TISS, such as, for example, invoicing information, transaction details, etc. In at least one embodiment, the invoicing information may include one or more of the following (or combinations thereof):
payment request
shopping cart checkout information
item descriptions
order details
shipping/handling charges
discount information
pricing information
etc.

As shown at 26b, the TISS may be operable to process the received invoicing information; populate the TISS database with selected transaction details; dynamically generate customized transaction invoice information which, for example, may be suitable for display at the Client Device.

In at least one embodiment, as shown at 28b, for example, the Client Device may periodically poll the TISS in order to retrieve the transaction invoice information and/or other related information. In some embodiments, the TISS may provide the Client Device with a transaction event notification message, whereupon the Client Device may respond by retrieving the transaction invoice information and/or other related information from a specified location. In yet other embodiments, the TISS (or other components of the Transaction Identification System) may push the transaction invoice information to the Client Device.

As shown at 30b, the Client Device may present a GUI (e.g., 716, FIG. 7A) prompting the user to input security authentication credentials such as, for example, a personalized passcode, PIN, password, biometric data, etc.

As shown at 32b, the Client Device may provide the user's security authentication credentials to the TISS for processing. In some embodiments, the Client Device may also provide Client Device authentication credentials to the TISS for processing.

In at least one embodiment, authentication of the Client user and/or Client Device may occur after the Client user has approved the details of the invoiced transaction.

As shown at 34b, the TISS may process the information received from the Client Device. In at least one embodiment, the TISS may use at least a portion of the received information to authenticate and/or verify the Client user's security credentials and/or Client Device's security credentials. In the present example of FIG. 31A, it is assumed that the TISS successfully authenticates the Client user's credentials (and Client Device's credentials).

As shown at 38b, the TISS may provide transaction invoice information to the Client Device. In at least one embodiment, the TISS may also be operable to determine or identify one or more payment methods which are available to the Client user, and to provide information relating to such payment methods to the Client Device.

In one embodiment, if the TISS is unable to establish connection with client device, it may initiate alternative procedure(s) in which the Client user is able to complete the transaction via the Agent Device. Alternatively, the TISS may initiate alternative procedure(s) in which the user of the Agent Device may be requested to manually verify/confirm the identity of the Client user (e.g., by checking ID), and by processing payment for the transaction using a default payment method as specified in the Client user's profile (e.g., stored at the TISS database).

As shown at 40b, 42b, the Client Device may display one or more GUI(s) (e.g., 718, FIG. 7A) which includes content relating to the transaction invoice information and available payment methods. In at least one embodiment, the GUI(s) may also include content prompting the user to select the type of payment method to be used. Additionally, in some embodiments, the GUI(s) may also include content prompting the user to accept or decline the transaction. In this particular example, it is assumed that the Client user accepts the transaction.

In at least one embodiment, payment transactions which satisfy specific criteria may be processed as “Pre-Approved Payment Transactions” in which the payment transaction may be processed without the need to obtain authorization from the Client user and/or without the need to obtain (and/or to authenticate) the Client user's security authentication credentials. For example, in one embodiment, the Agent may verify that the Client has a valid TID with the TISS. In one embodiment, a valid TID may be one of the condition(s) required to process the transaction. In at least one embodiment, a TID may be considered valid when it is issued by the TISS and time constrains are still valid. For example, according to different embodiments, Pre-Approved Payment Transactions may be permitted for transactions satisfying one or more of the following types of conditions/criteria (or combinations thereof):
Payment transactions for amounts under a specified value (e.g., payments for transactions totaling less than $10)
Payment transactions relating to commuter transit (e.g., BART entrances/exits, subway turnstiles, bus fares, Fastrak tolls, bridge/road tolls, etc.)
Payment transactions involving specific types of payment methods
TID used for the transaction confirmed as valid and/or active.
Payment transactions matching other types of pre-defined Pre-Approved Payment Transaction criteria

As shown at 44b, the Client Device may provide Client response information to the TISS for processing (46b). In at least one embodiment, the Client response information may include the Client user's input information relating to selected method of payment, transaction approval, etc.

In at least one embodiment, the TISS may be configured or designed to handle the processing of the Client payment transaction details, and to perform operation(s) which may be desirable in order to complete the TIS payment transaction between the client (e.g., user A) and the merchant (e.g., user B). For example, according to different embodiments, the TISS may be operable to initiate and/or perform one or more of the following types of operation(s), action(s), and/or procedure(s) (or combinations thereof):
Process the Client user's payment transaction via one or more payment gateway(s).
Verify/Confirm success/failure of the Payment Gateway payment transaction.
Update the TISS database with the Payment Gateway payment transaction details.
Update the status of the relevant TIS transaction records (e.g., at the TISS database) based upon the Payment Gateway payment transaction details.
Generate one or more transaction identifiers, as needed.
Manage the transfer of funds from one user account to another user account.
Manage the collection and processing of transaction fees relating to Client and/or Agent transactions.
Provide transaction confirmation details and/or status updates to the Client and Agent devices.
etc.

For example, as illustrated in the example embodiment of FIG. 31A, at 48b, the TISS may provide the Client user's payment information (along with payment transaction instructions) to a payment gateway (3108) to thereby cause the payment gateway to process (50b) the Client user's payment transaction in accordance with the payment method/details provided by the Client user.

As shown at 50b and 52b, it is assumed that the Payment Gateway processes the Client user's payment transaction, and provides confirmation of the processed payment transaction details and status (e.g., success/failure) to the TISS.

As shown at 54b, the TISS may update TISS database with the received transaction payment details. In at least one embodiment, the TISS may also update appropriate records in the TISS database to reflect that User A (client) has successfully completed a payment transaction to User B (merchant) for a specified amount (e.g., along with other related payment transaction details such as, for example, timestamp information, payment method details, TID information, transaction reference information, etc.).

As shown at 56b, 57b, the TISS may provide Invoice/Payment Transaction confirmation details to the Client Device and/or Agent Device, which may be displayed, for example, at the Client and/or Agent Device(s) (as illustrated, for example, at 722, FIGS. 7A and 724, FIG. 7B.

One of the advantageous features of the Transaction ID technology disclosed herein is that the Transaction Identification System may be configured or designed to provide flexibility to users by enabling a given transaction (e.g., between two parties) to be initiated by either party to the transaction by scanning the other party's TID. For example, as illustrated in the example embodiment of FIG. 31A, user B (e.g., the merchant/agent) may initiate a payment transaction with user A (client) by using the Agent Device to scan or read the TID displayed at the Client Device. Alternatively, in at least one embodiment, (as illustrated, for example, in FIG. 31B), user A (e.g., the client) may initiate the same payment transaction with user B (merchant/agent) by using the Client Device to scan or read a TID displayed at the Agent Device.

FIG. 31B shows an alternate example embodiment of an interaction diagram illustrating various communication flows and actions which may be initiated and/or performed during an example mobile-mobile payment transaction. In this particular example, it is assumed that the users of mobile devices A and B desire to conduct a payment transaction with each other using their respective mobile devices. Additionally, in this particular example, it is assumed that the user of Mobile Device B (3104) is a merchant or vendor who desires to receive a payment from the user of Mobile Device A (3102) for goods and/or services.

As illustrated in the example embodiment of FIG. 31B, at 2c it is assumed user B (the merchant/agent) uses Transaction Identification Device Application software running on Mobile Device B (Agent Device) to display a Transaction ID (TID) on the display of the Client Device.

As shown at 4c, it is assumed that user A (e.g., the Client user) uses Transaction Identification Device Application software running on Mobile Device A (Client Device) to scan or read the TID displayed at the Agent Device.

As shown at 6c, 8c, Client Device may present a GUI prompting the Client user to input security authentication credentials such as, for example, a personalized passcode, PIN, password, biometric data, etc.

As shown at 10c, the Client Device may process the user's input. Additionally, in at least one embodiment, the Transaction Identification Device Application running at the Client Device may also acquire contextual information relating to the Client Device, the client, the merchant, the transaction to be performed, etc.

As shown at 12b, the Client Device may transmit information to the TISS 3106, such as, for example, the Client user's authentication credentials, Client Device authentication credentials, TID information (e.g., relating to the scanned Agent Device TID), contextual information, transaction type information (which, for example, may be manually input by the merchant), etc.

As shown at 14b, the TISS may process the information received from the Client Device. In at least one embodiment, the TISS may use at least a portion of the received information to authenticate and/or verify the Client user's authentication credentials and/or the Client Device's authentication credentials. In the present example of FIG. 31B, it is assumed that the TISS successfully authenticates the merchant's credentials (and/or Client Device credentials).

In at least one embodiment, further processing of the Transaction ID payment transaction of the present example (of FIG. 31B) may be similar to that described with respect to FIG. 31A, commencing at operation 16b of FIG. 31A, for example.

Note that in at least one embodiment, in order to successfully complete the payment transaction, the merchant may be required at some point to provide his/her security authentication credentials for authentication/verification by the TISS in a manner similar to operations 8b-14b of FIG. 31A.

FIG. 32A shows a specific example embodiment of an interaction diagram illustrating various communication flows and actions which may be initiated and/or performed during an example user identity verification transaction. For purposes of illustration, the interaction diagram of FIG. 32A will now be described by way of example with reference to the FIGS. 8A-8B. In this particular example, it is assumed that a user of Mobile Device A (Client Device) 3202 desires to use his mobile device to participate in an identity verification transaction in which the user authorizes trusted identification information relating to that user to be provided to a designated Agent Device (e.g., Device B, 3204). According to different embodiments, the Agent Device may be implemented as a mobile device, a computer system, a kiosk system, a component of a server system, etc.

As illustrated in the example embodiment of FIG. 32A, at 2d it is assumed that the Client user operates Transaction Identification Device Application software running on the Client Device to display a Transaction ID (TID) (e.g., 806a, FIG. 8A) on the display of Client Device.

As shown at 4d, it is assumed that the Agent Device initiates a scan or read of the TID displayed at the Client Device, and processes (6d) the scanned TID information.

For purposes of illustration, it is assumed in the present example embodiment of FIG. 32A that the Agent Device corresponds to a mobile device operated by an Agent user. As shown at 8d, the Agent Device may present a GUI (e.g., 808, FIG. 8B) prompting the Agent user to input security authentication credentials.

As shown at 9d, the Agent Device may present a GUI (e.g., 812, FIG. 8B) prompting the Agent user to select or identify the type of transaction to be performed. According to different embodiments, examples of various different transaction types may include, but are not limited to, one or more of the following (or combinations thereof):
payment transactions;
user identity verification transactions;
user age verification transactions;
universal shopping cart transactions;
contact information exchange transactions
user check-in/out transactions
URL access/login transactions
etc.

According to different embodiments, each of the different transaction types listed above may have associated therewith one or more subordinate transaction types. For example, in the specific example embodiment of FIG. 32A, different types of subordinate transactions (or sub-transactions) relating to the user identity verification transaction may include, but are not limited to, one or more of the following (or combinations thereof):
driver's license verification
Social Security number verification
passport verification
military ID verification
student ID verification
government ID verification
hospital ID verification
company ID version
security credential verification
etc.

In at least one embodiment, the Transaction Identification Device Application running at the Agent Device may also acquire contextual information relating to the Agent Device, the Agent user, the transaction to be performed, etc.

As shown at 12d, the Agent Device may transmit information to the TISS 3206, such as, for example, one or more of the following (or combinations thereof): the Agent user's authentication credentials, Agent Device authentication credentials, TID information (e.g., relating to the scanned Client Device TID), contextual information, transaction type information (which, for example, may be selected by the Agent user), etc.

As shown at 14d, the TISS may process the information received from the Agent Device. In at least one embodiment, the TISS may use at least a portion of the received information to authenticate and/or verify the Agent user's/agent's authentication credentials. In the present example of FIG. 32A, it is assumed that the TISS successfully authenticates the Agent user's credentials (and/or Agent Device credentials).

As shown at 16d, the TISS may use at least a portion of the received information to determine and/or identify the type(s) of available transactions and/or subordinate transactions which may be performed (e.g., between the two users/devices).

As shown at 18d, the TISS may provide to the Agent Device information relating to the available transaction types.

In at least one embodiment, the TISS may optionally generate Client and Agent Transaction UUIDs which, for example, may be exchanged between the TISS and Client and Agent Devices during TISS API function calls, and used to increase security.

In at least one embodiment, the Agent Device may be operable to display (20d) one or more GUIs for prompting the Agent user to input or select (22d) the type of transaction (or sub-transaction) to be performed.

For example, as illustrated in the example GUI 814 of FIG. 8B, the Agent user may select the type of sub-transaction (to be performed) from a dropdown menu list (e.g., 814a) of sub-transactions. In this particular example, it is assumed that the Agent user has elected to perform a Driver's License User Identity Verification transaction.

As illustrated in the example embodiment of FIG. 32A, the Agent Device may process (22d) the Agent user's input information, and provide (24d) various types of information to the TISS, such as, for example, transaction type information, user input information, Etc.

As shown at 26d, the TISS may be operable to process the information received from the Agent Device, and populate the TISS database with selected transaction details.

In at least one embodiment, as shown at 28d, for example, the Client Device may periodically poll the TISS in order to retrieve transaction-related information and/or other information. In some embodiments, the TISS may provide the Client Device with a transaction event notification message, whereupon the Client Device may respond by retrieving the user identification transaction details and/or other related information from a specified location. In yet other embodiments, the TISS (or other components of the Transaction Identification System) may push the in one related information to the Client Device.

As shown at 30d, the Client Device may present a GUI (e.g., 816, FIG. 8A) prompting the user to input security authentication credentials.

As shown at 34d, the Client Device may present a GUI (e.g., 818, FIG. 8A) which displays information relating to the identity verification transaction request, and prompts the user for input to approve/deny the transaction request. In the present example embodiment, it is assumed that the user provides input for approving the identity verification transaction request.

As shown at 36d, the Client Device may provide Client response information to the TISS for processing. In at least one embodiment, the Client response information may include one or more of the following (or combinations thereof):
Client user security credentials
Client Device authentication credentials
Client user input information/instructions
etc.

In at least one embodiment, authentication of the Client user and/or Client Device may occur after the Client user has approved the details of the invoiced transaction.

As shown at 40d, the TISS may process the information received from the Client Device. In at least one embodiment, the TISS may use at least a portion of the received information to authenticate and/or verify the Client user's security credentials and/or Client Device's security credentials. In the present example of FIG. 32A, it is assumed that the TISS successfully authenticates the Client user's credentials (and Client Device's credentials).

In at least one embodiment, the TISS may also process the Client user's input instructions (e.g., relating to the approval of the request to perform an identity verification transaction), and initiate one or more actions to facilitate the processing of the user identity verification transaction.

In at least one embodiment, the TISS may be configured or designed to handle and/or facilitate the processing of identity verification transactions. For example, according to different embodiments, the TISS may be operable to initiate and/or perform one or more of the following types of operation(s), action(s), and/or procedure(s) (or combinations thereof):
Initiate a user identity verification transaction via one or more identity verification gateway(s).
Verify/Confirm success/failure of an identity verification transaction.
Update the TISS database with the identity verification transaction details.
Retrieve or access personal identification verification information from a Trusted Source.
Retrieve or access personal identification verification information from an identity verification gateway.
Manage the collection and processing of transaction fees relating to Client and/or Agent transactions.
Provide transaction confirmation details and/or status updates to the Client and Agent devices.
etc.

For example, as illustrated in the example embodiment of FIG. 32A, at 42d, the TISS may submit a user identity verification request to an identity verification gateway (3208) to thereby cause the identity verification gateway to process (44d) the identity verification request. In at least one embodiment, the processing of the identity verification request may include retrieving or accessing personal identification verification information from a Trusted Source (such as, for example, the Department of Motor Vehicles). Further, in at least one embodiment, the Trusted Source may include at least one Local Transaction Identification Appliance which is configured or designed to process identification verification requests from the TISS and/or other devices/components of the Transaction Identification System.

As illustrated in the example embodiment of FIG. 32A, it is assumed at 46d that the Identity Verification Gateway processes the user identity verification transaction, and accesses personal identification verification information relating to the Client user (e.g., an image of the Client user's drivers license) from a Trusted Source (e.g., DMV).

As shown at 48d, the TISS may update TISS database with the received transaction identity verification details.

As shown at 50d, the TISS may provide to the Client Device information confirming the successful completion of the user identity verification transaction. In at least one embodiment, the Client Device may display at least a portion of the user identity verification transaction confirmation details as shown, for example, at 822 of FIG. 8A.

In at least one embodiment, the TISS may also provide (52d) to the Agent Device at least a portion of the personal identity verification information relating to the Client user. In at least one embodiment, the Agent Device may be configured or designed to display (54d) the received personal identity verification information at a local display (e.g., as shown at 824, FIG. 8B). In at least one embodiment, the Agent user may use the displayed identity verification information to verify the identity of the Client user. For example, in at least one embodiment, the identity of the Client user may be confirmed by comparing the Client user's drivers license information (e.g., which may be displayed at the Agent System) to observable features of the Client user. In one embodiment, the Agent device may include biometric information reader which may read/scan biometric ID data from the Client user in order to compare such information to trusted identity verification information relating to that particular user.

FIG. 32B shows an alternate example embodiment of an interaction diagram illustrating various communication flows and actions which may be initiated and/or performed during an example user identity verification transaction. For purposes of illustration, the interaction diagram of FIG. 32B will now be described by way of example with reference to the FIGS. 8C-8D. In this particular example, it is assumed that a user of Mobile Device A (Client Device) 3202 desires to use his mobile device to participate in an identity verification transaction in which the user authorizes trusted identification information relating to that user to be provided to a designated Agent Device (e.g., Device B, 3204). However, in contrast to the example embodiment of FIG. 32A (e.g., in which the Agent Device scans the Client's TID), in the example embodiment of FIG. 32B, it is assumed that the Client Device initiates the identity verification transaction by scanning the Agent's TID).

Thus, for example, as illustrated in the example embodiment of FIG. 32B, at 2e it is assumed that the Agent displays an Agent TID to be scanned by the Client Device. According to different embodiments, different techniques may be used for displaying the Agent TID, such as, for example, one or more of the following (or combinations thereof):
displaying the Agent TID at a display of the Agent Device
displaying the Agent TID on a mobile device (e.g., 858, FIG. 8D)
displaying the Agent TID on an electronic display other than the Agent Device
displaying the Agent TID on a sheet of paper or other tangible print media
etc.

As shown at 4e, it is assumed that the Client Device initiates a scan or read of the displayed Agent TID, and processes (6e) the scanned TID information.

As shown at 8e, the Client Device may present a GUI (e.g., 866, FIG. 8C) prompting the Client user to input security authentication credentials.

In at least one embodiment, the Transaction Identification Device Application running at the Client Device may also acquire contextual information relating to the Client Device, the Client user, the transaction to be performed, etc.

As shown at 12e, the Client Device may transmit information to the TISS 3206, such as, for example, one or more of the following (or combinations thereof): the Client user's authentication credentials, Client Device authentication credentials, TID information (e.g., relating to the scanned Agent TID), contextual information, etc.

As shown at 14e, the TISS may process the information received from the Client Device. In at least one embodiment, the TISS may use at least a portion of the received information to authenticate and/or verify the Client user's/Client's authentication credentials. In the present example of FIG. 32B, it is assumed that the TISS successfully authenticates the Client user's credentials (and/or Client Device credentials).

As shown at 18e, the TISS may notify the Agent Device of a pending identity verification transaction event. In at least one embodiment, the TISS may also request for the Agent Device to provide Agent authentication/security credentials in order to authenticate the Agent Device. In at least one embodiment, the Agent Device may be configured or designed to automatically provide (24e) the Agent authentication/security credentials and/or transaction related information to the TISS without requiring an Agent user's input.

As shown at 26e, the TISS may perform one or more of the following: process information received from the Agent Device, authenticate the Agent authentication/security credentials, populate the TISS database with updated transaction information, etc.

As shown at 28e, the Client Device may poll the TISS in order to retrieve transaction-related information and/or other information.

As shown at 30e, the Client Device may present a GUI (e.g., 868, FIG. 8C) which displays information relating to the identity verification transaction request, and prompts the user for input to approve/deny the transaction request. In the present example embodiment, it is assumed that the user provides input for approving the identity verification transaction request.

As shown at 36e, the Client Device may provide Client response information to the TISS for processing. In at least one embodiment, the Client response information may include one or more of the following (or combinations thereof):
Client user security credentials
Client Device authentication credentials
Client user input information/instructions
etc.

In at least one embodiment, authentication of the Client user and/or Client Device may occur after the Client user has approved the details of the invoiced transaction.

As shown at 40e, the TISS may process the information received from the Client Device. For example, in at least one embodiment, the TISS may process the Client user's input instructions (e.g., relating to the approval of the request to perform an identity verification transaction), and initiate one or more actions to facilitate the processing of the user identity verification transaction.

As illustrated in the example embodiment of FIG. 32B, at 42e, the TISS may submit a user identity verification request to an identity verification gateway (3208) to thereby cause the identity verification gateway to process (44e) the identity verification request. In at least one embodiment, the processing of the identity verification request may include retrieving or accessing personal identification verification information from a Trusted Source (such as, for example, the Department of Motor Vehicles).

As illustrated in the example embodiment of FIG. 32B, it is assumed at 46e that the Identity Verification Gateway processes the user identity verification transaction, and accesses personal identification verification information relating to the Client user (e.g., an image of the Client user's drivers license) from a Trusted Source (e.g., DMV).

As shown at 48e, the TISS may update TISS database with the received transaction identity verification details.

As shown at 50e, the TISS may provide to the Client Device information confirming the successful completion of the user identity verification transaction. In at least one embodiment, the Client Device may display at least a portion of the user identity verification transaction confirmation details as shown, for example, at 872 of FIG. 8C.

In at least one embodiment, the TISS may also provide (52e) to the Agent Device at least a portion of the personal identity verification information relating to the Client user. In at least one embodiment, the Agent Device may be configured or designed to display (54e) the received personal identity verification information at a local display (e.g., as shown at 874, FIG. 8D). In at least one embodiment, the Agent user may use the displayed identity verification information to verify the identity of the Client user. For example, in at least one embodiment, the identity of the Client user may be confirmed by comparing the Client user's drivers license information (e.g., which may be displayed at the Agent System) to observable features of the Client user. In one embodiment, the Agent device may include biometric information reader which may read/scan biometric ID data from the Client user in order to compare such information to trusted identity verification information relating to that particular user.

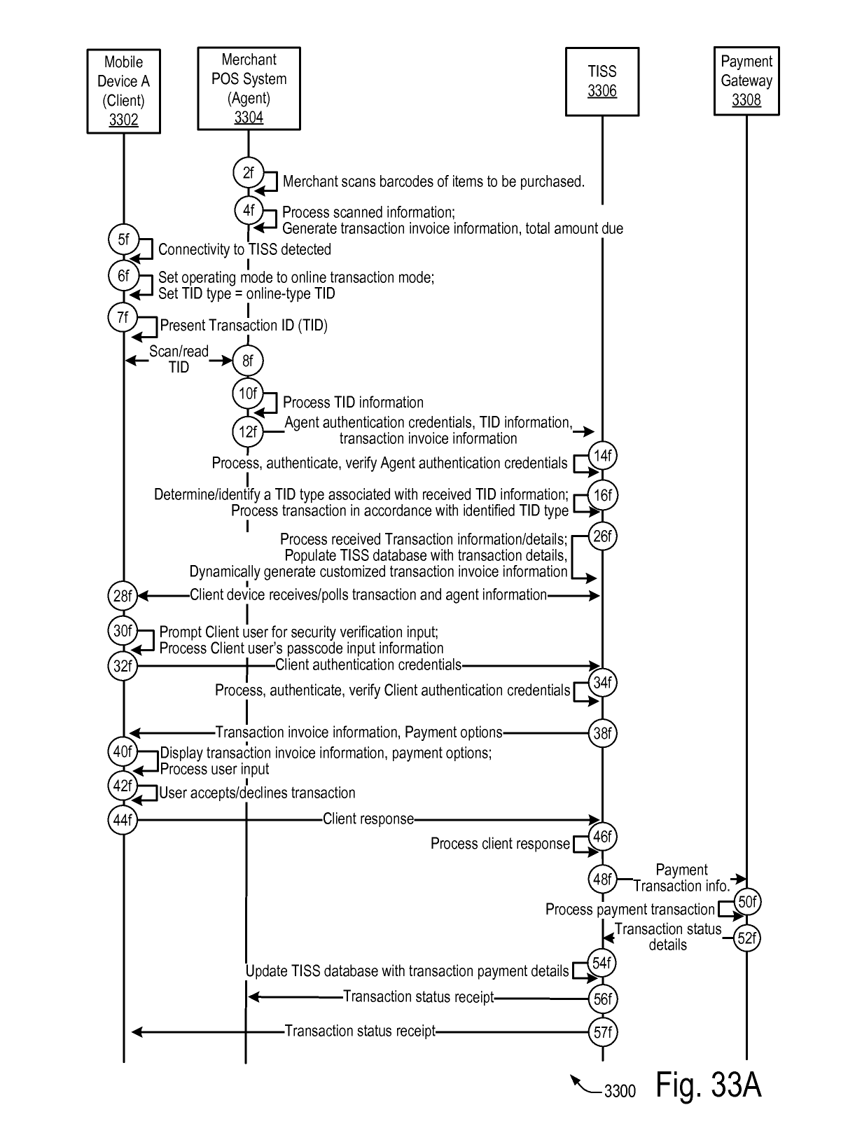

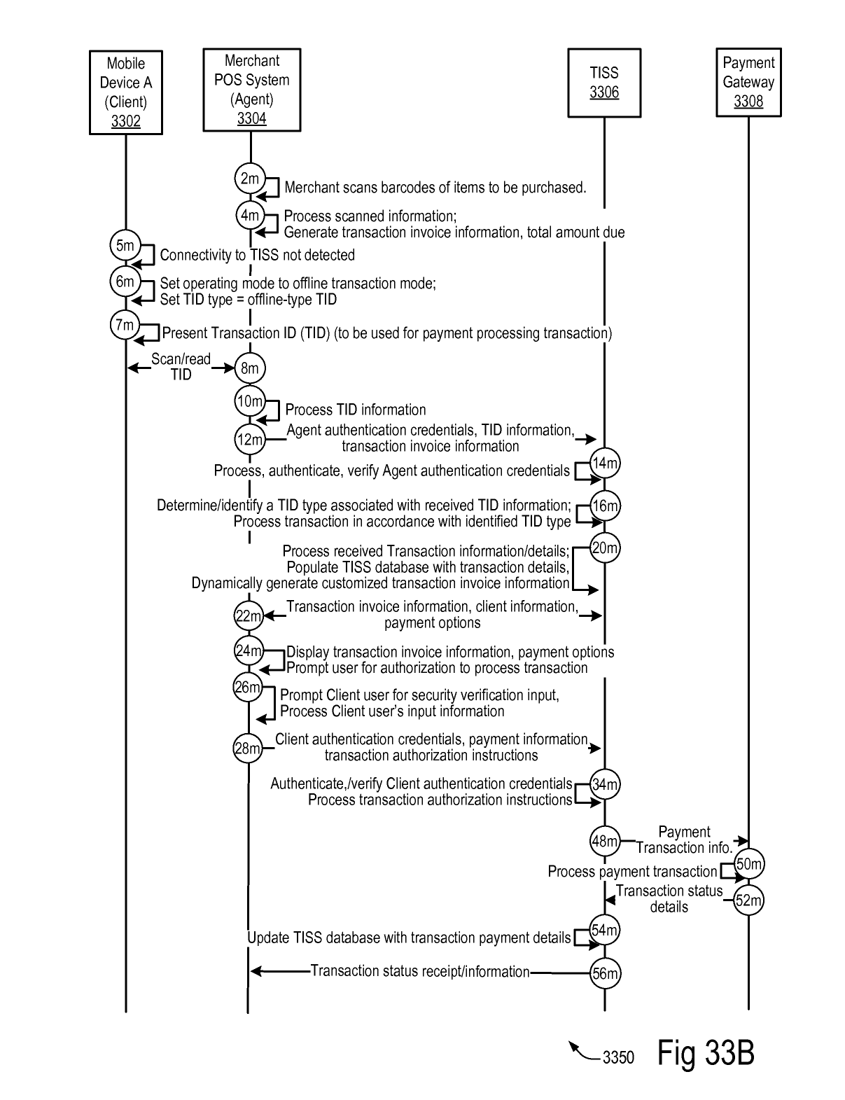

FIG. 33A shows a specific example embodiment of an interaction diagram illustrating various communication flows and actions which may be initiated and/or performed during an example mobile-POS payment transaction. For purposes of illustration, the interaction diagram of FIG. 33A will now be described by way of example with reference to the FIGS. 9A-9B. In this particular example, it is assumed that a user of Client Device A is at the checkout stand of a merchant store (e.g., Safeway) and desires to use his mobile device as a payment instrument for performing POS payment transaction at the checkout stand (to thereby pay for the goods/services being purchased). Additionally, in this particular example, it is assumed that the merchant's POS system includes a scanner device (e.g., 950, FIG. 9A) which is operable to scan/read barcode insignias (e.g., 951, FIG. 9A) and QRcode insignias (e.g., 903, FIG. 9B).

As illustrated in the example embodiment of FIG. 33A, it is assumed at 2f that a checkout clerk (Agent user) scans barcodes of items to be purchased (e.g., as illustrated, for example, at 953, 960, FIG. 9A). It is further assumed at 4f that the Merchant POS System (Agent) processes the scanned barcode information, and generates transaction invoice information, including a total amount due.

In the specific example embodiment of FIG. 33A it is assumed that the Client user uses Transaction Identification Device Application software running on Mobile Device A (herein referred to as the “Client Device”) to display a Transaction ID (TID) on the display of the Client Device. In at least one embodiment, when the Transaction Identification Device Application is first initiated or launched at the Client Device, it may invoke execution of a Client/Agent Online/Offline Transaction Processing Procedure such as that illustrated and described, for example, with respect to FIG. 41A.

As illustrated in the example embodiment of FIG. 33A, as shown at 5f, the Client Device may check to see whether it is able to establish connectivity (e.g., via one or more secure/encrypted communication channel(s)) to the Transaction Identification Server System.

In the present example of FIG. 33A, it is assumed that that the Client Device is able to establish connectivity via a secure communication channel to the Transaction Identification Server System. Accordingly, the Client Device (and/or Transaction Identification Device Application) may initiate or perform one or more of the following actions(s)/operation(s) (or combinations thereof):
Set (6f) current operating mode to online transaction mode;
Set (6f) TID type=online−type TID
Present (7f) online-type Transaction ID (TID) (e.g., to be used for payment processing transaction) (e.g., 903, FIG. 9A)

As shown at 8f, it is assumed that the checkout clerk (POS agent) operates the Merchant POS System (herein referred to as the “Agent System”) to scan or read the online-type TID displayed at the Client Device. For example, as illustrated in the example embodiment of FIGS. 9A and 9B, a scanning device 950 (which is operable he connected to the Agent System) may be used to scan (955) the TID 903a displayed on the Client Device display 903.

As shown at 10f, the Agent System may process the scanned TID information.

As shown at 12f, the Agent System may transmit information to the TISS 3306, such as, for example, one or more of the following (or combinations thereof): Agent System authentication credentials, TID information (e.g., relating to the scanned Client Device TID), transaction invoice information, etc.

In at least one embodiment, the transaction invoicing information may include one or more of the following (or combinations thereof):
Merchant agent identifier information
POS station identifier information
timestamp information
checkout information
item descriptions
discount/savings information
transaction fee information
pricing information
SKU codes
total transaction amount
Customer ID or membership information
etc.

As shown at 14f, the TISS may process the information received from the Agent System. In at least one embodiment, the TISS may use at least a portion of the received information to authenticate and/or verify the POS agent's/agent's authentication credentials. In the present example of FIG. 33A, it is assumed that the TISS successfully authenticates the POS agent's credentials (and/or Agent System credentials).

As shown at 16f, the TISS may be operable to determine/identify a TID type associated with received TID information (e.g., the scanned Client Device TID). Additionally, the TISS may be operable to process the associated payment transaction in accordance with identified TID type. Thus, for example, in the present example embodiment of FIG. 33A, it is assumed that the TISS has identified the scanned Client Device TID as corresponding to an online-type Transaction ID, and that the TISS has made a determination to process the associated payment transaction in accordance with online processing procedures.

As shown at 26f, the TISS may be operable to initiate or perform one or more of the following actions(s)/operation(s) (or combinations thereof):
process received transaction information/details;
populate TISS database with transaction details,
dynamically generate customized transaction invoice information which, for example, may be suitable for display at the Client Device;
etc.

In at least one embodiment, as shown at 28f, for example, the Client Device may periodically poll the TISS in order to retrieve the transaction invoice information and/or other related information. In some embodiments, the TISS may provide the Client Device with a transaction event notification message, whereupon the Client Device may respond by retrieving the transaction invoice information and/or other related information from a specified location. In yet other embodiments, the TISS (or other components of the Transaction Identification System) may push the transaction invoice information to the Client Device.

As shown at 30f, the Client Device may present a GUI (e.g., 905, FIG. 9A) prompting the user to input security authentication credentials such as, for example, a personalized passcode, PIN, password, biometric data, etc.

As shown at 32f, the Client Device may provide the user's security authentication credentials to the TISS for processing. In some embodiments, the Client Device may also provide Client Device authentication credentials to the TISS for processing.

In at least one embodiment, authentication of the Client user and/or Client Device may occur after the Client user has approved the details of the invoiced transaction.

As shown at 34f, the TISS may process the information received from the Client Device. In at least one embodiment, the TISS may use at least a portion of the received information to authenticate and/or verify the Client user's security credentials and/or Client Device's security credentials. In the present example of FIG. 33A, it is assumed that the TISS successfully authenticates the Client user's credentials (and Client Device's credentials).

As shown at 38f, the TISS may provide transaction invoice information to the Client Device. In at least one embodiment, the TISS may also be operable to determine or identify one or more payment methods which are available to the Client user, and to provide information relating to such payment methods to the Client Device.

In one embodiment, if the TISS is unable to establish connection with client device, it may initiate alternative procedure(s) in which the Client user is able to complete the transaction via the Agent System. Alternatively, the TISS may initiate alternative procedure(s) in which the user of the Agent System may be requested to manually verify/confirm the identity of the Client user (e.g., by checking ID), and by processing payment for the transaction using a default payment method as specified in the Client user's profile (e.g., stored at the TISS database).

As shown at 40f, 42f, the Client Device may display one or more GUI(s) (e.g., 907, FIG. 9A) which includes content relating to the transaction invoice information and available payment methods. In at least one embodiment, the GUI(s) may also include content prompting the user to select the type of payment method to be used. Additionally, in some embodiments, the GUI(s) may also include content prompting the user to accept or decline the transaction. In this particular example, it is assumed that the Client user accepts the transaction.

In at least one embodiment, payment transactions which satisfy specific criteria may be processed as “Pre-Approved Payment Transactions” in which the payment transaction may be processed without the need to obtain authorization from the Client user and/or without the need to obtain (and/or to authenticate) the Client user's security authentication credentials. Additional details relating to Pre-Approved Payment Transactions are provided elsewhere in the present disclosure and therefore will not be repeated.

As shown at 44f, the Client Device may provide Client response information to the TISS for processing (460. In at least one embodiment, the Client response information may include the Client user's input information relating to selected method of payment, transaction approval, etc.

In at least one embodiment, the TISS may be configured or designed to handle the processing of the Client payment transaction details, and to perform operation(s) which may be desirable in order to complete the TIS payment transaction between the client (e.g., user A) and the POS merchant. For example, according to different embodiments, the TISS may be operable to initiate and/or perform one or more types of operation(s), action(s), and/or procedure(s), as described or referenced herein.

For example, as illustrated in the example embodiment of FIG. 33A, at 48f, the TISS may provide the Client user's payment information (along with payment transaction instructions) to a payment gateway (3308) to thereby cause the payment gateway to process (500 the Client user's payment transaction in accordance with the payment method/details provided by the Client user.

As shown at 50f and 52f, it is assumed that the Payment Gateway processes the Client user's payment transaction, and provides confirmation of the processed payment transaction details and status (e.g., success/failure) to the TISS.

As shown at 54f, the TISS may update TISS database with the received transaction payment details. In at least one embodiment, the TISS may also update appropriate records in the TISS database to reflect that the Client user (and/or associated Client Device) has successfully completed a payment transaction to the POS merchant for a specified amount (e.g., along with other related payment transaction details such as, for example, timestamp information, payment method details, TID information, transaction reference information, etc.).

As shown at 56f, 57f, the TISS may provide Invoice/Payment Transaction confirmation details to the Client Device and/or Agent System, which may be displayed, for example, at the Client and/or Agent System(s) (as illustrated, for example, at 909, FIG. 9A).

In at least one embodiment, a Transaction Identification Device Application running at Client Device 3302 may be configured or designed to initiate and/or perform at least a portion of the operations/activities implemented at Client Device 3302.

FIG. 33B shows a specific example embodiment of an interaction diagram illustrating various communication flows and actions which may be initiated and/or performed during an example mobile-POS payment transaction. In this particular example, it is assumed that a user of Client Device A is at the checkout stand of a merchant store (e.g., Safeway) and desires to use his mobile device as a payment instrument for performing POS payment transaction at the checkout stand (to thereby pay for the goods/services being purchased). Additionally, in this particular example, it is assumed that the merchant's POS system includes a scanner device which is operable to scan/read barcode insignias and QRcode insignias.

As illustrated in the example embodiment of FIG. 33B, it is assumed at 2m that a checkout clerk (Agent user) scans barcodes of items to be purchased. It is further assumed at 4m that the Merchant POS System (Agent) processes the scanned barcode information, and generates transaction invoice information, including a total amount due.

In the specific example embodiment of FIG. 33B it is assumed that the Client user uses Transaction Identification Device Application software running on Mobile Device A (herein referred to as the “Client Device”) to display a Transaction ID (TID) on the display of the Client Device. In at least one embodiment, when the Transaction Identification Device Application is first initiated or launched at the Client Device, it may invoke execution of a Client/Agent Online/Offline Transaction Processing Procedure such as that illustrated and described, for example, with respect to FIG. 41A.

As illustrated in the example embodiment of FIG. 33B, as shown at 5m, the Client Device may check to see whether it is able to establish connectivity (e.g., via one or more secure/encrypted communication channel(s)) to the Transaction Identification Server System.

In the present example of FIG. 33B, it is assumed that that the Client Device is not able to establish connectivity to the Transaction Identification Server System. Accordingly, the Client Device (and/or Transaction Identification Device Application) may initiate or perform one or more of the following actions(s)/operation(s) (or combinations thereof):
Set (6m) current operating mode to offline transaction mode;
Set (6m) TID type=offline−type TID
Present (7m) offline-type Transaction ID (TID) (e.g., to be used for payment processing transaction)

As shown at 8m, it is assumed that the checkout clerk (POS agent) operates the Merchant POS System (herein referred to as the “Agent System”) to scan or read the offline-type TID displayed at the Client Device.

As shown at 10m, the Agent System may process the scanned TID information.

As shown at 12m, the Agent System may transmit information to the TISS 3306, such as, for example, one or more of the following (or combinations thereof): Agent System authentication credentials, TID information (e.g., relating to the scanned Client Device TID), transaction invoice information, etc.

In at least one embodiment, the transaction invoicing information may include one or more of the following (or combinations thereof):
Merchant agent identifier information
POS station identifier information
timestamp information
checkout information
item descriptions
discount/savings information
transaction fee information
pricing information
SKU codes
total transaction amount
Customer ID or membership information
etc.

As shown at 14m, the TISS may process the information received from the Agent System. In at least one embodiment, the TISS may use at least a portion of the received information to authenticate and/or verify the POS agent's/agent's authentication credentials. In the present example of FIG. 33B, it is assumed that the TISS successfully authenticates the POS agent's credentials (and/or Agent System credentials).

As shown at 16m, the TISS may be operable to determine/identify a TID type associated with received TID information (e.g., the scanned Client Device TID). Additionally, the TISS may be operable to process the associated payment transaction in accordance with identified TID type. Thus, for example, in the present example embodiment of FIG. 33B, it is assumed that the TISS has identified the scanned Client Device TID as corresponding to an offline-type Transaction ID, and that the TISS has made a determination to process the associated payment transaction in accordance with offline processing procedures.

In at least one embodiment, the processing of a transaction in accordance with offline processing procedures may include one or more of the following (or combinations thereof):
taking appropriate action(s) to cause the transaction to be completed via the Agent Device and/or Agent System;
identifying an alternate device which is able to establish connectivity to the TISS;
requesting the Agent user to manually verify the identity of the Client user (e.g., by checking ID)
performing a payment processing transaction using a Client user's default payment method/account (which, for example, may be specified in a Client user profile)
using the Agent Device and/or Agent System to display transaction information to the Client user and/or to receive input (e.g., payment method, security credentials, Client user signature, transaction authorization/approval, etc.) from the Client user.
etc.

In the specific example embodiment of FIG. 33B, it is assumed that the offline processing procedures for the payment transaction includes using the Agent System to display transaction information to the Client user and/or to receive input from the Client user. Thus, for example, in one embodiment, during offline processing procedures for a payment transaction, the merchant's POS system (e.g., which may include a separate POS device configured or designed to be operated by the customer), may be used by the Client user to complete the payment/checkout transaction.

As shown at 20m, the TISS may be operable to initiate or perform one or more of the following actions(s)/operation(s) (or combinations thereof):
process received transaction information/details;
populate TISS database with transaction details,
dynamically generate customized transaction invoice information which, for example, may be suitable for display at the Agent System;
etc.

In at least one embodiment, the Agent System may periodically poll the TISS in order to retrieve the transaction invoice information and/or other related information. In some embodiments, the TISS may provide the Agent System with a transaction event notification message, whereupon the Agent System may respond by retrieving the transaction invoice information and/or other related information from a specified location. In yet other embodiments, the TISS (or other components of the Transaction Identification System) may push the transaction invoice information to the Agent System.

As shown at 22m, the TISS may provide transaction invoice information to the Agent System. In at least one embodiment, the TISS may also be operable to determine or identify one or more payment methods which are available to the Client user, and to provide information relating to such payment methods to the Agent System.

As shown at 24m, the Agent System may display one or more GUI(s) which includes content relating to the transaction invoice information and available payment methods. In at least one embodiment, the GUI(s) may also include content prompting the user to select the type of payment method to be used. Additionally, in some embodiments, the GUI(s) may also include content prompting the user to accept or decline the transaction. In this particular example, it is assumed that the Client user accepts the transaction.

As shown at 26m, the Agent System may present a GUI prompting the Client user to input security authentication credentials such as, for example, a personalized passcode, PIN, password, biometric data, signature, etc.

As shown at 28m, the Agent System may provide various types of information to the TISS for processing such as, for example, one or more of the following (or combinations thereof): Client user's security authentication credential; Client user's input information relating to selected method of payment, transaction approval, etc.; Agent System authentication credentials; etc.

As shown at 34m, the TISS may process the information received from the Agent System. In at least one embodiment, the TISS may use at least a portion of the received information to authenticate and/or verify the Client user's security credentials and/or Agent System's security credentials. In the present example of FIG. 33B, it is assumed that the TISS successfully authenticates the Client user's credentials (and Agent System's credentials).

In at least one embodiment, authentication of the Client user and/or Agent System may occur before the Client user has approved the details of the invoiced transaction.

In at least one embodiment, the TISS may be configured or designed to handle the processing of the Client payment transaction details, and to perform operation(s) which may be desirable in order to complete the TIS payment transaction between the Client user and the POS merchant. For example, according to different embodiments, the TISS may be operable to initiate and/or perform one or more types of operation(s), action(s), and/or procedure(s), as described or referenced herein.

For example, as illustrated in the example embodiment of FIG. 33B, at 48m, the TISS may provide the Client user's payment information (along with payment transaction instructions, if desired) to a payment gateway (3308) to thereby cause the payment gateway to process (50m) the Client user's payment transaction in accordance with the payment method/details provided by the Client user.

As shown at 50m and 52m, it is assumed that the Payment Gateway processes the Client user's payment transaction, and provides confirmation of the processed payment transaction details and status (e.g., success/failure) to the TISS.

As shown at 54m, the TISS may update TISS database with the received transaction payment details. In at least one embodiment, the TISS may also update appropriate records in the TISS database to reflect that the Client user has successfully completed a payment transaction to the POS merchant for a specified amount (e.g., along with other related payment transaction details such as, for example, timestamp information, payment method details, TID information, transaction reference information, etc.).

As shown at 56m, the TISS may provide Invoice/Payment Transaction confirmation details to the Agent System, which may be displayed, for example, at the POS terminal display of the checkout stand associated with the payment transaction.

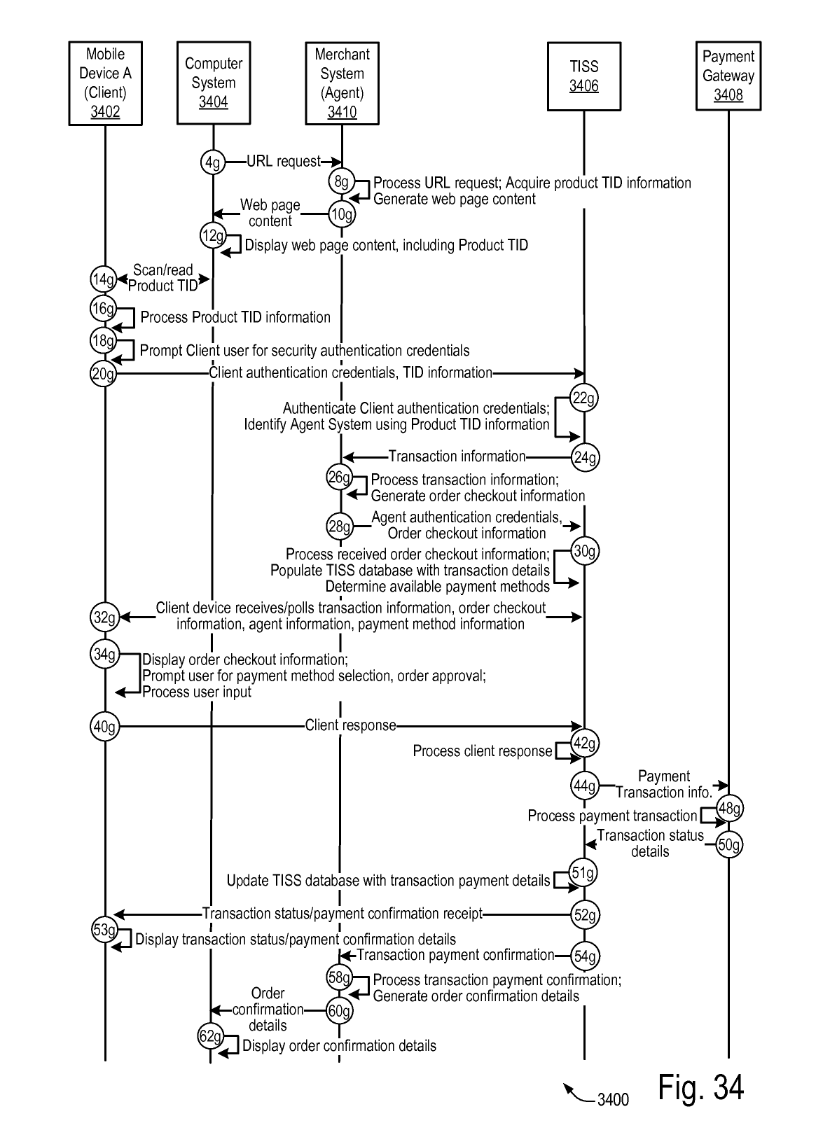

FIG. 34 shows a specific example embodiment of an interaction diagram illustrating various communication flows and actions which may be initiated and/or performed during an example mobile device-online product purchasing and payment transaction. For purposes of illustration, the interaction diagram of FIG. 34 will now be described by way of example with reference to the FIGS. 14A-14E. In this particular example, it is assumed that a user of Client Device A desires to use his mobile device (e.g., 1410, FIG. 14A) to select and purchase a product or item from an online merchant/website (e.g., Amazon.com). Additionally, in this particular example, it is assumed that the Client user may access the merchant's website and/or product webpage (e.g., 1402, FIG. 14A) via computer system 3404 (FIG. 34).

In the specific example embodiment of FIG. 34, it is assumed that the Client user directs a web browser of computer system 3404 to a desired URL corresponding to a product webpage (e.g., 1402, FIG. 14A) of an online merchant's website (herein referred to as the “Agent System”). As shown at 4g, the computer system may send a URL request to the Agent System 3410.

As shown at 8g, the Agent System may be operable to perform one or more of the following action(s)/operation(s) (or combinations thereof):
process the received URL request;
acquire product TID information (e.g., as needed or desired)
generate webpage content
etc.

In at least one embodiment, the product TID information may include a product TID which may be used to uniquely identify the product associated with that particular webpage. For example, as illustrated in the example embodiment of FIG. 14A, the displayed content of webpage 1402 includes a product Transaction ID 1404 which may be configured or designed to uniquely identify the product or item (e.g., Amazon Kindle 3G) associated with that specific webpage.

According to specific embodiments, the information contained in the displayed product TID (e.g., 1404) may include, but is not limited to, one or more of the following (or combinations thereof):
a randomized alpha-numeric string
product/item name
product/item description
merchant identifier information
product/item pricing information
shipping/handling information
webpage URL
etc.

According to different embodiments, the product TID information may be accessed via a variety of different techniques such as, for example, one or more of the following (or combinations thereof):
configuring the product TID information as a static portion of webpage content
causing the merchant system to automatically and dynamically retrieve the product TID information (e.g., when rendering dynamic webpage content)
causing the computer system to automatically and dynamically retrieve the product TID information from an external source (e.g., via dynamic processing of embedded webpage tags and/or scripts, via web browser plug-ins, via executable code, etc.)
retrieving the product TID information from a local database (e.g., a local database at the merchant system, a local Transaction Identification Appliance deployed at the merchant system or within the merchant system's local network, etc.)
retrieving the product TID information from a remote database (e.g., a database located at the Transaction Identification Server System, a database located at a remote server system or remote network, etc.)

As shown at 10g, the Agent System may provide various types of webpage content and/or other information to the computer system 3404. In at least one embodiment, the information provided from the Agent System to the computer system may include the product TID information. In other embodiments, the information provided from the Agent System to the computer system may include instructions, script, or code for causing the computer system to dynamically retrieve the product TID information from an external source.

As shown at 12g, the computer system may display webpage content relating to the requested URL. In at least one embodiment, the displayed webpage content may include the display of a product TID which has been configured or designed to be displayed in a machine readable format, as illustrated for example, at 1404 of FIG. 14A.

In the specific example embodiment of FIG. 34, it is assumed at 14g that the Client user operates the Client Device to scan or read (e.g., 1411, FIG. 14A) the product TID displayed on the display of the computer system. In at least one embodiment, Transaction Identification Device Application software running on the Client Device may be used to facilitate the TID scanning operation.

As shown at 16g, 18g, the Client Device may process the scanned TID information, and may present a GUI (e.g., FIG. 14B) prompting the Client user to input security authentication credentials such as, for example, a personalized passcode, PIN, password, biometric data, etc.

As shown at 20g, the Client Device may transmit information to the TISS 3406, such as, for example, one or more of the following (or combinations thereof):
Client user's authentication credentials
Client Device authentication credentials
product TID information
contextual transaction information
etc.

As shown at 22g, the TISS may process the information received from the Client Device. In at least one embodiment, the TISS may use at least a portion of the received information to initiate and/or perform one or more of the following operation(s)/action(s) (or combinations thereof):
authenticate and/or verify the Client user's authentication credentials;
authenticate and/or verify the Client Device's authentication credentials;
identify the Agent System using the product TID information;
determine the type of transaction(s) to be performed (e.g., online product purchasing and payment transaction);
determine a product identifier (e.g., merchant SKU) associated with the product TID information;
determine a Client user identifier;
determine a Client Device identifier;
determine URL information relating to the product webpage;
acquire additional information relating to the item or product associated with the product TID information;
etc.

In the present example of FIG. 34, it is assumed that the TISS successfully authenticates the Client user's credentials (and/or Client Device credentials). In at least one alternate embodiment, authentication of the Client user and/or Client Device may occur after the Client user has approved the processing of the transaction.

As shown at 24g, the TISS may provide various types of transaction information to the identified Agent System, such as, for example, one or more of the following (or combinations thereof):
product TID information;
product SKU information (and/or other types of information which may be used by the Agent System to properly identify the product/item selected by the Client user);
Client user information;
Client Device information;
transaction type information;
URL information relating to the product webpage;
etc.

As shown at 26g, the Agent System may process the received transaction information and generate order checkout information relating to the product purchasing transaction to be performed. In at least one embodiment, the order checkout information may include one or more of the following types of information (or combinations thereof):
Merchant/Agent identifier information
timestamp information
checkout information
item/product description information
discount/coupon information
transaction fee information
pricing information
SKU codes
total transaction amount
Customer ID or membership information
shipping/handling information
tax information
product availability information
etc.

As shown at 28g, the Agent System may transmit information to the TISS 3406, such as, for example, one or more of the following (or combinations thereof):
Agent System authentication credentials;
order checkout information;
information relating to permitted methods of payment;
etc.

As shown at 30g, the TISS may be operable to initiate or perform one or more of the following actions(s)/operation(s) (or combinations thereof):
process received order checkout information;
populate TISS database with transaction details;
dynamically generate customized transaction invoice information which, for example, may be suitable for display at the Client Device;
etc.

It may be appreciated that the specific example embodiment of FIG. 34 describes a specific implementation in which the Merchant System dynamically generates at least a portion of the order checkout information. However, in at least some other embodiments, the TISS may be operable to generate all (or at least a portion) of the order checkout information relating to one or more mobile device-online product purchase transaction(s). Accordingly, in at least some embodiments, some or all of the operations/actions described at 22g, 24g, 26g, 28g, and/or 30g may be modified or omitted, as desired.

As shown at 32g, the Client Device may fetch and/or receive from the TISS various types of information such as, for example, one or more of the following (or combinations thereof):
transaction information
order checkout information
agent information
payment method information
etc.

As shown at 34g, the Client Device may display one or more GUI(s) (e.g., FIG. 14C) which includes content relating to the order checkout information and/or available payment methods. In at least one embodiment, the GUI(s) may also include content prompting the user to select the type of payment method to be used. Additionally, in some embodiments, the GUI(s) may also include content prompting the user to accept or decline the transaction. In this particular example, it is assumed that the Client user accepts the transaction.

In other embodiments, the Client user may be presented with an option to add the item/product to the user's Universal Shopping Cart. This feature enables a user to purchase items from different merchants, and complete item ordering/purchasing via a Universal Shopping Cart Checkout procedure.

As shown at 40g, the Client Device may provide Client response information to the TISS for processing (46g). In at least one embodiment, the Client response information may include the Client user's input information relating to selected method of payment, transaction approval, etc.

In at least one embodiment, the TISS may be configured or designed to handle the processing of the Client payment transaction details, and to perform operation(s) which may be desirable in order to complete the TIS payment transaction between the Client user and the online merchant.

For example, as illustrated in the example embodiment of FIG. 34, at 44g, the TISS may provide the Client user's payment information (along with payment transaction instructions) to a payment gateway (3408) to thereby cause the payment gateway to process (50g) the Client user's payment transaction in accordance with the payment method/details provided by the Client user.

As shown at 50g and 52g, it is assumed that the Payment Gateway processes the Client user's payment transaction, and provides confirmation of the processed payment transaction details and status (e.g., success/failure) to the TISS. In alternate embodiments, payment may be processed and confirmed via a payment gateway designated by the merchant/merchant system.

As shown at 54b, the TISS may update TISS database with the received transaction payment details. In at least one embodiment, the TISS may also update appropriate records in the TISS database to reflect that User A (client) has successfully completed a payment transaction to User B (merchant) for a specified amount (e.g., along with other related payment transaction details such as, for example, timestamp information, payment method details, TID information, transaction reference information, etc.).

As shown at 51g, the TISS may update TISS database with the received transaction payment details. In at least one embodiment, the TISS may also update appropriate records in the TISS database to reflect that the Client user (and/or associated Client Device) has successfully completed a payment transaction to the online merchant for a specified amount (e.g., along with other related payment transaction details such as, for example, timestamp information, payment method details, order checkout information, transaction reference information, etc.).

As shown at 52g, the TISS may provide Invoice/Payment Transaction confirmation details to the Client Device, which may be displayed (53g), for example, at the Client Device (as illustrated, for example, in FIG. 14D).

As shown at 54g, the TISS may provide transaction payment confirmation information to the Agent System. The Agent System may process (58g) the transaction payment confirmation information (e.g., thereby completing the online purchasing transaction), and may generate order confirmation details.

As shown at 60g, the Agent System may provide the order confirmation details to the computer system 3404, which may be displayed (62g), for example, at the computer system display (as shown, for example, in FIG. 14E).

According to different embodiments, the interaction diagram illustrated in the example embodiment of FIG. 34 may be applied or adapted for use with other types of media advertising such, for example, newspapers, magazines, televisions, etc. In at least some of these embodiments, the TISS may be operable to provide notification(s) to the various devices/systems regarding transaction status/payment confirmation receipt information. In some embodiments, such notifications may be distributed via email, IM, and/or text messages.

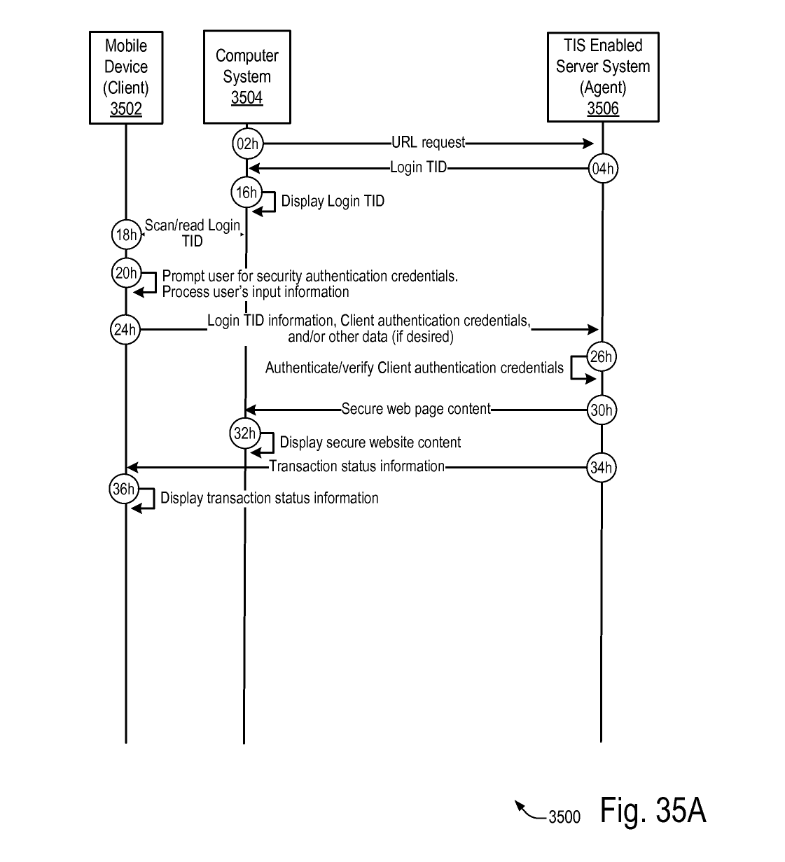

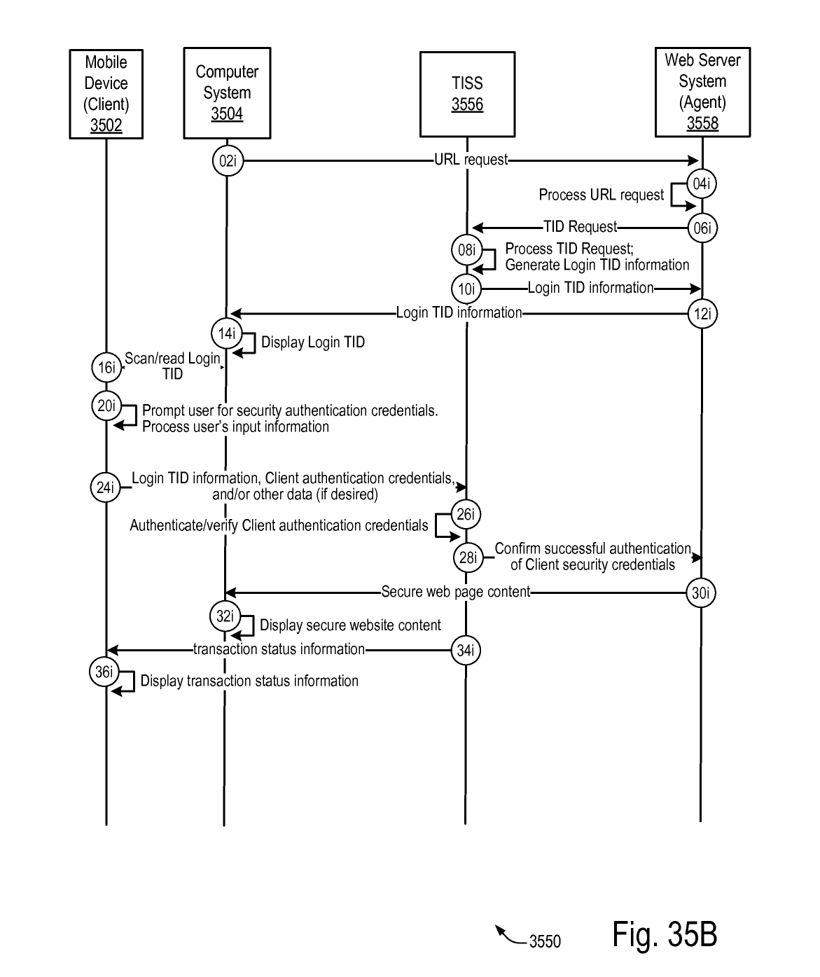

FIG. 35A shows a specific example embodiment of an interaction diagram illustrating various communication flows and actions which may be initiated and/or performed during an example mobile device-website authentication transaction. For purposes of illustration, the interaction diagram of FIG. 35A will now be described by way of example with reference to the FIGS. 13A-13D. In this particular example, it is assumed that a user of Mobile Device (Client Device) 3502 desires to use the mobile device to perform a website login transaction (and/or to access secure webpage content). Further, it is assumed that the user may access the desired website via computer system 3504. Additionally, in this particular example, it is assumed that access to the website and its content is managed by Server System (Agent System) 3506.

In at least one embodiment, Server System 3506 may be configured or designed to as a Transaction Identification System (TIS) Enabled Server System. Examples of various types of TIS enabled server system(s) may include, but are not limited to, one or more of the following (or combinations thereof):
a Transaction Identification Server System which may include webserver functionality;
a 3rd party Web Server System which is operatively coupled to a Local Transaction ID Appliance;
etc.

In the specific example embodiment of FIG. 35A, it is assumed that the Client user directs a web browser of computer system 3504 to a desired URL. In one embodiment, the URL may correspond to a website login interface. In another embodiment the URL may correspond to a secure webpage (or a webpage which includes secure content). In the present example, it is assumed that access to the URL is managed by Server System (Agent System) 3506. Accordingly, as shown at 2h, the computer system 3504 may provide a URL request to the Agent System for accessing secure content associated with the URL.

As shown at 4h, the Agent System may be operable to respond to the received URL request by providing to the computer system Login Transaction Identifier (Login TID) content (e.g., 1304, FIG. 13A) that is to be rendered and displayed (16h) at the computer system display (e.g., 1302, FIG. 13A).

In the specific example embodiment of FIG. 35A, it is assumed at 18h that the Client user operates the Client Device to scan or read (e.g., 1311, FIG. 13A) the Login TID displayed on the display of the computer system. In at least one embodiment, Transaction Identification Device Application software running on the Client Device may be used to facilitate the TID scanning operation.

In at least one embodiment, the Client Device may process the scanned TID information, and may present (20h) a GUI (e.g., FIG. 13B) prompting the Client user to input security authentication credentials such as, for example, a personalized passcode, PIN, password, biometric data, etc.

As shown at 24h, the Client Device may transmit information to the Agent System 3506, such as, for example, one or more of the following (or combinations thereof):
Client user's authentication credentials
Client Device authentication credentials
mobile device information
Login TID information
Client Device geolocation information
contextual transaction information
etc.

As shown at 26h, the Agent System may process the information received from the Client Device. In at least one embodiment, the Agent System may use at least a portion of the received information to initiate and/or perform one or more of the following operation(s)/action(s) (or combinations thereof):
authenticate and/or verify the Client user's authentication credentials;
authenticate and/or verify the Client Device's authentication credentials;
determine the type of transaction(s) to be performed (e.g., user login/identity authentication/verification);
etc.

In the present example of FIG. 35A, it is assumed that the Agent System successfully authenticates the Client user's credentials (and/or Client Device credentials).

In at least one embodiment, after successfully authenticating the Client user's security credentials, the Agent System may provide (30h) computer system 3504 with access to secure webpage content associated with the URL request previously received, which, in turn, may be displayed (32h) at the computer system display (e.g., as shown in FIG. 13D).

In some embodiments, after successfully authenticating the Client user's security credentials, the Agent System may initiate an auto login procedure, wherein the Client user (and associated computer system 3504) is automatically logged into (and/or registered with) the Server System to thereby allow secure webpage content to be accessed by the computer system and presented at the computer and display.

As illustrated in the example embodiment of FIG. 35A, the Agent System may provide (34h) updated transaction status information to the Client Device, which, for example, may be displayed (36h) at the Client Device display (e.g., as shown in FIG. 13C)

FIG. 35B shows an alternate example embodiment of an interaction diagram illustrating various communication flows and actions which may be initiated and/or performed during an example mobile device-website authentication transaction. For purposes of illustration, the interaction diagram of FIG. 35B will now be described by way of example with reference to the FIGS. 13A-13D. In this particular example, it is assumed that a user of Mobile Device (Client Device) 3502 desires to use the mobile device to perform a website login transaction (and/or to access secure webpage content). Further, it is assumed that the user may access the desired website via computer system 3504. Additionally, in this particular example, it is assumed that access to the website and its content is managed by Web Server System (Agent System) 3558. In at least one embodiment, Server System 3558 may be configured or designed to as a Non-TIS Enabled Server System.

In the specific example embodiment of FIG. 35B, it is assumed that the Client user directs a web browser of computer system 3504 to a desired URL. In one embodiment, the URL may correspond to a website login interface. In another embodiment the URL may correspond to a secure webpage (or a webpage which includes secure content). In the present example, it is assumed that access to the URL is managed by Server System (Agent System) 3558. Accordingly, as shown at 2i, the computer system 3504 may provide a URL request to the Agent System for accessing secure content associated with the URL.

In at least one embodiment, the Agent System may be operable to process (4i) the URL request and send (6i) a TID request to the Transaction Identification Server System (TISS) 3556.

As shown at 8i, the TISS may be operable to process the TID request and generate one or more Login TID information to be provided (10i) to the Agent System in response to the TID request.

As shown at 12i, the Agent System may provide the Login TID information to the computer system 3504 in response to the Beasley received URL request. In at least one embodiment, the Login TID information may include machine-readable content (e.g., QR code) that may be rendered and displayed (14i) at the computer system display.

In the specific example embodiment of FIG. 35B, it is assumed at 16i that the Client user operates the Client Device to scan or read the Login TID displayed on the display of the computer system. In at least one embodiment, Transaction Identification Device Application software running on the Client Device may be used to facilitate the TID scanning operation.

In at least one embodiment, the Client Device may process the scanned TID information, and may present (20i) a GUI prompting the Client user to input security authentication credentials.

As shown at 24i, the Client Device may transmit information to the TISS, such as, for example, one or more of the following (or combinations thereof): Client user's authentication credentials, Client Device authentication credentials, mobile device information, Login TID information, Client Device geolocation information, contextual transaction information, etc.

As shown at 26i, the TISS may process the information received from the Client Device. In at least one embodiment, the TISS may use at least a portion of the received information to initiate and/or perform one or more of the following operation(s)/action(s) (or combinations thereof): authenticate and/or verify the Client user's authentication credentials; authenticate and/or verify the Client Device's authentication credentials; determine the type of transaction(s) to be performed (e.g., user login/identity authentication/verification); etc. In the present example of FIG. 35B, it is assumed that the Agent System successfully authenticates the Client user's credentials (and/or Client Device credentials).

As illustrated in the example embodiment of FIG. 35B, the TISS may provide (28i) the Agent System with notification and/or information relating to the successful authentication/verification of the Client security credentials.

In at least one embodiment, after successfully authenticating the Client user's security credentials, the Agent System may provide (30i) computer system 3504 with access to secure webpage content associated with the URL request previously received, which, in turn, may be displayed (32i) at the computer system display.

In some embodiments, after successfully authenticating the Client user's security credentials, the Agent System may initiate an auto login procedure, wherein the Client user (and associated computer system 3504) is automatically logged into (and/or registered with) the Server System to thereby allow secure webpage content to be accessed by the computer system and presented at the computer and display.

As illustrated in the example embodiment of FIG. 35B, the Agent System may provide (34i) updated transaction status information to the Client Device, which, for example, may be displayed (36i) at the Client Device display.

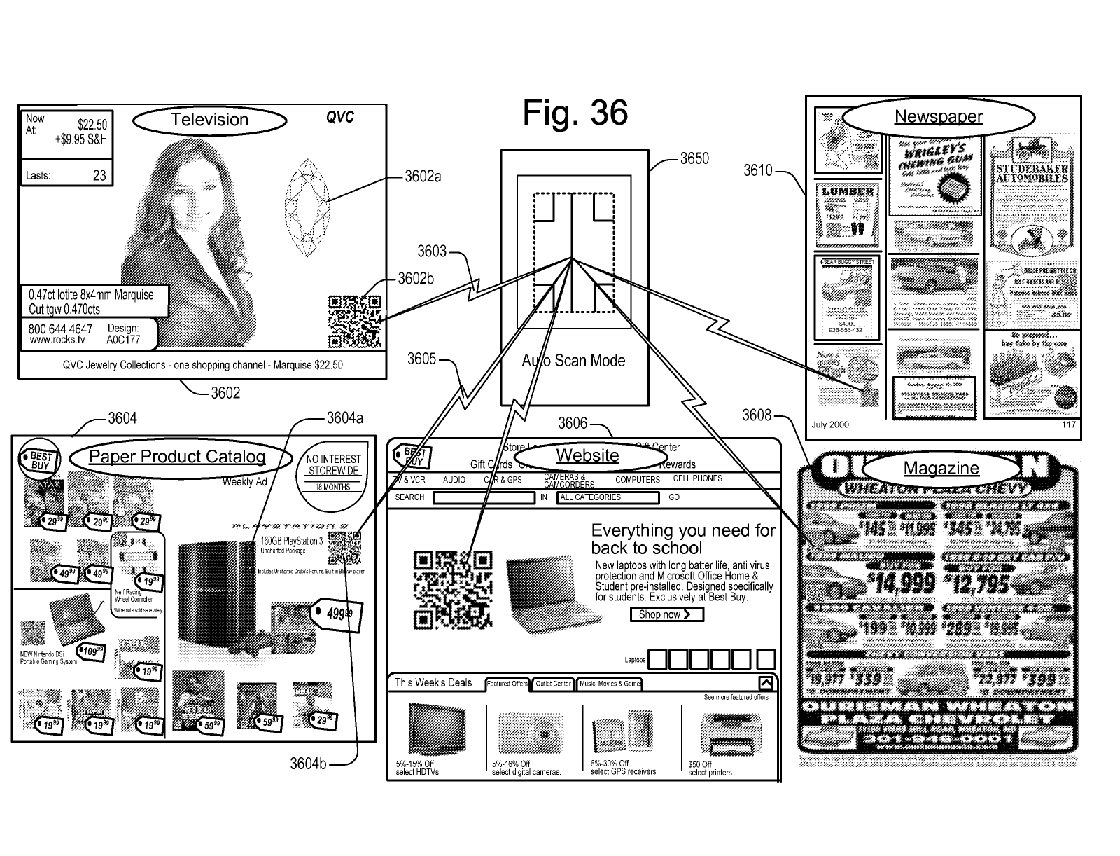

FIG. 36 shows an example and illustration of universal shopping cart (USC) functionality which may be provided by the Transaction Identification System, in accordance with a specific embodiment. Using TIS technology described herein, users can add products and services to their shopping cart from multiple merchants. Users may purchase products from different advertising media such as TV, magazines, new papers classified, web sites etc.

In at least one embodiment, various USC actions/operations may be performed by a user operating a mobile device. By way of example with reference to FIG. 36, and for purposes of illustration, it is assumed that a user operating a TIS-enabled mobile device (e.g., which, for example, may include a Transaction Identification Device Application running at the mobile device) desires to add several different products and/or services from multiple vendors and advertising media to the user's universal TIS shopping cart. According to different embodiments, such USC activities may include, but are not limited to, operating the mobile device (e.g., 3650) (and/or other components of the Transaction Identification System) to perform one or more of the following operations, actions, procedures (or combinations thereof):
1) Scan a first TID one from TV screen (e.g., 3602).
2) Receives first item information and decides to add the item to the TIS shopping cart
3) Scan a second TID from a paper catalog (e.g., 3608)
4) Receives seconds item information and add adds it to the TIS shopping cart
5) Scan a third TID from a web site (e.g., 3604)
6) Receives third item information and adds it to the TIS shopping cart
7) Scan a fourth TID from a magazine (e.g., 3608)
8) Receives fourth item information and adds it to the TIS shopping cart
9) Scan a fifth TID from a newspaper (e.g., 3610)
10) Receives fifth item information and adds it to the TIS shopping cart
11) Receives input from user to proceed to checkout.
12) Receives user input login information and authenticates to the TISS.
13) Provides/confirms users TIS shopping cart information with TISS
14) Upon successful authentication the TISS, TISS may communicate with respective merchants and informs them about their respective item order(s)/purchase(s).
15) User select method of payment (e.g., for one or more orders) and accept or declines the transaction(s).
16) TISS process payment through configured gateways and informs vendors about the sale
17) User receives confirmation receipt.

In at least one embodiment, the mobile device may be operable to add items to the user's universal TIS shopping cart while off line (e.g., while in airplane mode, while not connected to Internet, cellular network and/or other networks, etc.) process. Item information upon scanning the TID can be available off line (e.g., via local cache) or via Internet.

For example, while a user is flying on an airplane and operating his mobile device in airplane mode, the mobile device may launch the a Transaction Identification Device Application at the mobile device, and use the mobile device to adds shopping cart items from a Sky Mall catalog to the user's universal shopping cart. In one embodiment, if the Transaction Identification Device Application detects that it is unable to communicate with the Transaction Identification Server System, it may store or cache the USC information locally and provide the USC information to the TISS at a later time, when connectivity to the TISS is re-established.

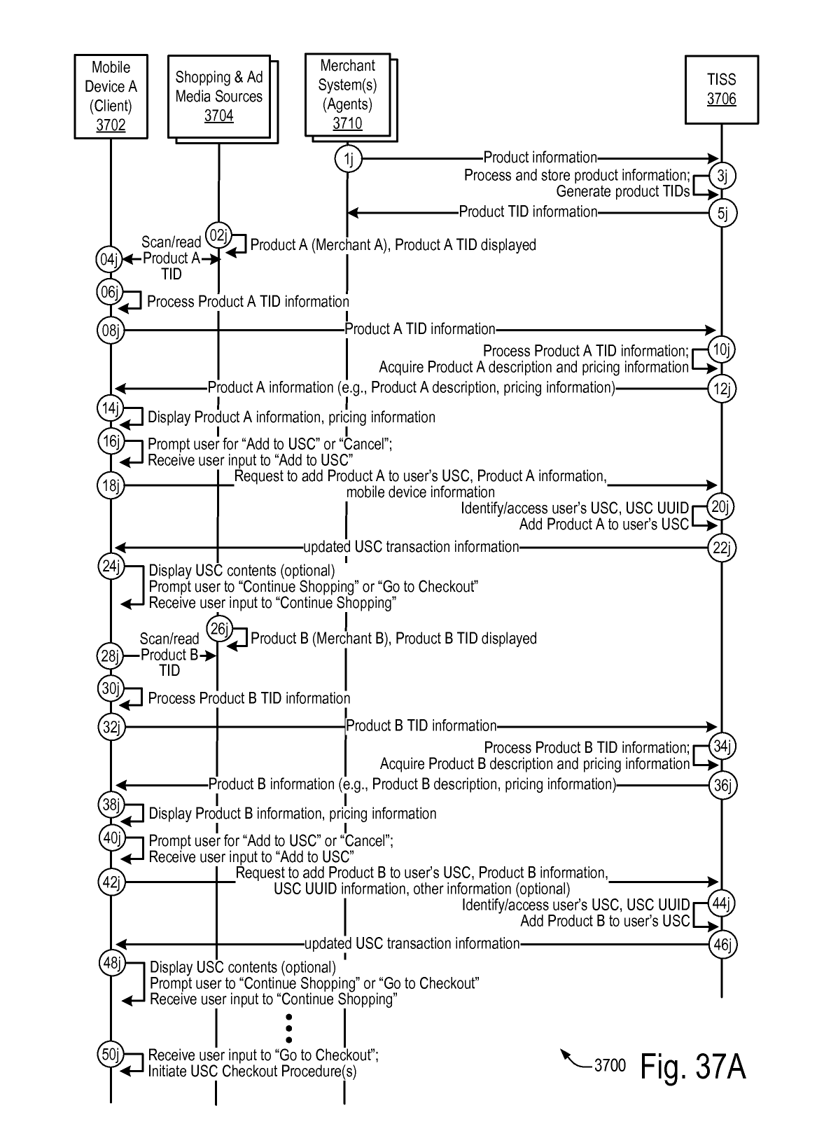

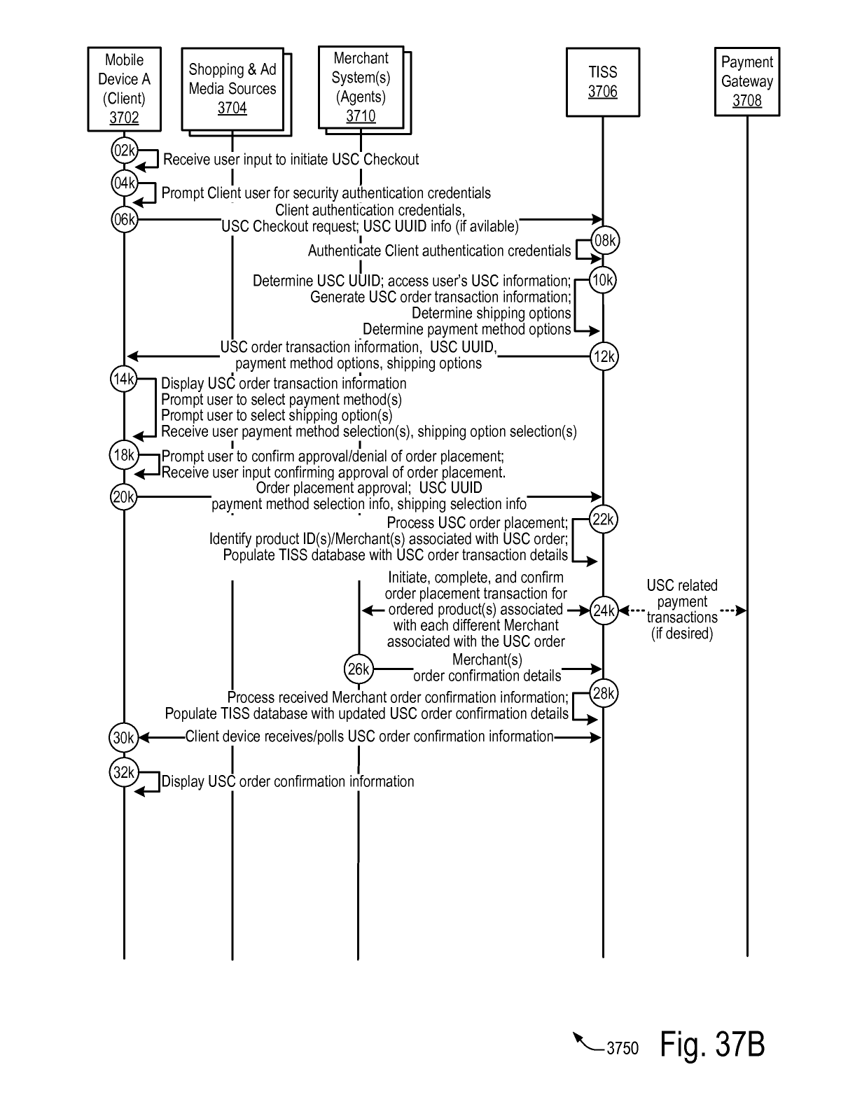

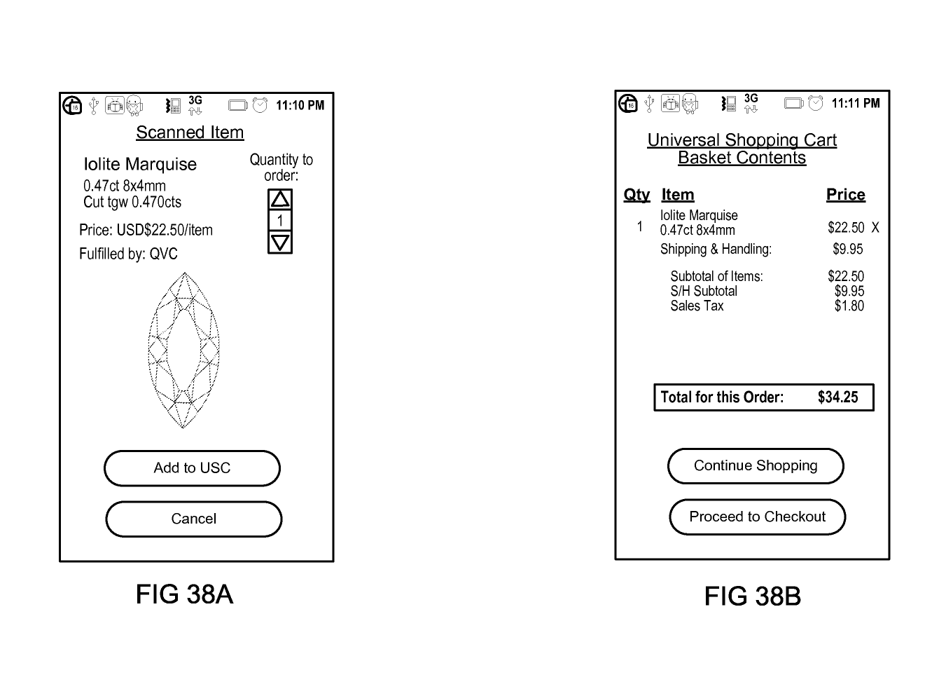

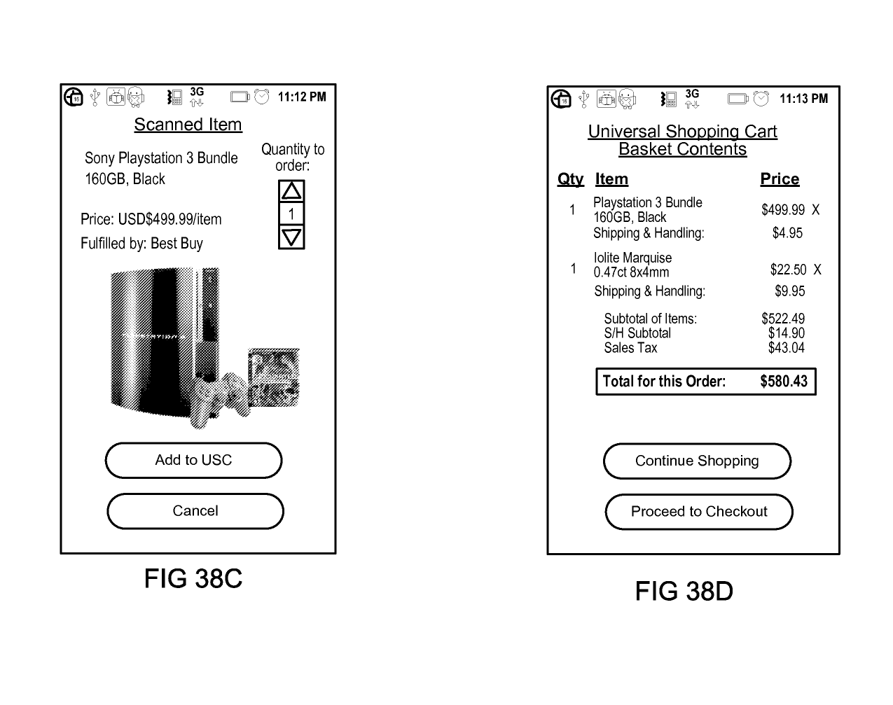

FIG. 37A shows a specific example embodiment of an interaction diagram illustrating various communication flows and actions which may be initiated and/or performed during a plurality of example online universal shopping cart (USC) transactions. For purposes of illustration, the interaction diagram of FIG. 37A will now be described by way of example with reference to the FIGS. 38A-38D. In this particular example, it is assumed that a user of Mobile Device A (Client Device) desires to use his mobile device to select and add products and/or services (e.g., from multiple different merchants 3710, and/or from different shopping/media sources 3704) to the user's universal shopping cart, which, for example, has been enabled using Transaction Identification System technology. Additionally, in this specific example embodiment, it is assumed that the Client Device 3702 Is able to establish connectivity to the Transaction Identification Server System 3706.

In at least one embodiment, as illustrated in the example embodiment of FIG. 37A at 1j, 3j, and 5j, it is assumed that a plurality of different merchants systems (Agent Systems) (e.g., as represented at 3710) send (1j) their respective product information to the TISS for assignment of product TIDs. In at least one embodiment, at least a portion of the communications may be conducted via a TIS POS API. According to different embodiments, the product information may include, but are not limited to, one or more of the following types of information (or combinations thereof): product name, product description, product shipping information, product pricing information, product SKU, etc.). According to different embodiments, the product information can be sent to the TISS as a group or batch of items or individually.

In at least one embodiment, the TISS may process and store (3j) the product information at a TISS database, and may be operable to generate (3j) a unique product TID for each (or for selected) identified item/product. As shown at 5j, the TISS may provide may respective set of product TID information to each of the plurality of different merchants systems, wherein a given set of product TIDs is associated with a respective set of products, items, and/or services relating to the product information provided to the TISS by given merchant system. Thus, for example, according to different embodiments, a given product TID may be assigned to represent one or more of the following (or combinations thereof):
an item or product
a group of items/products
specific service
a coupon, discount code, or promotional code
a wager
other types of deliverables which may be purchased or sold
etc.

According to different embodiments, the product TIDs may be represented in various formats such as, for example, one or more of the following (or combinations thereof):
raw data (e.g., alpha-numeric data and/or other types of data which has not yet been rendered to image);
images and/or other graphical content (e.g., suitable for printing in magazine or newspapers);
other types of machine-readable content;
etc.

One advantage of this technique (e.g., from the merchant's perspective) is that this process may be automated using the TIS APIs. For example, in at least one embodiment, product information may be automatically and/or dynamically retrieved from the merchant database directly and communicated to the TISS each time there is a product update or new product.

In the specific example embodiment of FIG. 37A, it is assumed at 2j that the Client user has identified a first item to be purchased. For purposes of illustration, it is assumed that the first item relates to a jewelry product (e.g., 3602a, FIG. 36) that is being advertised and displayed on a television display (e.g., 3602, FIG. 36) that is visible to the Client user.

As illustrated in the example embodiment of FIG. 36, television display 3602 is depicted as displaying content relating to an offer for sale of an item of jewelry (e.g., 3602a). A portion of the displayed television content includes an image of a product TID 2602b (herein referred to as the “product A TID”, which may be used by the Transaction Identification System to uniquely identify (and purchase) that particular item of jewelry from that particular merchant (e.g., QVC).

According to specific embodiments, the product TID may include machine-readable information which, for example, may be embedded or encoded into the displayed product TID (e.g., 3804). According to different embodiments, such product TID information may include, but is not limited to, one or more of the following (or combinations thereof):
a randomized alpha-numeric string
product/item name
product/item description
merchant identifier information
product/item pricing information
shipping/handling information
webpage URL
etc.

In the specific example embodiment of FIG. 37A, it is assumed at 4j that the Client user operates the Client Device to scan or read (e.g., 3603, FIG. 36) the product A TID displayed on the television display.

In at least one embodiment, Transaction Identification Device Application software running on the Client Device may be used to facilitate the product TID scanning operation. Additionally, in at least one embodiment, the Transaction Identification Device Application may be operable to invoke execution of Client/Agent Online/Offline Transaction Processing Procedure(s) (e.g., such as that illustrated and described with respect to FIG. 41A) in order to determine whether to operate in accordance with an online transaction mode of operation or in accordance with an off-line transaction mode of operation. In the specific example embodiment of FIG. 37A and is assumed that the Transaction Identification Device Application has been configured to operate in accordance with an online transaction mode of operation.

Accordingly, the Client Device may process (6j) the scanned product TID information and transmit (8j) the scanned product A TID information to the TISS.

In at least one embodiment, the processing of the scanned product TID information at the Client Device may include temporarily storing or caching the scanned product TID information in a universal shopping cart database which is instantiated within the local memory of the Client Device.

As shown at 10j the TISS may process the received product A TID information, and acquire product description, pricing information and/or other related product information for the item/product which is associated with the product A TID. In at least one embodiment, at least a portion of the acquired product information may be retrieved from information stored locally at one or more TISS databases. In some embodiments, the TISS may be operable to retrieve (e.g., via one or more API interfaces) at least a portion of the product information from the Merchant System corresponding to the merchant (e.g., Best Buy) that is associated with the product A TID.

As shown at 12j, the TISS may provide various types of product information to the Client Device, such as, for example, one or more of the following (or combinations thereof):
Merchant/Agent identifier information
item/product description information
discount/coupon information
transaction fee information
pricing information
SKU codes
universal shopping cart information
shipping/handling information
tax information
product availability information
image(s) of the product/item
etc.

As shown at 14j, the Client Device may process the received product information and display one or more GUI(s) (e.g., FIG. 38A) which includes at least a portion of the product information associated with the scanned product A TID. The GUI(s) may also include content prompting (16j) the user to provide instructions for initiating one or more of the following actions/operations (or combinations thereof): add the identified item to the user's universal shopping cart (USC), cancel the current activity, etc. In at least one embodiment, the GUI(s) may also provide an option for the user to provide input as to the desired quantity of the item which is to be added to the user's USC. In other embodiments, the Client user may increase quantity of an item to be added to the user's USC by repeating a scan of the product A TID. In this particular example, it is assumed that the Client user elects to add the item corresponding to product A TID (e.g., default quantity=1) to the user's USC.

As shown at 18j, the Client Device may transmit information to the TISS 3706, such as, for example, one or more of the following (or combinations thereof):
Instructions for adding an item associated with the product A TID to the user's USC;
product A TID information;
USC UUID information (if available)
Client Device identifier information
item quantity information
etc.

In at least one embodiment, if the Transaction Identification Device Application (and/or Client Device) detects that it is unable to communicate with the Transaction Identification Server System (e.g., in off-line mode), it may allow the user to seamlessly continue universal shopping cart transaction activities by accessing product information (such as, product name, product description, merchant name, pricing information, etc.) which may be embedded or encoded in The product TID. Additionally, while operating in off-line mode, the Transaction Identification Device Application may store or cache the user's USC information/activities in local memory at the Client Device, and may provide the cached USC information to the TISS at a later time, when connectivity to the TISS is re-established.

As shown at 20j, the TISS may process the information received from the Client Device, and initiate and/or perform one or more of the following operation(s)/action(s) (or combinations thereof):
identify (or assign) a USC UUID which is associated with the Client user's universal shopping cart (and/or associated with the USC transaction);
access the Client user's universal shopping cart information;
add the item associated with the product A TID to the user's USC;
update TISS database information to reflect recent USC transaction activity;
generate updated USC basket/checkout information;
etc.

As shown at 22j, the TISS the may provide the Client Device with updated USC transaction information relating to the Client user's USC. In at least one embodiment, examples of such updated USC transaction information may include, but are not limited to, one or more of the following (or combinations thereof):
updated information relating to the user's USC
USC UUID information
etc.

As shown at 24j, the Client Device may process the received information and display one or more GUI(s) (e.g., FIG. 38B) which includes updated information relating to the Client user's USC. The GUI(s) may also include content prompting the user to provide instructions for initiating one or more of the following actions/operations (or combinations thereof): continue shopping, edit shopping cart, proceed to checkout, end USC shopping session, leave/cancel current activity, etc. In this particular example, it is assumed that the Client user elects to continue shopping.

Accordingly, in the specific example embodiment of FIG. 37A, it is assumed at 26j that the Client user has identified a second item to be added to the user's USC. For purposes of illustration, it is assumed that the second item relates to a video game console (e.g., 3604a) that is being advertised and displayed in a paper product catalog display (e.g., 3604, FIG. 36) which is visible to the Client user.

As shown at 28j, it is assumed that the Client user operates the Client Device to scan or read (e.g., 3605, FIG. 36) the product B TID displayed adjacent to the video game console item in the paper product catalog display. The Client Device may process (30j) the scanned product TID information and transmit (32j) the scanned product B TID information to the TISS. In at least one embodiment, the processing of the scanned product TID information at the Client Device may include temporarily storing or caching the scanned product TID information in a universal shopping cart database which is instantiated within the local memory of the Client Device.

As shown at 34j the TISS may process the received product B TID information, and acquire product description, pricing information and/or other related product information for the item/product which is associated with the product B TID. In at least one embodiment, at least a portion of the acquired product information may be retrieved from information stored locally at one or more TISS databases. In some embodiments, the TISS may be operable to retrieve (e.g., via one or more API interfaces) at least a portion of the product information from the Merchant System corresponding to the merchant (e.g., Best Buy) that is associated with the product B TID.

As shown at 36j, the TISS may provide various types of product information to the Client Device.

As shown at 38j, the Client Device may process the received product information and display one or more GUI(s) (e.g., FIG. 38C) which includes at least a portion of the product information associated with the scanned product B TID. The GUI(s) may also include content prompting (40j) the user to provide instructions for initiating one or more of the following actions/operations (or combinations thereof): add the identified item to the user's universal shopping cart (USC), cancel the current activity, etc. In this particular example, it is assumed that the Client user elects to add the item corresponding to product B TID (e.g., default quantity=1) to the user's USC.

As shown at 42j, the Client Device may transmit information to the TISS 3706, such as, for example, one or more of the following (or combinations thereof):
Instructions for adding an item associated with the product B TID to the user's USC;
product B TID information;
USC UUID information (if available)
Client Device identifier information
item quantity information
etc.

As shown at 44j, the TISS may process the information received from the Client Device, and initiate and/or perform one or more of the following operation(s)/action(s) (or combinations thereof):
identify (or assign) a USC UUID which is associated with the Client user's universal shopping cart (and/or associated with the USC transaction);
access the Client user's universal shopping cart information;
add the item associated with the product B TID to the user's USC;
update TISS database information to reflect recent USC transaction activity;
generate updated USC basket/checkout information;
etc.

As shown at 46j, the TISS the may provide the Client Device with updated USC transaction information relating to the Client user's USC. In at least one embodiment, examples of such updated USC transaction information may include, but are not limited to, one or more of the following (or combinations thereof):
updated information relating to the user's USC
USC UUID information
etc.

As shown at 48j, the Client Device may process the received information and display one or more GUI(s) (e.g., FIG. 38B) which includes updated information relating to the Client user's USC. The GUI(s) may also include content prompting the user to provide instructions for initiating one or more of the following actions/operations (or combinations thereof): continue shopping, edit shopping cart, proceed to checkout, end USC shopping session, leave/cancel current activity, etc.

In at least one embodiment, the Client user may elect to continue shopping, and add subsequent items to the user's USC by the product TID associated with the desired item. As shown at 50j, the user may provide instructions at the Client Device to proceed to checkout. In response, the Client Device (and TISS) may initiate one or more USC Checkout Procedures, as described in greater detail, for example, with respect to FIG. 37B.

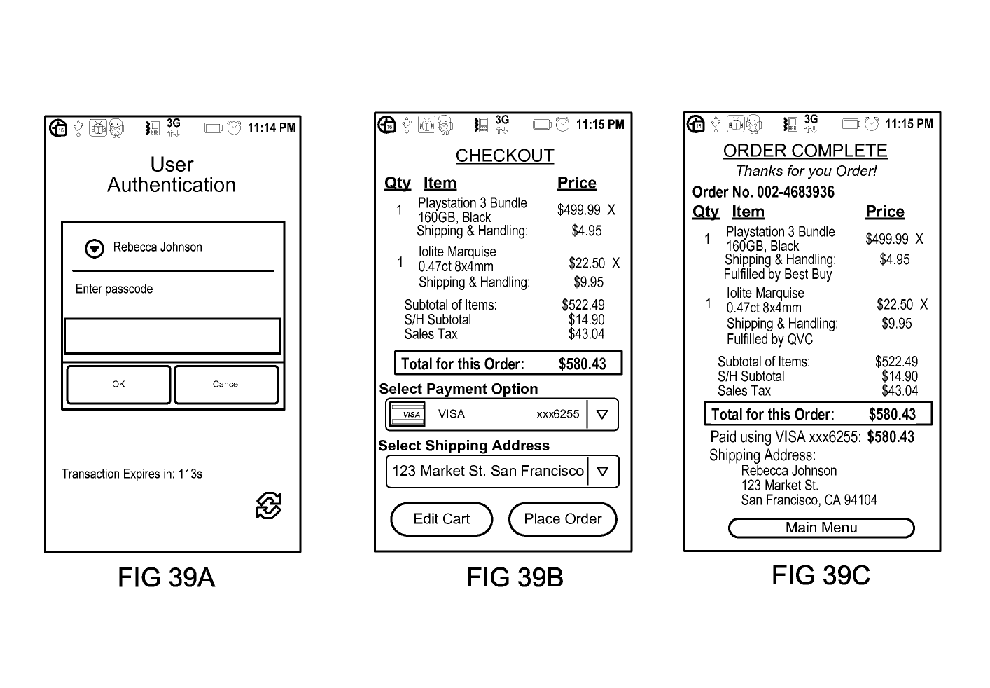

FIG. 37B shows a specific example embodiment of an interaction diagram illustrating various communication flows and actions which may be initiated and/or performed during a plurality of example of a universal shopping cart (USC) checkout transaction. For purposes of illustration, the interaction diagram of FIG. 37B will now be described by way of example with reference to the FIGS. 39A-39C. In this particular example, it is assumed that a user of Mobile Device A (Client Device) desires to use his mobile device to perform a universal shopping cart checkout transaction. Additionally, in this specific example embodiment, it is assumed that the Client Device 3702 is able to establish connectivity to the Transaction Identification Server System 3706.

As illustrated in the example embodiment of FIG. 37B, it is assumed at 2k that the Client user has provided instructions at the Client Device to initiate a USC checkout procedure.

As shown at 4k, the Client Device may present a GUI (e.g., FIG. 39A) prompting the Client user to input security authentication credentials.

As shown at 6k, the Client Device may transmit information to the TISS 37B06, such as, for example, one or more of the following (or combinations thereof):
Client user's authentication credentials
Client Device authentication credentials
USC checkout request instructions
USC UUID information (if available)
etc.

As shown at 8k, 10k, the TISS may process the information received from the Client Device. In at least one embodiment, the TISS may use at least a portion of the received information to initiate and/or perform one or more of the following operation(s)/action(s) (or combinations thereof):
authenticate and/or verify the Client user's authentication credentials;
authenticate and/or verify the Client Device's authentication credentials;
determine/identify USC UUID;
access user's USC information;
generate USC order transaction information;
determine shipping options;
determine payment method options;
etc.

In the present example of FIG. 37B, it is assumed that the TISS successfully authenticates the Client user's credentials (and/or Client Device credentials). In at least one alternate embodiment, authentication of the Client user and/or Client Device may occur after the Client user has approved the processing of the USC checkout transaction.

As shown at 12k, the TISS may provide various types of USC checkout transaction information to the identified Client Device, such as, for example, one or more of the following (or combinations thereof):
USC order transaction information,
USC UUID information,
payment method options,
shipping options,
etc.

As shown at 14k, 18k the Client Device may process the received information and initiate and/or perform one or more of the following operation(s)/action(s) (or combinations thereof):
Display USC order transaction information
Prompt user to select payment method(s) (e.g., FIG. 39)
Prompt user to select shipping option(s) (e.g., FIG. 39)
Receive user payment method selection(s), shipping option selection(s)
Prompt user to confirm approval/denial of order placement;
Receive user input confirming approval/denial of order placement.
etc.

As shown at 20k, the Client Device may provide order placement information to the TISS for processing (22k). In at least one embodiment, the order placement information may include, for example, one or more of the following (or combinations thereof):
Order placement approval/instructions;
USC UUID information;
payment method selection information;
shipping selection information;
etc.

In at least one embodiment, the TISS may use at least a portion of the received information to initiate and/or perform one or more of the following operation(s)/action(s) (or combinations thereof):
Process USC order placement;
Identify product ID(s)/Merchant(s) associated with USC order;
Populate TISS database with updated USC order transaction details;
etc.

In at least one embodiment, the TISS may be configured or designed to handle the processing of the Client payment transaction details, and to perform operation(s) which may be desirable in order to successfully complete the USC order checkout transaction.

For example, as shown at 24k, the TISS may automatically and dynamically initiate and/or perform one or more operation(s)/action(s) which may be desirable or required to Initiate, complete, and confirm order placement transaction(s) for ordered product(s) associated with each of the different merchants/Merchant Systems associated with the Client user's USC order. Examples of such operation(s)/action(s) may include, but are not limited to, one or more of the following (or combinations thereof):
exchange order transaction information via one or more merchant APIs
send, receive, and/or track product/item details
send, receive, and/or track payment details
send, receive, and/or track shipping details
execute order placement
send, receive, and/or track order confirmation details received (26k) from one or more Merchant System(s)
process (28k) received Merchant order confirmation information
populate TISS database with updated USC order transaction details
initiate payment processing transactions via one or more payment gateways (e.g., 3708)
etc.

In at least one embodiment, after the TISS has confirmed completion of a portion of a USC checkout order transaction, the TISS may inform the appropriate Merchant System(s) about the updated order status. The merchant(s) may then proceed to ship the item if the order transaction and associated payment transaction(s) have been confirmed as being successfully completed.

As shown at 30k, the Client Device may receive or access USC order confirmation information from TISS, and may display (32k) content relating to the USC order confirmation information at the Client Device (e.g., FIG. 39C).

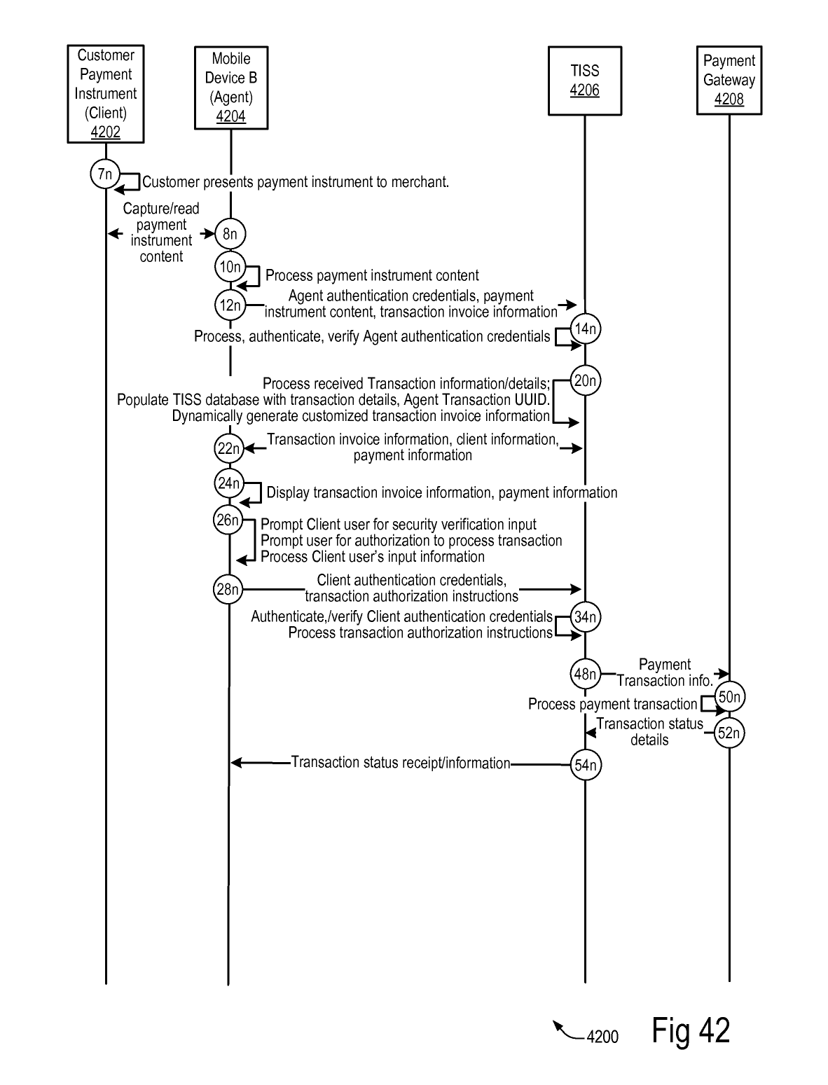

FIG. 42 shows a specific example embodiment of an interaction diagram illustrating various communication flows and actions which may be initiated and/or performed during an example mobile payment transaction in which a user's credit card may be used as a payment instrument in the transaction. In this particular example, it is assumed that the user of Mobile Device B (4204) is a merchant or vendor who desires to receive a payment from a customer (Client 4202) for goods and/or services. For purposes of illustration, the interaction diagram of FIG. 42 will now be described by way of example with reference to the FIGS. 43A-C.

As illustrated in the example embodiment of FIG. 42, it is assumed at 8n the merchant operates the Agent Device 4204 to perform a scan, read and/or image capture of the Client's physical credit card. For example, according to different embodiments, Mobile Device B may be operable to perform one or more of the following (or combinations thereof):
perform optical scan/image capture of credit card (e.g., FIG. 43A)
read payment instrument info using NFC/RFID/Bluetooth (e.g., FIG. 43C)
read TID image printed on payment instrument (e.g., FIG. 43B)

As shown at 10n, the Agent System may process the scanned TID information.

As shown at 12n, the Agent System may transmit information to the TISS 4206, such as, for example, one or more of the following (or combinations thereof): Agent System authentication credentials, payment instrument content, transaction invoice information, TID information, etc.

As shown at 14n, the TISS may process the information received from the Agent System. In at least one embodiment, the TISS may use at least a portion of the received information to authenticate and/or verify the POS agent's/agent's authentication credentials. In the present example of FIG. 42, it is assumed that the TISS successfully authenticates the POS agent's credentials (and/or Agent System credentials).

As shown at 20n, the TISS may be operable to initiate or perform one or more of the following actions(s)/operation(s) (or combinations thereof):
process received transaction information/details;
populate TISS database with transaction details,
dynamically generate customized transaction invoice information which, for example, may be suitable for display at the Agent System;
etc.

As shown at 22n, the TISS may provide transaction invoice information to the Agent System. In at least one embodiment, the TISS may also be operable to determine or identify one or more payment methods which are available to the Client, and to provide information relating to such payment methods to the Agent System.

As shown at 24n, the Agent System may display one or more GUI(s) which includes content relating to the transaction invoice information and available payment methods. In at least one embodiment, the GUI(s) may also include content prompting the user to select the type of payment method to be used. Additionally, in some embodiments, the GUI(s) may also include content prompting the user to accept or decline the transaction. In this particular example, it is assumed that the Client accepts the transaction.

As shown at 26n, the Agent System may present a GUI prompting the Client to input security authentication credentials such as, for example, a personalized passcode, PIN, password, biometric data, signature, etc.

As shown at 28n, the Agent System may provide various types of information to the TISS for processing such as, for example, one or more of the following (or combinations thereof): Client's security authentication credential; Client's input information relating to selected method of payment, transaction approval, etc.; Agent System authentication credentials; etc.

As shown at 34n, the TISS may process the information received from the Agent System. In at least one embodiment, the TISS may use at least a portion of the received information to authenticate and/or verify the Client's security credentials and/or Agent System's security credentials. In the present example of FIG. 42, it is assumed that the TISS successfully authenticates the Client's credentials (and Agent System's credentials). In at least one embodiment, authentication of the Client and/or Agent System may occur before the Client has approved the details of the invoiced transaction.

For example, as illustrated in the example embodiment of FIG. 42, at 48n, the TISS may provide the Client's payment information (along with payment transaction instructions, if desired) to a payment gateway (4208) to thereby cause the payment gateway to process (50n) the Client's payment transaction in accordance with the payment method/details provided by the Client.

As shown at 50n and 52n, it is assumed that the Payment Gateway processes the Client's payment transaction, and provides confirmation of the processed payment transaction details and status (e.g., success/failure) to the TISS.

As shown at 54n, the TISS may update TISS database with the received transaction payment details. In at least one embodiment, the TISS may also update appropriate records in the TISS database to reflect that the Client has successfully completed a payment transaction to the POS merchant for a specified amount (e.g., along with other related payment transaction details such as, for example, timestamp information, payment method details, TID information, transaction reference information, etc.).

In at least one embodiment, TISS may include an OCR Processing Engine (e.g., 2934, FIG. 29A) which, for example, may be operable to perform image processing and optical character recognition of images such as those captured by a mobile device camera, for example. In at least one embodiment, the OCR Processing Engine may be configured or designed to process an image of a credit card or ATM card (e.g., captured by a mobile device camera), and extract relevant information from the credit/ATM card image such as, for example, one or more of the following (or combinations thereof):
credit card account number
financial institution information (e.g., bank name, Visa, MasterCard, etc.)
TID information (e.g., as illustrated, for example, in FIG. 43B)
card holder name
card expiration date
card type information (e.g., credit card, ATM card, etc.)
etc.

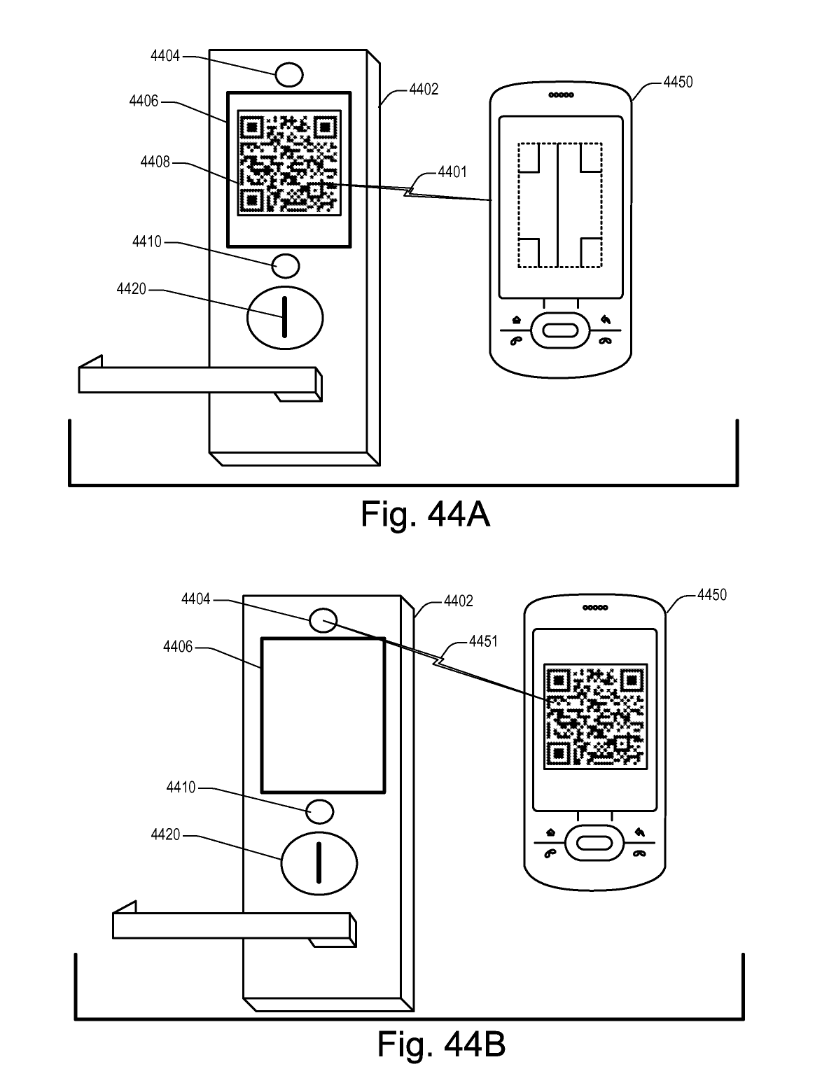

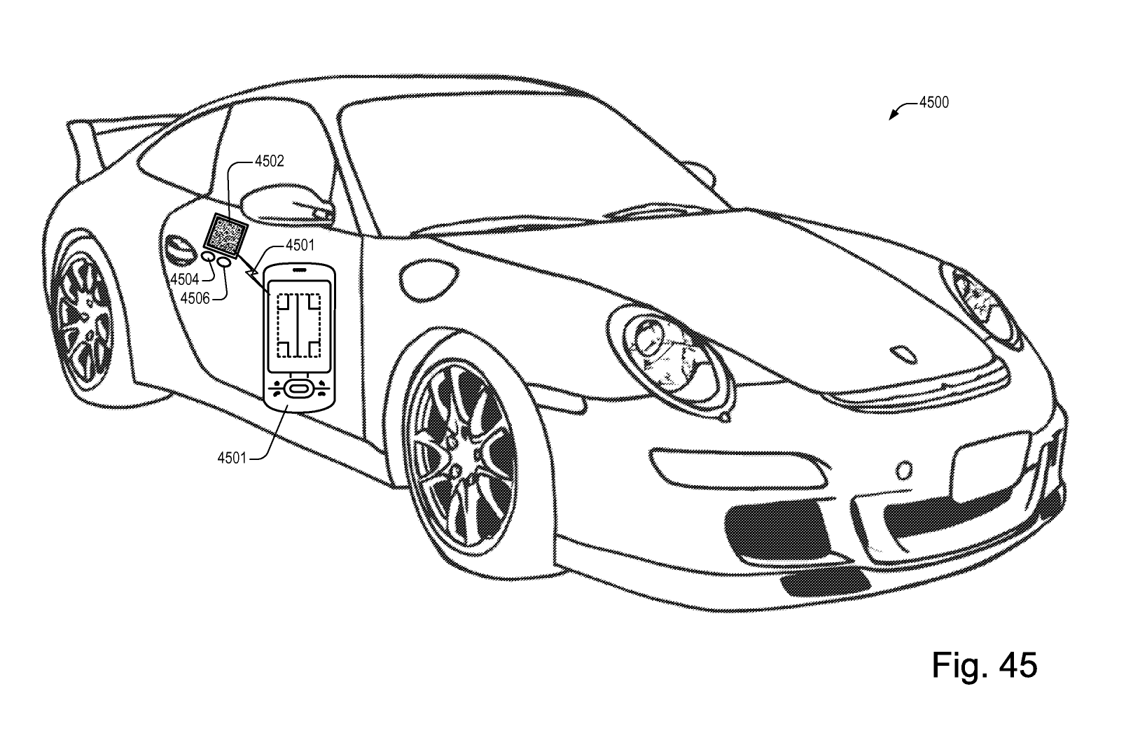

FIGS. 44A, 44B, and 45 illustrate example embodiments of different TIS-enabled electro-mechanical actuated the locking mechanisms.

TIS lock system can be implemented in places where secure access is needed. Lock are hardware devices capable of displaying TIS TIDs on the screen and communicate to the TIS server to complete the transaction. Upon a successful authentication with the mobile device they mechanically unlock and give access to the secured location or space.

In at least one embodiment, by using the TIS lock functionality disclosed herein, ZIP cars members can be identified and unlock their car for driving. Additionally, the TIS lock functionality disclosed herein may be utilized to provide controlled access to their homes, hotel rooms and office.

### Example

### Offline Tis Lock Maintenance TID—(Electromechanical Transaction)

In the event Internet access or power is not available, the lock should be able to operate with a backup battery (The battery or power input for the lock should be located outside the secured area). When offline mode is active the lock hardware scanner is required to scan an offline/maintenance TID from the mobile operator in order to unlock. If the maintenance TID matches the system lock maintenance TID the door opens. The maintenance key may have an expiration upon use. The lock maintains a database of offline or maintenance TIDs when it is online (and communicates with the TISS) that matches he mobile device offline TIDs. It may be enforced that the lock system won't lock again until it is online again and gets a new maintenance TID from the TISS system.

In FIG. 44A, lock device 4402 is an electromechanical device running TIS software and used to secure physical locations. It has a display 4406 capable of displaying TIDs 4408. 4404 is a scanner device part of system 4402 capable of scanning TIDs displayed on device 4450. Device 4402 may have a secondary backup key mechanism 4420. 4410 is a event detector (motion, light, heat etc. . . . ) which activates display 4406 or scanner 4404 upon an specific event (light, movement, heat changes). 4450 is a mobile device running TIS software which is able to scan TID 4408 as indicated in 4401.

### Example Unlock Scenario (Online Mode)

In FIG. 44B, lock device 4402 retrieves TID information from TISS server and displays first valid TID on screen 4406 upon event detected by sensor 4410. Mobile device scans TID from 4408 screen 4406 and authenticates with the TISS server. If authentication is successful device 4402 polls confirmation (or TISS server sends/pushes notification to device 4402) from TISS server and activate electromechanical mechanism to unlock the system. Mobile device 4450 receives confirmation as well as the management agent for lock devices 4402.

### Example Unlock Scenario (Offline TI Lock Maintenance TID)

In the event Internet access or power is not available, the lock 4402 should be able to operate with a backup battery (The battery or power input for the lock should be located outside the secured area). When offline mode is active the lock hardware scanner 4404 is required to scan an offline/maintenance TID from the mobile operator in order to unlock. If the maintenance TID matches the system lock maintenance TID the door opens. The maintenance key may have an expiration upon use. The lock 4402 maintains a database of offline or maintenance TIDs when it is online (and communicates with the TISS) that matches he mobile device offline TIDs. It may be enforced that the lock system won't lock again until it is online again and gets a new maintenance TID from the TISS system.

### Other Embodiments/Concepts/Aspects/Features

In at least one embodiment, one or more components of the Transaction Identification System may be operable to use of near field communication (NFC) or other techniques for acquiring/reading/exchanging TID information between devices
Registration of TID(s)—In at least one embodiment, this can also be done completely from your phone (would be part of the TID(s) app)—no need to scan the website, you would just fill in the standard registration form and then click Register, and the Transaction Identification Server System would pull the hardware info and create the system TID etc.).
Hardware (e.g., chip) in mobile device may be used to obtain/access unique mobile device identifier and/or other mobile device information
In at least one embodiment, user may be provided with option to refresh/update TID on manual basis
2 different timers may be used
   TID expiration timer
   Transaction timer (which may be configured or designed to be different than TID expiration)

### Time and Client TIDs Delivery and Synchronization.

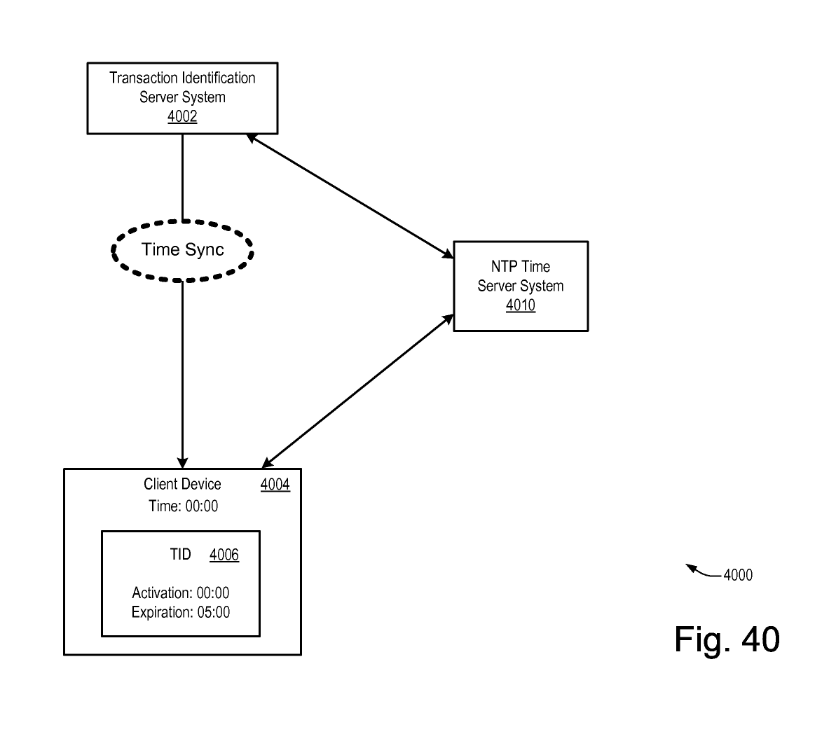

FIG. 40 shows an example block diagram, illustrating a specific example embodiment of how time synchronization may be managed across different devices in the Transaction Identification System or Transaction Identification Network.

In at least one embodiment, TID may be created with an activation and expiration time in Unix Time. Mobile devices (e.g., 4004) and TISS (e.g., 4002) may synchronize time over the Internet via NTP (4010). Time drift is expected to be small between mobile devices and servers. TISS server generates TIDs and delivers them to the client via a secure connection. Activation and expiration times are processed by the client. The mobile client may wait for the activation time to be valid before displaying the TID on its screen. And request another TID upon expiration. TIDs can be communicated as and image or string representation.

### Transaction Identification System Business Methods and Revenue Generating Techniques

Examples of the various business methods/techniques we could employ for generating revenue from the TIS software/service (with particular emphasis on any novel/unique revenue generating techniques).
Hardware—Sell the Transaction Identification Server Systems to companies, with customized Transaction Identification Device Application.
Sell the Service—TIS service could be a monthly fee on your AT&T bill for example. Banks could sell the TIS service (charge bank fees for this service).
Charge transactions fees (similar to what PayPal, Intuit, and Square do).
Sell Software as a Service (SaaS)—license the Transaction Identification Device Application to customers either as a service on demand (usage fees), through a subscription, or in a “pay-as-you-go” model. Could be a one-time software fee with upgrade/new version fees.
Sell the App
Ads—software is free to use and sell advertising within the app.
Identification Services—Electronic Drivers Licenses DMV (license fees)
   TIS Integration/Compatibility with Other Mobile Payment Technologies

Different embodiments of the Transaction Identification System may be configured or designed to be compatible with (and/or integrated with) other mobile payment technologies such as, for example, Paypal Bump.

Bump technology relies on GPS and time to locate possible candidates for a transaction. If GPS data is not available or is available but inexact the transaction will either fail or the target match may be misinterpreted. In the real world GPS signal is not always available and location is not always exact. Probably that explains the high rate of failure of Bump. Security could be a concern when more than two users bump and time and GPS is information is similar. In this case the information could end up in the wrong device.

For example, in some embodiments, when a user launches the Transaction Identification Device Application on their cell phone they are requesting temporary TIDs. When requested temporary TIDs the Transaction Identification Server System also collects the following information from the user—time and GPS location (if available). GPS location is not required to get temporary TIDs, but will be collected if available.

Once the temporary TIDs are sent, the Transaction Identification Server System can calculate the number of potential users in the same area that are available to perform a bump transaction (based on time and GPS location). For example, if 4 people launch the Transaction Identification Device Application around the same time and have GPS information (could be a set number of seconds), then the TIS technology can make the “bump” option available. If no users are in the area (could be a set number of meters calculated with GPS), then the “bump” option would not be available for transactions.

### Use Case A

1) User A launches Transaction Identification Device Application and temporary TIDs are sent.
2) User B launches Transaction Identification Device Application and temporary TIDs are sent. In at least one embodiment, selected TIS information is also sent to the Transaction Identification Server System (e.g., system TID, HTTP environment variables, security info: IP mac addr etc.)
3) The Transaction Identification Server System determines there is another user in the area, and makes the “bump” option available.
4) If GPS information is available, user A is presented with the option to bump. User A selects Bump and shakes their phone if the option is available.
5) If GPS information is available, user B is presented with the option to bump. User B selects Bump and shakes their phone if the option is available.
6) Transaction Identification Server System collects and verifies GPS and time information and compares the information with the previous one received in step 1) and 2). If the following conditions are met the transaction continues: GPS information still available; location has not changed in a significant manner and temporary TIDs haven't expired. Otherwise the transaction fails and transaction status is returned to client and agent. Original authentication and validation TIS methods still apply.
7) TISS determines which user “bumped” their phone first—this user is the agent, and the second user is the client. This is done by using the time information. In at least one embodiment, from this point, the steps may be similar to those of FIG. 31A.
8) The user determined as the agent receives a password prompt and enters passcode information
9) The agent user then enters the Item information (item name, amount, description). The client application (client software) is still polling.
10) The agent device then sends the payment transaction request to the system server.
11) The client device receives a prompt for a password; the client user enters it and clicks ok.
12) Once authenticated by the identifier system the client user can review the agent user's payment request. For example—Send payment to AgentXYZ for itemABC $25 etc. The Client user can then select a payment type and accept or decline the transaction.
13) The Agent device polls for transaction confirmation.
14) The Client device receives the transaction status.
15) The Agent device receives transaction status.

Having fully described at least one embodiment, other equivalent or alternative methods of secure communications according to the present invention may be apparent to those skilled in the art. The invention has been described above by way of illustration, and the specific embodiments disclosed are not intended to limit the invention to the particular forms disclosed. For example, the particular implementation of the scanning devices or interfaces devices may vary depending upon the particular type identifier used. The identifiers described in the foregoing were directed to optical implementations; however, similar techniques may be provided via other technologies. Implementations of the present invention are contemplated as within the scope of the present invention. The invention is thus to cover one or more modifications, equivalents, and alternatives falling within the spirit and scope of the following claims.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A method for facilitating a mobile transaction between a client and an agent comprising:
displaying, on a first display of a first mobile device, a first insignia comprising a first portion of machine readable data;
scanning the first insignia using a second device, wherein the scanning includes reading the first portion of machine readable data;
transmitting the first portion of machine readable data from the second device to a first server system; and
displaying, at the first mobile device, a first authentication verification request to receive authentication information input at the first mobile device;
wherein the first authentication verification request is caused to be displayed at the first mobile device in response to the transmitting of the first portion of machine readable data from the second device to the first server system.

2. The method of claim 1 further comprising:
receiving authentication information from a first user of the first mobile device;
authenticating an identity of the first user; and
facilitating successful completion of the mobile transaction using the first portion of machine readable data.

3. The method of claim 1 further comprising:
receiving authentication information from a first user of the first mobile device;
authenticating an identity of the first user; and
facilitating, in response to successful authentication of the identity of the first user, successful completion of the mobile transaction using the first portion of machine readable data.

4. The method of claim 1 further comprising:
receiving authentication information from a first user of the first mobile device;
confirming, at the first server system, a validity of the first portion of machine readable data; and
facilitating, in response to confirming the validity of the first portion of machine readable data, successful completion of the mobile transaction using the first portion of machine readable data.

5. The method of claim 1 further comprising:
receiving authentication information from a first user of the first mobile device;
authenticating an identity of the first user;
confirming, at the first server system, a validity of the first portion of machine readable data; and
facilitating successful completion of the mobile transaction in response to successful authentication of the identity of the first user, and further in response to confirming the validity of the first portion of machine readable data.

6. The method of claim 1 further comprising:
configuring a validity of the first portion of machine readable data to expire upon an occurrence of a first condition or event;
detecting an occurrence of the first condition or event; and
preventing successful completion of the mobile transaction in response to detecting that the first portion of machine readable data is inactive or invalid.

7. The method of claim 1 further comprising:
configuring the first portion of machine readable data to be valid only during a first specified time interval;
detecting that the validity of the first portion of machine readable data has expired; and
preventing successful completion of the mobile transaction in response to detecting that the first portion of machine readable data is inactive or invalid.

8. A method for facilitating a mobile transaction between a client and an agent comprising:
storing a plurality of transaction identifiers at a mobile device, wherein the first plurality of transaction identifiers includes a first transaction identifier configured to be valid only during a first predefined time interval, and wherein the first plurality of transaction identifiers includes a second transaction identifier configured to be valid only during a second predefined time interval;
using the first transaction identifier to successfully complete a first mobile transaction during the first predefined time interval; and
using the second transaction identifier to successfully complete a second mobile transaction during the second predefined time interval.

9. The method of claim 8 further comprising:
preventing successful completion of the first mobile transaction in response to detecting an attempt to use the first transaction identifier to complete the first mobile transaction during a time which falls outside of the first predefined time interval.

10. The method of claim 8 further comprising:
displaying, on a first display of a first mobile device, a first insignia comprising a first portion of machine readable data;
scanning the first insignia using a second device, wherein the scanning includes reading the first portion of machine readable data;
transmitting the first portion of machine readable data from the second device to a first server system; and
displaying, at the first mobile device, a first authentication verification request to receive authentication information input at the first mobile device;
wherein the first authentication verification request is caused to be displayed at the first mobile device in response to the transmitting of the first portion of machine readable data from the second device to the first server system.

11. A method for facilitating a mobile transaction between a client and an agent comprising:
displaying, on a first display of a first mobile device, a first transaction identifier comprising a first portion of machine readable data;
scanning the first transaction identifier using a second device, wherein the scanning includes reading the first portion of machine readable data;
transmitting the first portion of machine readable data from the second device to a first server system;
displaying, at the first mobile device, a first authentication verification request to receive authentication information input at the first mobile device;
authenticating an identity of the first user; and
facilitating, in response to successful authentication of the identity of the first user, successful completion of the mobile transaction using the first portion of machine readable data.

12. The method of claim 11 further comprising:
using the first transaction identifier to successfully complete a mobile payment transaction between the client and the agent.

13. The method of claim 11 further comprising:
using the first transaction identifier to successfully complete a mobile point-of-sale (POS) transaction between the client and a POS system.

14. The method of claim 11 further comprising:
using the first transaction identifier to successfully complete a user identity verification transaction between the client and the agent.

15. The method of claim 11 further comprising:
using the first transaction identifier to successfully complete a user age verification transaction between the client and the agent.

16. The method of claim 11 further comprising:
using the first transaction identifier to successfully complete a URL access/login transaction between the client and the agent.

17. The method of claim 11 further comprising:
using the first transaction identifier to successfully complete a mobile payment transaction between the client and the agent.

18. The method of claim 11 further comprising:
using the first transaction identifier to successfully complete a mobile payment transaction between the client and the agent.

19. The method of claim 11 further comprising:
using the first transaction identifier to process a payment transaction via the first mobile device;
receiving at the first mobile device, the first transaction identifier, wherein the first transaction identifier is received from the first server system;
receiving at the first mobile device user credential information provided by the first user of the first mobile device; and
using the received user credential information to authenticate the identity of the first user;
wherein the first transaction identifier is configured as a temporary transaction identifier which is valid only during a specific time interval; and
wherein at least a portion of the authentication of the identity of the first user is performed at the first server system.
